(19) United States
(12) Patent Application Publication
(10) Pub. No.: US 2023/0266473 A1
(43) Pub. Date: Aug. 24, 2023

(54) METHOD AND SYSTEM FOR OBJECT DETECTION FOR A MOBILE ROBOT WITH TIME-OF-FLIGHT CAMERA

(71) Applicant: STARSHIP TECHNOLOGIES OÜ, Tallinn (EE)

(72) Inventors: Ardi LOOT, Tallinn (EE); Risto REINPÕLD, Tallinn (EE); Sergii KHARAGORGIIEV, Tallinn (EE); Tommi TYKKÄLÄ, Tallinn (EE)

(73) Assignee: STARSHIP TECHNOLOGIES OÜ, Tallinn (EE)

(21) Appl. No.: 17/768,320

(22) PCT Filed: Oct. 21, 2020
(86) PCT No.: PCT/EP2020/079655

§ 371 Date: Apr. 12, 2022

(30) Foreign Application Priority Data
Oct. 25, 2019 (EP) 19205470.8

(51) Int. Cl. G01S 17/894; G01S 17/931; G05D 1/02; G01S 17/86

(52) U.S. Cl. CPC G01S 17/894; G01S 17/86; G01S 17/931; G05D 1/0242; G05D 1/0248

(57) ABSTRACT

The present invention provides a system and method for operating a mobile robot. Firstly, a mobile robot can be equipped with at least one time-of-flight (ToF) sensor and the mobile robot can travel in an outdoor setting. At least one ToF sensor image related to the outdoor setting can be captured via the at least one ToF sensor. A data processing unit can process the at least one ToF sensor image to identify at least one cluster of pixels on the at least one ToF sensor image based on at least one pixel-clustering parameter. It can be determined whether at least one cluster of pixels corresponds to a hazardous object in the outdoor setting.

### FIELD OF INVENTION

The invention relates to operating mobile robots. More specifically, the invention relates to computer vision for mobile robots, particularly for increased safety of operations.

### INTRODUCTION

Recently, mobile robots have been increasingly deployed in outdoor environments. Such robots are used for maintenance (such as grass mowing or snow cleaning), security (such as surveillance or patrolling), and services (such as carrying items or delivering parcels). For example, Starship Technologies has disclosed and launched a mobile robot configured to transport items, such as to deliver them to recipients. The applicant’s international patent application WO 2017/064202 A1 discloses such mobile delivery robots.

Mobile robots travelling outdoors are generally outfitted with a plurality of sensors allowing for autonomous or partially-autonomous travel. Such sensors can allow the robots to build a computer vision picture of their surroundings, to perform navigation, mapping and localisation, and to avoid colliding with other traffic participants or stationary objects. The applicant’s application WO 2017/064202 A1 also discloses a large number of such sensors that can be used in a complimentary way to ensure safe and efficient operation of mobile delivery robots.

Particularly advantageous for use in computer vision applications is depth sensing, also referred to as 3-dimensional (3D) sensing. Depth sensing consists on acquiring sensor data on a scene for measuring distances to surfaces in the captured scene. Some 3D sensing technologies include laser scanning with Light Detection and Raging (LIDAR) sensors, stereo imaging with visual stereo cameras and range imaging with time-of-flight (ToF) cameras.

LIDAR sensors measure distances to targets by emitting a narrow laser beam and measuring the reflected pulses with a sensor. Due to the narrow field of view, to obtain a more complete view of the surroundings, the LIDAR sensors are equipped with actuators which can orient them in multiple directions allowing for a full (i.e. 360°) or part scanning of the surroundings. Although LIDAR sensors may comprise a sufficient depth measurement accuracy, they are generally characterized by high energy consumption. This makes them disadvantageous for use by mobile robots, wherein power is typically limited due to battery operation.

Stereo cameras measure distances to targets by sensing visual light emitted or reflected by surfaces in a captured scene. Stereo cameras generally comprise a relatively wide field of view (e.g. compared to LIDAR), however they have certain limitations. Firstly, stereo cameras may only operate in good visual lighting conditions (e.g. only during daytime or on well-lit environments). Secondly, they can be inefficient in environments with few visual features. Thirdly, the accuracy of distance measurements for the stereo cameras drops significantly with distance. Moreover, stereo cameras may require a lot of processing power and computational resources, e.g., for solving the correspondence problem - which is generally limited in a mobile robot due to space, cost and energy constrains.

The ToF cameras (or range cameras) are equipped with sensors that can provide intensity and range images. The intensity image can be obtained based on the amount of sensed intensity to a grayscale. The range images can be obtained by illuminating an environment, sensing the light that is reflected by surfaces in the environment and detecting a difference between the emitted and received illumination, such as, a roundtrip time, phase shift, etc.

U.S. Pat. US 8,649,557 B2 discloses a computer-readable medium and method of a mobile platform detecting and tracking dynamic objects in an environment having the dynamic objects. The mobile platform acquires a three-dimensional (3D) image using a time-of-flight (TOF) sensor, removes a floor plane from the acquired 3D image using a random sample consensus (RANSAC) algorithm, and individually separates objects from the 3D image. Movement of the respective separated objects is estimated using a joint probability data association filter (JPDAF).

US 9,904,859 B2 discloses an imaging system and method, the system including a main detection unit, an auxiliary detection unit, an image processor, and a controller. The main detection unit includes a light source that emits light pulses and a gated image sensor that receives reflections of the light pulses reflected from a selected depth of field in the environment and converts the reflections into a reflection-based image. The auxiliary detection unit includes a thermal sensor that detects infrared radiation emitted from the environment and generates an emission-based image. The image processor processes and detects at least one region of interest in the acquired reflection-based image and/or acquired emission-based image. The controller adaptively controls at least one detection characteristic of a detection unit based on information obtained from the other detection unit. The image processor detects at least one object of interest in the acquired reflection-based image and/or acquired emission-based image.

### SUMMARY

In a first embodiment, the present invention provides a method for operating a mobile robot (which for the sake of brevity can also be referred to as robot) that comprises at least one time-of-flight (hereinafter referred to by the abbreviation ToF) sensor. That is, the method particularly relates to operating mobile robots equipped with ToF sensors. More particularly, the method relates to operating land-based mobile robots, preferably land-based mobile delivery robots that are equipped with at least one ToF sensor.

The method comprises the mobile robot travelling in an outdoor setting. For example, this step may comprise the mobile robot transporting a delivery item to a recipient. The outdoor setting may comprise, for example, sidewalks, pedestrian walkways, roads, streets, driveways and other outdoor spaces. Objects, people, buildings, traffic participants, traffic signs, etc., can be present in the outdoor setting in addition to the mobile robot. The outdoor setting is meant to differentiate from generally structured and more predictable indoor settings. As such, the method of the first embodiment can particularly relate to operating the mobile robot while travelling in an outdoor setting.

The method further comprises capturing at least one ToF sensor image related to the outdoor setting via the at least one ToF sensor. That is, the mobile robot comprising at least one ToF sensor and travelling in the outdoor setting (e.g. delivering an item) may utilize the at least one ToF sensor it comprises. This can result in the acquisition or capturing of at least ToF sensor image. The ToF sensor image can comprise sensor data that can be output by a ToF sensor (i.e. ToF sensor data). Said ToF sensor data can generally be configured in a matrix format or matrix data structure, hence forming a ToF sensor image. The ToF sensor image may comprise a plurality of pixels. For example, each element of the matrix data structure can be a pixel.

The method further comprises a data processing unit processing the at least one ToF sensor image to identify at least one cluster of pixels on the at least one ToF sensor image based on at least one pixel-clustering parameter. That is, one or more ToF sensor image(s) can be provided to a data processing unit. The data processing unit may process the ToF sensor image(s) to identify therein at least one cluster of pixels. A cluster of pixels can be a group of pixels of the ToF sensor image, wherein the pixels in a cluster can comprise an identical or similar feature. Identifying pixels that can be grouped in a cluster (i.e. pixels with an identical or similar feature) is performed based on at least one pixel-clustering parameter (which for the sake of brevity can also be referred to as clustering parameter).

The method further comprises determining whether at least one cluster of pixels corresponds to a hazardous object in the outdoor setting. That is, as discussed, a cluster can comprise pixels in a ToF sensor image with a similar or identical feature, e.g., brightness, distance. Thus, a cluster may correspond to any object in the outdoor setting. A cluster may also correspond to an artefact – i.e. appearing to be an object when it’s not. In other words, not every detected cluster may be relevant for facilitating the operation of the mobile robot, such as, an autonomous traveling of the robot. Thus, the method comprises the step of further analyzing the one or more or each cluster to determine whether it/they correspond to a hazardous object.

In general, a hazardous object may be any object that can be relevant in taking a decision or action for operating the mobile robot. For example, a faraway tree to the mobile robot may not influence the operation of the mobile robot, however a close by moving bicycle may influence the operation of the mobile robot. Thus, a hazardous object may, for example, be an object close to the mobile robot, a moving object, a large object, an object in collision course with the mobile robot or any combination thereof.

That is, the method can provide the utilization of a data processing unit and at least one ToF sensor for the operation of a mobile robot in the outdoor setting. The at least one ToF sensor can provide to the mobile robot information related to the outdoor setting and the data processing unit can provide computational capabilities to the mobile robot which can be utilized for processing, analyzing and/or understating the information acquired by the at least one ToF sensor. As such, the travelling, more particularly the autonomous travelling, of the mobile robot in the outdoor setting can be facilitated.

Detecting hazardous objects in the outdoor setting may allow the robot to autonomously take decisions. On the one hand, this may increase the autonomous driving time, hence making the operation of the mobile robot more efficient. On the other hand, detecting hazardous object increases the safety of the mobile robot and other traffic participants. By detecting hazardous objects, corresponding measures may be taken to avoid hazardous situations, such as collisions.

Clustering the pixels on the ToF sensor image and then detecting hazardous objects from the clusters can be time efficient. That is, firstly, relevant pixels are identified and grouped into clusters. Then, one or more or each cluster can be considered for determining whether it corresponds to a hazardous object. Through this “divide and conquer” technique, time efficiency is provided as not every pixel is considered for being a hazardous object (which may be a more complex task as simply determining whether it belongs to a cluster), but rather this decision is taken at the cluster level.

In addition, the present method can increase the accuracy of detecting hazardous objects and operating the mobile robot. In one hand, the detection of clusters can increase the likelihood of detecting objects from ToF sensor images – thus ensuring that (almost) all objects are detected. On the other hand, determining whether one or more, preferably each, cluster is a hazardous object (and not simply considering all the clusters as hazardous objects) decreases the false positive rate – i.e. the rate of determining the non-hazardous object to be hazardous. As such, a more efficient operation of the mobile robot can be achieved.

Furthermore, the use of ToF sensors makes the method compatible at different light conditions. This is due to the fact that ToF sensors utilize active infra-red (IF) illumination during the capturing of a ToF sensor image. The active IF illumination may be used during daytime and reduced light conditions (e.g. nighttime) without disturbing other traffic participants – as it is not perceptible by the human eye. As such, the method can be used to operate the mobile robot and to facilitate the mobile robot’s travelling during daytime, nighttime and reduced light conditions.

In some embodiments, the step of capturing at least one ToF sensor image can comprise capturing at least one distance (or depth) image. That is, the at least one captured ToF sensor image may comprise at least one distance image. In other words, the at least one ToF sensor can be configured to capture a distance image (which can also be referred to as depth image). That is, the at least one ToF sensor image can be configured to perform depth measurements of the outdoor setting. A distance image can comprise a plurality of pixels (which can also be referred to as point cloud), wherein each pixel comprises data indicating a distance measurement, such as, a distance between the at least one ToF sensor and a corresponding segment or surface or object or point in the outdoor setting. The distance images are advantageous as depth and visual features (of the outdoor setting) can be extracted from therein. Thus, the distance images can facilitate detecting clusters in the outdoor setting and a distance to the detected clusters.

Furthermore, the use of a ToF sensor for performing depth measurements comprises multiple advantages. As an initial matter, a ToF sensor can be efficiently and conveniently used at reduced visual light conditions (e.g. at nighttime). Additionally, a ToF sensor may comprise a wide field of view, particularly in comparison with laser scanners (or laser sensors), such as, LIDARS – generally used for range measurements. More particularly, laser scanners can measure a narrow angular sector at a time. However, a ToF sensor may capture a wide angular sector at a time (i.e. multiple narrow angular sectors). Moreover, the output of a ToF sensor may be divided into multiple angular sector, each corresponding or being similar or comprising similar features or similar formats to the output of a laser scanner. Thus, well established techniques used in laser scanning may also be utilized for processing the output of a ToF sensor.

In some embodiments, the step of capturing at least one ToF sensor image can comprise capturing at least one brightness (or grayscale) image. That is, the at least one captured ToF sensor image may comprise at least one brightness image. A brightness image can comprise a plurality of pixels, wherein each pixel comprises data indicating an amount of light received by the ToF sensor. The brightness image can be particularly advantageous as it can indicate visual features (of the outdoor setting) which can facilitate the detection of clusters. Furthermore, infra-red active illumination can be used and the brightness image can efficiently be captured irrespective of the natural/artificial light conditions in the outdoor setting. That is, the ToF sensor can efficiently provide brightness images indicating visual features of the outdoor setting at daytime, nighttime, in darkness, etc.

In some embodiments, identifying a cluster of pixels on a ToF sensor image can comprise identifying a continuous portion of the ToF sensor image such that all the pixels therein or a portion of the pixels therein comprise an identical or similar pixel-clustering parameter. The pixel clustering parameter can also be referred to as a similarity feature. That is, the grouping of pixels in clusters can be performed based on the pixel-clustering parameter and the position of pixels on the image. In simple words, the pixel-clustering parameter facilitates grouping pixels that share a similar feature, such as, a similar visual or depth feature and the position of pixels on the image considers the spatial distribution of the pixels. This is based on the rationale that pixels corresponding to the same object generally share similar features (e.g. visual features and/or depth) and are in close spatial proximity with each other.

Thus, in some particular embodiments, a cluster may not comprise isolated pixels (as indicated by the feature “a continuous portion of the ToF sensor image”), wherein an isolated pixel can be a pixel wherein none of its neighbor pixels is in the cluster. This can also be rephrased as if a first cluster comprises a first pixel, a second cluster comprises a second pixel and the first and the second pixels are neighbors, then the first and the second clusters are one cluster (i.e. cannot be considered as separate clusters). This can be advantageous as it alleviates the issue of considering two objects in the outdoor setting as being one object (i.e. belonging to the same cluster). In other words, said feature facilitates separating objects in the outdoor setting, particularly objects being positioned close to each other.

However, the above feature may be too restrictive and may result in the detection of multiple clusters for the same object. Thus, in some embodiments, said restriction may be alleviated. For example, two clusters with a distance of one pixel from each other may be considered as one cluster. Two clusters are considered to have a distance of 1 pixel form each other, if at least one pixel from one of the clusters comprise the same neighbor pixel with at least one pixel from the other cluster and the said neighbor pixel is in none of the two clusters. The restriction can further be alleviated by considering two clusters with a distance of two pixels from each other to be considered as one cluster. As it will be understood, the said restriction can be alleviated even further, for example, with a distance of 2 – 100 pixels. Alleviating said restriction involves a trade-off between being able to separate objects and lowering the likelihood of detecting multiple clusters for the same object. The ideal outcome may be detecting one cluster per object (or one cluster per group of objects being very close to each other).

In some embodiments, the pixel-clustering parameter can be a feature or a combination of features of a pixel that is extracted based on the data comprised by the pixel. That is, a ToF sensor image can comprise a plurality of pixels and each pixel may comprise data obtained during the capturing of the ToF sensor. For example, for a distance image a pixel may comprise or indicate a measured distance. For a brightness image a pixel may comprise or indicate a measured light intensity of the received (i.e. sensed) light by the ToF sensor. Thus, in such embodiments, while clustering the pixels a feature or a combination of features of the pixels can be considered.

The pixel-clustering parameter of a pixel may comprise or indicate a position of the pixel on the ToF sensor image. For example, the pixel-clustering parameter of a pixel may comprise coordinates of the pixel on the ToF sensor image. Thus, the identification or detection of the at least one cluster of pixels in a ToF sensor image can be based on the position of the pixels on the ToF sensor image. The position of the pixel on the ToF sensor image can be used to calculate a horizontal and/or vertical distance of the pixel (i.e. of the portion of the outdoor setting captured by the pixel) from the ToF sensor (or the center of the mobile robot).

The pixel-clustering parameter of a pixel may comprise or indicate a distance value comprised by the pixel. For example, the pixel-clustering parameter of a pixel may comprise a measured distance provided in the pixel (e.g. in distance image). In some embodiments, the clustering parameter can comprise a 2-dimensional Euclidean distance of the pixel from the robot center or the ToF sensor, said 2-dimensional Euclidean distance calculated based on the depth measurement (i.e. d parameter of the pixel) and the horizontal position of the pixel on the image. In some further embodiments, the clustering parameter can comprise a 3-dimensional Euclidean distance of the pixel from the robot center or the ToF sensor, said 3-dimensional Euclidean distance calculated as for the 2-dimensional Euclidean distance wherein in addition the height of the pixel (i.e. vertical position of the pixel on the image) is considered. In some embodiments, the above calculations of the Euclidean distances may comprise calculating a horizontal and/or vertical distance between the pixel and the center of the mobile robot or ToF sensor based on the position of the pixel on the image. Thus, the identification or detection of the at least one cluster of pixels in a ToF sensor image can be based on the distance value of the pixel.

The pixel-clustering parameter of a pixel may comprise or indicate a light intensity value comprised by the pixel. For example, the pixel-clustering parameter of a pixel may comprise a measured light intensity provided in the pixel (e.g. in brightness image). Thus, the identification or detection of the at least one cluster of pixels in a ToF sensor image can be based on the light intensity value of the pixel.

In some embodiments, The method according to any of the preceding embodiments, wherein the pixel-clustering parameter of a pixel comprises a distance value related to the pixel, a depth measurement by the ToF sensor related to the pixel, a received light intensity measurement by the ToF sensor related to the pixel, a position of the pixel on the ToF sensor image, a 2-dimensional Euclidean distance calculated based on the depth measurement by the ToF sensor related to the pixel and the horizontal position of the pixel on the ToF sensor image, a 2-dimensional Euclidean distance calculated based on the depth measurement by the ToF sensor related to the pixel and the vertical position of the pixel on the ToF sensor image, a 3-dimensional Euclidean distance calculated based on the depth measurement by the ToF sensor related to the pixel and the position of the pixel on the ToF sensor image, or any combination thereof.

In some embodiments, two pixels can be clustered if they are proximal within a predefined proximity threshold to each other and comprise respective distance values with a difference smaller than a predefined distance threshold. Proximity between two pixels can be measured based on the position of the pixels on the ToF sensor image. The distance value can comprise any combination of the depth measurements by the ToF sensor related to the pixels, 2-dimensional Euclidean distances calculated based on the depth measurements by the ToF sensor related to the pixels and the horizontal position of the pixels on the ToF sensor image, a 2-dimensional Euclidean distance calculated based on the depth measurements by the ToF sensor related to the pixels and the vertical position of the pixels on the ToF sensor image, a 3-dimensional Euclidean distance calculated based on the depth measurements by the ToF sensor related to the pixels and the position of the pixels on the ToF sensor image.

That is, as also discussed, when clustering pixels the position of the pixels in the ToF sensor image and a pixel feature (in this case a measured distance feature) can be considered. More particularly, two pixels are clustered if they are proximal to each other and if they comprise identical or similar distance values. In such embodiments, the capturing of at least one distance image can be advantageous. In other words, such embodiments are particularly advantageous for detecting clusters from a distance image.

In some embodiments, two pixels can be clustered if they are proximal within a predefined proximity threshold to each other and comprise respective light intensity (or brightness) values with a difference smaller than a predefined light intensity threshold. Proximity between two pixels can be measured based on the position of the pixels on the ToF sensor image. That is, as also discussed, when clustering pixels the position of the pixels in the ToF sensor image and a pixel feature (in this case a measured brightness or light intensity) can be considered. More particularly, two pixels are clustered if they are proximal to each other and if they comprise identical or similar light intensity values. In such embodiments, the capturing of at least one brightness image can be advantageous. In other words, such embodiments are particularly advantageous for detecting clusters from a brightness image.

In some embodiments, identifying a cluster of pixels can be based on an edge detection algorithm for detecting region boundaries and identifying a cluster of pixels from bounded regions. In such embodiments, the edges of objects in the real word can be detected. Based on this the clusters can be identified. Herein, different edge detection algorithm can be utilized.

In some embodiments, identifying a cluster of pixels can be based on an iterative algorithm, such as, the K-means algorithm (also referred to as K-means clustering).

In some embodiments, identifying a cluster of pixels can comprise calculating a histogram of the pixel-clustering parameter for all the pixels in a ToF sensor image and identifying clusters of pixels based on the peaks and valleys in the histogram.

In some embodiments, identifying a cluster of pixels can be based on an optimization algorithm. The optimization algorithm can be configured to maximize the number of pixels in a cluster while maintaining a pixel-clustering error below a predetermined error bound. Alternatively, the optimization algorithm can be configured to minimize a pixel-clustering error while maintaining the size of a cluster above a predetermined minimum cluster size. The pixel-clustering error can be calculated based on the difference between the pixel-clustering parameters of the pixels in the cluster.

In some embodiments, the step of identifying at least one cluster of pixels on the at least one ToF sensor image based on at least one pixel-clustering parameter can comprises configuring the data processing unit to solve an optimization problem. For example, an optimizer processing unit (that can be comprised by the data processing unit) can be configured to solve an optimization problem to cluster the pixels on a ToF sensor image. The optimization problem can be advantageous to optimize the trade-offs involved for clustering pixels.

In some embodiments, identifying a cluster of pixels can be based on a classification algorithm that can determine a continuous portion of an image to correspond to a cluster of pixels if the number of pixels on the continuous portion of the image is above a predetermined minimum cluster size and a pixel clustering error is below a predetermined error bound and wherein the pixel-clustering error is calculated based on the difference between the pixel-clustering parameters of the pixels on the continuous portion of the image.

In some embodiments, the step of identifying at least one cluster of pixels on the at least one ToF sensor image based on at least one pixel-clustering parameter can comprise dividing a ToF sensor image into subregions. Preferably, each subregion can comprise equally-sized subregions, such as, rectangular equally-sized subregions. For example, image tiling can be used to divide a ToF sensor image into subregions. The subregions can for example comprise a width and a height of at least 1 pixel and at most 20 pixels, preferably at least 2 pixels and at most 20 pixels. In a particular embodiment, the subregions (which can also be referred to as tiles) can comprise a size of 4×4 pixels –i.e. a width of 4 pixels and a height of 4 pixels. Alternatively or additionally, a ToF sensor image may be divided into at least 4 subregions and at most 20000 subregions, preferably at least 48 subregions at most 4800 subregions, such as, 1200 subregions.

In each of the subregions, at least one cluster of pixels on at least one subregion of the at least one ToF sensor image can be identified based on at least one first pixel-clustering parameter. That is, pixels in a subregion of the ToF sensor image can be grouped into clusters based on their respective first pixel-clustering parameters. The first pixel-clustering parameter can comprise a distance value and two pixels in a subregion can be grouped in a cluster if they comprise distance values with a difference of at most 50 cm. The distance value can for example indicate a distance value related to the pixel, a depth measurement by the ToF sensor related to the pixel, a position of the pixel on the ToF sensor image, a 2-dimensional Euclidean distance calculated based on the depth measurement by the ToF sensor related to the pixel and the horizontal position of the pixel on the ToF sensor image, a 2-dimensional Euclidean distance calculated based on the depth measurement by the ToF sensor related to the pixel and the vertical position of the pixel on the ToF sensor image, a 3-dimensional Euclidean distance calculated based on the depth measurement by the ToF sensor related to the pixel and the position of the pixel on the ToF sensor image, or any combination thereof.

Thus, all the pixels within one subregion comprising a similar pixel-clustering parameter can form a cluster. By considering only pixels within a subregion to form clusters, the error of having a cluster extend over multiple objects can be alleviated –particularly by selecting the tiles to be small. In addition, the subregions can be processed individually and independently for identifying clusters therein. Thus, the subregions can be processed in parallel, which can decrease the time required to identify clusters in the ToF sensor image. This is particularly advantageous if the data processing unit comprises multiple cores – wherein each of the cores can be utilized to process one of the subregions.

In some embodiments, the step of identifying at least one cluster of pixels on at least one subregion of the at least one ToF sensor image based on at least one first pixel-clustering parameter can further comprise grouping two pixels in the same subregion in a cluster if they are neighboring pixels.

In some embodiments, the step of identifying at least one cluster of pixels on at least one subregion of the at least one ToF sensor image based on at least one first pixel-clustering parameter can be based on a flat clustering algorithm, such as, the K-means clustering algorithm, hierarchical clustering algorithm, such as, agglomerative hierarchical clustering algorithm or divisive hierarchical clustering algorithm, or any combination thereof

The identification of the clusters in each subregion can be followed by a grouping of clusters into bigger clusters, which can be referred to as composite clusters or components. More particularly, the clusters in a plurality of subregions can be grouped to form composite clusters.

In some embodiments, the plurality of subregions can comprise subregions that are vertically aligned to form a column of subregions in a ToF sensor image. In other words, clusters in close angular proximity (i.e. in the same column) can be grouped together into composite clusters, as they most probably belong to the sample object. This is particularly advantageous for detecting elongated objects, which can extend over multiple subregions of a vertical column of subregions. In such embodiments, grouping clusters within a plurality of subregions to form composite clusters can be performed for each column of subregions of the ToF sensor image independently.

In some embodiments, the plurality of subregions can comprise subregions that are horizontally aligned to form a row of subregions in a ToF sensor image. In other words, clusters at similar heights (i.e. in the same row) can be grouped together into composite clusters, as they most probably belong to the sample object. This can be particularly advantageous for detecting wide objects, which can extend over multiple subregions of a row of subregions. In such embodiments, grouping clusters within a plurality of subregions to form composite clusters can be performed for each row of subregions of the ToF sensor image independently.

In some embodiments, the plurality of subregions can comprise neighboring subregions. Neighboring subregions can be subregions in a ToF sensor image that share at least one border. In such embodiments, grouping clusters within a plurality of subregions to form composite clusters can be performed for each plurality subregions of the ToF sensor image independently.

Grouping clusters within a plurality of subregions to form composite clusters can comprise calculating for each cluster in the plurality of subregions a second pixel-clustering parameter based on the first pixel-clustering parameters of the pixels in the cluster and grouping two-clusters in the plurality of subregions if they comprise similar or identical second pixel-clustering parameters. The second pixel-clustering parameter can for example be an average, a minimum or a maximum of the first pixel-clustering parameters of the pixels in the cluster.

The second pixel-clustering parameter can comprise a distance value of a cluster, and two clusters can be grouped to form one composite cluster if the clusters comprise distance values with a difference of at most 50 cm. The distance value of a cluster can comprise a distance value calculated based on distance values related to the pixels of the cluster, a depth value calculated based on depth measurements by the ToF sensor related to the pixels of the clusters, a position of the cluster on the ToF sensor image, a 2-dimensional Euclidean distance of a cluster calculated based on 2-dimensional Euclidean distances calculated for each pixel based on the depth measurement by the ToF sensor related to the pixel and the horizontal position of the pixel on the ToF sensor image, a 2-dimensional Euclidean distance of a cluster calculated based on 2-dimensional Euclidean distances calculated for each pixel based on the depth measurement by the ToF sensor related to the pixel and the vertical position of the pixel on the ToF sensor image, a 3-dimensional Euclidean distance of a cluster calculated based on 2-dimensional Euclidean distances calculated for each pixel based on the depth measurement by the ToF sensor related to the pixel and the position of the cluster on the ToF sensor image, or any combination thereof.

Grouping clusters within a plurality of subregions to form composite clusters can further comprise grouping two clusters in the plurality of subregions if the cluster are positioned in subregions separated by at most 1 subregion. That is, the clusters can be grouped into composite clusters if the subregions that they belong to are either neighboring subregions or comprise one subregion in-between.

Grouping clusters within a plurality of subregions to form composite clusters can be based on a flat clustering algorithm, such as, the K-means clustering algorithm, hierarchical clustering algorithm, such as, agglomerative hierarchical clustering algorithm or divisive hierarchical clustering algorithm, or any combination thereof. In general, different clustering algorithms may be utilized for clustering the clusters into composite clusters. The clustering algorithm can be configured to cluster the clusters into composite clusters by using the second-pixel clustering parameter of the clusters for evaluating similarity scores between the clusters.

In other words, the step of identifying at least one cluster of pixels on the at least one ToF sensor image based on at least one pixel-clustering parameter can be based on a two-phase clustering process. In a first phase of the two-phase clustering process, pixels in a first portion of the ToF sensor image can be grouped into clusters based on a first pixel-clustering parameter. In a second phase of the two-phase clustering process, clusters in a second portion of the ToF sensor image can be grouped into composite clusters based on a second-pixel clustering parameter. The second phase can preferably be performed after the first phase and the second portion of the ToF sensor image can be composed of a plurality of the first portions of the ToF sensor image.

In some embodiments, the second portion of the ToF sensor image is composed of a plurality of first portions of the ToF sensor image that are vertically aligned in a column or a plurality of first portions of the ToF sensor image that are horizontally aligned in a row or a plurality of first portions of the ToF sensor images that are neighbors (i.e. share at least one border).

The first pixel-clustering parameter can comprise a distance value related to a pixel, a depth measurement by the ToF sensor related to a pixel, a received light intensity measurement by the ToF sensor related to a pixel, a position of a pixel on the ToF sensor image, a 2-dimensional Euclidean distance calculated based on the depth measurement by the ToF sensor related to a pixel and the horizontal position of the pixel on the ToF sensor image, a 2-dimensional Euclidean distance calculated based on the depth measurement by the ToF sensor related to a pixel and the vertical position of the pixel on the ToF sensor image, a 3-dimensional Euclidean distance calculated based on the depth measurement by the ToF sensor related to a pixel and the position of the pixel on the ToF sensor image, or any combination thereof.

The second pixel-clustering parameter can be calculated for a cluster based on the first pixel-clustering parameters of pixels of the clusters.

In some embodiments, the method can further comprise determining if at least one cluster of pixels corresponds to an object in the outdoor setting. That is, in some embodiments of the method, the identification of clusters can be configured such that it can inherently ensure (with some certainty) that the identified clusters relate to objects. However, in some embodiments, this may be further facilitated by performing a further step during which the clusters can be analyzed to determine whether they correspond to objects in the outdoor setting.

In some embodiments, determining whether a cluster of pixels corresponds to an object in the outdoor setting can be based on the size of the cluster. For example, small clusters can be disregarded, as there is a high chance that they are artefacts.

Alternatively or additionally, determining whether a cluster of pixels corresponds to an object in the outdoor setting can be based on the shape of the cluster.

Furthermore, determining if a cluster of pixels corresponds to an object in the outdoor setting can be based on an object classification algorithm configured to classify a shape (i.e. a cluster shape) into a respective category of objects.

In some embodiments an artificial neural network algorithm may be trained to determine if a cluster of pixels corresponds to an object in the outdoor setting. The artificial neural network algorithm can be trained with annotated (i.e. labelled) clusters of pixels.

In some embodiments, determining whether at least one cluster of pixels corresponds to a hazardous object in the outdoor setting can comprise determining whether at least one cluster of pixels corresponds to an object or obstacle in the outdoor setting that obstructs mobile robot’s travelling. In other words, a hazardous object may be an obstacle and the present method can comprise detecting obstacles. An object or obstacle in the outdoor setting that obstructs mobile robot’s travelling can be at least 20 cm high, or at least 30 cm high, preferably at least 50 cm high. Obstacle detection can be advantageous as it can provide a more secure travelling of the mobile robot.

In some embodiments, the method can further comprise generating a computerized view of the outdoor setting.

In such embodiments, the data processing unit can be configured to generate the computerized view of the outdoor setting. That is, the computerized view can be generated automatically.

In some embodiments, the computerized view may comprise an occupancy map that can depict the position of objects in the outdoor setting relative to the position of the mobile robot.

The method can further comprise projecting the at least one cluster on the computerized view.

The method can further comprise projecting the at least one hazardous object on the computerized view.

Projecting a cluster of pixels and/or hazardous object on the computerized view can comprise drawing an outline of boundary of the cluster of pixels and/or hazardous object on the computerized view. Alternatively or additionally, projecting a cluster of pixels and/or hazardous object on the computerized view can comprise associating a label to the projected cluster of pixels and/or hazardous object, wherein said label comprises at least one of: an ID of the cluster of pixels and/or hazardous object, a type or classification of the projected object, the position of the center of the cluster and/or hazardous object relative to the mobile robot.

Thus, the computerized view can provide an efficient way of representing the outdoor setting, such that, it can be efficiently utilized to operate the mobile robot.

In some embodiments, the method can comprise capturing at least two ToF sensor images at different times via the at least one ToF sensor. Furthermore, determining whether at least one cluster of pixels corresponds to a hazardous object in the outdoor setting can comprise determining whether the at least one cluster of pixels corresponds to a moving object in the outdoor setting. In other words, by capturing a plurality of ToF sensor images the method can comprise detecting hazardous objects that are moving objects.

In some embodiments, determining whether the at least one cluster of pixels corresponds to a moving object in the outdoor setting can comprise identifying at least two clusters projected on the computerized view on different positions that correspond to the same moving object in the outdoor setting.

In some embodiments, the method can comprise estimating a speed and direction of movement (i.e. velocity) of a moving object in the outdoor setting. This can be based on the positions of at least two clusters projected on the computerized view that can be identified to correspond to the same moving object in the outdoor setting and on the difference between the capturing times of the at least two ToF sensor images wherein said clusters were detected.

In some embodiments, the method may comprise tracing the movement of a moving objects. This can be done by tracking the projections of a moving object on the computerized view.

In some embodiments, the method can comprise detecting fast moving objects, such as, moving vehicles

In some embodiments, the step of determining whether at least one cluster of pixels corresponds to a hazardous object in the outdoor setting can comprises applying at least one geometric rule. The at least one geometric rule can comprises determining whether a cluster corresponds to a hazardous based on geometric information that can be extracted from the object, such as, location, size, orientation, shape of the cluster. The at least one geometric rule may comprises determining whether a cluster corresponds to a hazardous object by determining whether the cluster is connected to the ground.

Based on the geometric rule, for a cluster that is connected to the ground it can be determined with a higher likelihood that it is a hazardous object than for a cluster that is not connected to the ground. That is, the method can comprise classifying clusters into hazardous or non-hazardous objects based on the connection of the cluster to the ground.

In some embodiments, the method can comprise capturing at least one first ToF sensor image with at least one ToF sensor configured with a first ambiguity distance and at least one second ToF sensor image with at least one ToF sensor configured with a second ambiguity distance, wherein the first ambiguity distance is different from the second ambiguity distance.

In such embodiments, the method can comprise detecting a first cluster on the at least one first ToF sensor image and a corresponding second cluster on the at least one second ToF sensor image wherein the first cluster and the corresponding second cluster correspond to the same object in the outdoor setting. Then, the method can comprise generating with a first likelihood a first location hypothesis of the said object based on the measured distance of the first cluster on the at least one first ToF sensor image. Then the method can comprise generating with a second likelihood a second location hypothesis of the said object based on the measured distance of the second cluster on the at least one second ToF sensor image. Then the method can comprise generating with a third likelihood a third location hypothesis based on the first location hypothesis and the second location hypothesis and wherein the third likelihood is higher than the first likelihood and the second likelihood.

The first location hypothesis can comprise a first set of multiple locations related to the location of the object. The second location hypothesis can comprise a second set of multiple locations related to the location of the object. The third location hypothesis can comprise a third set of one or multiple locations related to the location of the object, wherein the third set is smaller than the first and second set.

The third set can be generated based on the intersection of the first set and the second set.

In some embodiments, the method can comprise determining a region of interest on the at least one ToF sensor image and the data processing unit processing only the region of interest to identify at least one cluster of pixels on the at least one ToF sensor image based on at least one pixel-clustering parameter.

Determining the region of interest on the at least one ToF sensor image comprises partially or fully excluding parts of the ToF sensor image that comprise a high likelihood of corresponding to the ground and/or sky.

In some embodiments, the ToF sensor can output ToF sensor images comprising only the region of interest.

In some embodiments, the method can comprise capturing at least one first ToF sensor image at a first mobile robot position and at least one second ToF sensor image at a second mobile robot position. The method can further comprise detecting a first cluster on the at least one first ToF sensor image and a corresponding second cluster on the at least one second ToF sensor image wherein the first cluster and the corresponding second cluster correspond to the same object in the outdoor setting. The method can further comprise generating with a first likelihood a first location hypothesis of the said object based on a measured distance and angle to the first cluster based on the at least one first ToF sensor image. The method can further comprise generating with a second likelihood a second location hypothesis of the said object based on the measured distance and angle to the second cluster on the at least one second ToF sensor image. The method can further comprise generating with a third likelihood a third location hypothesis using a triangulation technique based on the first location hypothesis and the second location hypothesis and wherein the third likelihood is higher than the first likelihood and the second likelihood.

In some embodiments, the method can further comprise calculating a blurriness parameter for at least one portion of a ToF sensor image, wherein the blurriness parameter can indicate a degree of image blurring for the at least one portion of the ToF sensor image.

In some embodiments, the blurriness parameter can be calculated for at least one cluster of pixels.

The blurriness parameter of a cluster of pixels can utilized to disambiguate an ambiguous distance measurement to the cluster of pixels.

In some embodiments, a distance to a cluster of pixels can be determined from a distance image. A first location hypothesis and a second location hypothesis for the cluster can be generated based on the distance to the cluster of pixels, wherein the first location hypothesis is closer to the mobile robot than the second location hypothesis. The method can further comprise determining one of the first location hypothesis and second location hypothesis as the location of the cluster of pixels based on the blurriness parameter calculated for the cluster of pixels. For example, the first location hypothesis can be chosen if the blurriness parameter is smaller than a blurriness threshold value and the second location hypothesis can be chosen if the blurriness parameter is larger than a threshold value.

In some embodiments, the at least one ToF sensor can sense infrared signal, such as electromagnetic waves with wavelengths between 700 – 1400 nm, preferably between 750 – 1050 nm. This can be advantageous for facilitating the operation of the mobile robot during reduced light conditions, such as, during nighttime.

In some embodiments, method can further comprise emitting infrared signal, such as electromagnetic waves with wavelengths between 700 – 1400 nm, preferably between 750 – 1050 nm, preferably during the step of capturing the at least one ToF sensor image. This can be advantageous for facilitating the operation of the mobile robot during reduced light conditions, such as, during nighttime. Furthermore, emitting light within the described wavelength can provide illumination to the at least one ToF sensor without disturbing the other traffic participants. Further still, providing active illumination to the ToF sensor can facilitate capturing at least one distance image and/or brightness image with a ToF sensor.

In some embodiments, the method can further comprises equipping the mobile robot with at least one visual camera and capturing at least one visual camera image with the at least one visual camera. This can be particularly advantageous as a visual camera can provide additional information related to the outdoor setting. More particularly, the visual camera may capture in more detail visual features of the outdoor setting. For example, the visual camera may provide color information related to the outdoor setting.

The visual camera can capture at least one visual camera image by sensing visible light, such as, electromagnetic waves with wavelengths between 380 to 740 nm. Thus, the visual camera and the ToF sensor can operate with electromagnetic waves with similar wavelengths. As such, visual camera images and ToF sensor images may depict similar visual features. This makes the visual camera a particularly advantageous addition to the ToF sensor. That is, visual camera images and ToF sensor images may easily be combined with each other.

Thus, the method can further comprise processing the at least one visual camera image to identify at least one cluster of pixels on the at least one visual camera image based on the at least one pixel-clustering parameter. That is, the visual camera images may further be used to identify clusters. In such embodiments, the at least one pixel-clustering parameter can comprise a color of the pixel on the visual camera image. Thus, pixels on the visual camera images can be grouped into clusters based on their color.

The method can further comprise capturing the at least one ToF sensor image and at least one visual camera image simultaneously. Herein, simultaneously (or instantly) is meant to also refer to a small time-difference. This can facilitate combining or fusing the captured visual image and ToF sensor image. This can further be facilitated if the visual camera and the ToF sensor are configured to comprise intersecting or fitting fields of view. Thus, the same scene in the outdoor setting may be captured instantly by a visual camera and a ToF sensor.

The method can further comprise fusing at least one visual camera image with at least one ToF sensor image and generating a fused image, wherein the fused image can comprise information extracted from the at least one visual camera image and the at least one ToF sensor image. As discussed, this step can be further facilitated by capturing the visual camera image and the ToF sensor image simultaneously. This step can also be facilitated, by arranging the visual camera and the ToF sensor with intersecting fields of view.

The method can further comprise processing the at least one fused image to identify at least one cluster of pixels on the at least one visual camera image based on the at least one pixel-clustering parameter.

The fused image provides a more detailed information of the outdoor setting, because in addition to the information captured by the ToF sensor it comprises information captured by the visual camera. For example, a fused image can comprise color and distance information of the surroundings. Furthermore, the visual cameras generally comprise a higher resolution (as compared to the ToF sensors), thus the visual camera can provide a more detailed information on visual features of the outdoor setting. This can make the detection of the clusters more accurate.

As discussed, the at least one ToF sensor and the at least one visual camera image may comprise similar or intersecting fields of view.

In some embodiments, the method may further comprise equipping the mobile robot with at least one stereo camera and capturing at least one stereo image with the at least one stereo camera. In such embodiments, the method may comprise generating a distance image based on the stereo image.

The use of the stereo cameras in addition to the ToF sensors comprise similar advantages to the use of visual cameras. However, the use of stereo cameras can comprise additional advantages as based on the stereo images a distance image can be generated.

In some embodiments, the distance image generated by the ToF sensor and the distance image generated by the stereo camera can be utilized to increase the accuracy of a distance measurement to a segment of the outdoor setting.

In some embodiments, a blurriness parameter for a portion on a ToF sensor image can calculated based on a corresponding portion on a visual camera image and/or stereo camera image. The blurriness parameter, as discussed, can be used to disambiguate a distance measurement by the ToF sensor.

In some embodiments, the method can comprise equipping the at least one ToF sensor with a custom optical lens. More particularly, an illumination unit of a ToF sensor can be equipped with an optical lens such that the shape of the emitted light by the illumination unit can be changed by the optical lens. In some embodiments, the lens can reshape the emitted light by the illumination unit such that it comprises a full width of the beam at half its maximum intensity (FWHM) between 30° to 35°, such as, 33° vertically and full width at 90% of the maximum value between 60° to 70°, preferably 66° horizontally.

In some embodiments, the data processing unit can carry out (i.e. execute) at least one of the steps of the method discussed above.

In some embodiments the method comprises, the data processing unit automatically executing at least one of the steps of the method while the mobile robot is travelling.

In some embodiments, the data processing unit can be triggered by an event to carry out at least one of the steps of the method. In other words, the method may further comprise an event triggering the data processing unit to execute at least one of the steps of the method.

The event can comprise the mobile robot approaching a road crossing.

The method can comprise setting a velocity of the mobile robot based on the determination whether at least one cluster of pixels corresponds to a hazardous object in the outdoor setting. That is, the method can facilitate operating the mobile robot, more particularly the mobile robot’s travelling. Furthermore, by setting or adjusting the velocity of the mobile robot based on the determination whether at least one cluster of pixels corresponds to a hazardous object in the outdoor setting, a more secure and efficient operation and travelling of the mobile robot can be achieved.

The method can comprise the mobile robot crossing a road based on the determination whether at least one cluster of pixels corresponds to a hazardous object (e.g. a moving car) in the outdoor setting. For example, if no moving car is detected then the mobile robot can determine to cross the road. Otherwise, the robot may determine to wait until the road is empty and/or request for assistance from a human operator. As such, security of the mobile robot and other traffic participants can be increased.

The method can comprise configuring the trajectory of the mobile robot to avoid an obstacle based on the determination whether at least one cluster of pixels corresponds to a hazardous object (e.g. an obstacle) in the outdoor setting.

The above discussed method can be a computer-implemented method.

In a second embodiment, the present invention provides a mobile robot configured to travel in outdoor settings, the mobile robot comprising at least one ToF sensor.

The at least one ToF sensor can be mounted on the robot at a height from the ground of 10 – 70 cm, preferably 20 – 55 cm, more preferably 40 – 50 cm.

In some embodiments, the robot can comprise a plurality of ToF sensors mounted on the robot and wherein at least a part of them can be mounted at the same height (or approximately at the same height) from the ground.

In some embodiments, the robot can comprise a plurality of ToF sensors, wherein a first set of ToF sensors can be mounted at a first height from the ground and a second set of ToF sensors can be mounted at a second height from the ground.

In some embodiments, at least one front ToF sensor can be mounted at the front of the mobile robot, preferably aligned near or at the middle of the front of the robot.

In some embodiments, at least one side ToF sensor, can be mounted on the sides of the robot, preferably on the sides of the robot near the front of the robot, such as, the front-left and the front-right sides of the mobile robot.

In some embodiments, the mobile robot can comprise at least one visual camera.

In some embodiments, wherein at least one ToF sensor and at least one visual camera can be mounted on the robot such that they comprise similar or intersecting fields of view.

In some embodiments, the mobile robot can comprise at least one stereo camera.

In some embodiments, at least one ToF sensor and at least stereo camera can be mounted on the robot such that they comprise similar or intersecting fields of view.

In some embodiments, the mobile robot can comprise at least one further sensor, such as, at least one radar configured to detect objects (e.g. moving objects) in the surroundings of the robot, at least one GPS sensor configured to provide an estimated geolocation of the mobile robot, at least one odometer configured to measure a distance travelled by the wheels of the robot, at least one odometer and gyroscope configured to measure relative movement of the mobile robot between two different poses, at least one accelerometer configured to measure acceleration, tilting and orientation of the mobile robot or any combination thereof.

In some embodiments, the mobile robot can comprise at least one sensor mounting section configured to facilitate mounting at least one sensor to the mobile robot.

In some embodiments, the at least one ToF sensor can be mounted on the sensor mounting section.

In some embodiments, the at least one visual camera can be mounted on the sensor mounting section.

In some embodiments, the at least one stereo camera can be mounted on the sensor mounting section.

In some embodiments, the at least one further sensor can be mounted on the sensor mounting section.

In some embodiments, the sensor mounting section can be configured to provide protection or cover to the at least one sensor attached therein from rain, snow, outdoor temperature, dust and in general any external particle or condition that can damage the at least one sensor mounted in the sensor mounting section.

In some embodiments, the sensor mounting section can be covered by a transparent cover, wherein the transparent cover can be a cover that minimizes the obfuscation of the view of the attached sensors on the sensor mounting section.

In some embodiments, the sensor mounting section can be positioned on the front of the mobile robot and can preferably be extended around the mobile robot.

In some embodiments, the sensor mounting section can be positioned at a height from the ground of 10 – 70 cm, preferably 20 – 60 cm, more preferably 40 – 60 cm.

In some embodiments, the sensor mounting section can comprise a larger area at the front of the mobile robot to accommodate a higher number of sensors as compared to the other sides.

In some embodiments, the mobile robot can be operated according to the method according to any of the preceding method embodiments.

In some embodiments, the mobile robot can comprise the data processing unit.

In a third embodiment, a custom optical lens configured to reshape light emitted by an illumination unit that provides active illumination for at least one ToF sensor, is provided. The at least one ToF sensor can preferably be mounted on a mobile robot.

The custom optical lens can comprise a focal length of 2 to 6 mm, such as, 4 mm.

The custom optical lens can comprise a refractive index of the lens material of 1.4 to 1.6, such as, 1.5.

The custom optical lens can be configured to reshape the emitted light by the illumination unit such that it comprises a full width of the beam at half its maximum intensity (FWHM) between 30° to 35°, such as, 33° vertically and full width at 90% of the maximum value between 60° to 70°, preferably 66° horizontally.

The custom optical lens can be configured to reshape the emitted light by the illumination unit, such that the power in the field of view of the at least one ToF sensor can be at least 70% of the total power emitted by the illumination unit, preferably at least 80%.

The at least one ToF sensor can comprise a field of view with a spread of 80° to 88°, such as 85.12°, horizontally and 60° to 75°, such as 69.05°, vertically.

In a fourth embodiment, the present invention provides a system configured to operate a mobile robot. The system comprises a mobile robot configured to travel in an outdoor setting. The mobile robot comprises at least one ToF sensor configured to capture at least one ToF sensor image. The system further comprises a data processing unit configured to process the at least one ToF sensor image to identify at least one cluster of pixels on the at least one ToF sensor image based on at least one pixel-clustering parameter. The data processing unit is further configured to determine whether at least one cluster of pixels corresponds to a hazardous object in the outdoor setting.

In some embodiment, the mobile robot can be configured according to any of the preceding robot embodiments, previously discussed.

In some embodiment, the mobile robot can comprise at least one illumination unit that can be configured to provide active illumination for the at least one ToF sensor.

In some embodiments, the mobile robot can comprise a custom optical lens configured to reshape light emitted by the illumination unit.

In some embodiments, the custom optical lens can be configured according to any of the preceding optical lens embodiments.

In some embodiments, the system can further comprise a server and the server can partially or fully comprise the data processing unit.

In some embodiments, the mobile robot and the server can comprise respective communication units configured to allow a bi-directional communication between the robot and the server.

The system can be configured to execute the method according to any of the preceding method embodiments.

The method according to any of the discussed method embodiments can be used for operating a mobile robot, particularly at low-light conditions, such as, during nighttime.

The method according to any of the discussed method embodiments can be used for detecting at least one obstacle in an outdoor setting wherein a mobile robot is travelling, particularly at low-light conditions, such as, during nighttime.

The method according to any of the discussed method embodiments can be used for detecting at least one moving object, such as a moving vehicle, in an outdoor setting wherein a mobile robot is travelling, particularly at low-light conditions, such as, during nighttime.

### NUMBERED EMBODIMENTS

Below, method embodiments will be discussed. These embodiments are abbreviated by the letter “M” followed by a number. Whenever reference is herein made to “method embodiments”, these embodiments are meant.

M1. A method for operating a mobile robot (20) comprising at least one ToF sensor (10), the method comprising:
a. the mobile robot (20) travelling in an outdoor setting; and
b. capturing at least one ToF sensor image related to the outdoor setting via the at least one ToF sensor (10); and
c. a data processing unit processing the at least one ToF sensor image to identify at least one cluster of pixels on the at least one ToF sensor image based on at least one pixel-clustering parameter; and
d. determining whether at least one cluster of pixels corresponds to a hazardous object in the outdoor setting.

M2. The method according to the preceding method embodiment, wherein the at least one ToF sensor image comprises at least one distance image comprising a plurality of pixels, wherein each pixel comprises data indicating a distance between the at least one ToF sensor (10) and a corresponding segment in the outdoor setting.

M3. The method according to any of the preceding method embodiments, wherein the at least one ToF sensor image comprises at least one brightness image comprising a plurality of pixels, wherein each pixel comprises data indicating an amount of light received by the ToF sensor (10).

### Cluster Detection

M4. The method according to any of the preceding method embodiments, wherein identifying a cluster of pixels on a ToF sensor image comprises identifying a continuous portion of the ToF sensor image such that all the pixels therein or a portion of the pixels therein comprise identical or similar pixel-clustering parameters.

M5. The method according to any of the preceding method embodiments, wherein the pixel-clustering parameter is a feature or a combination of features of a pixel that is extracted based on the data comprised by or related to the pixel.

M6. The method according to any of the preceding method embodiments, wherein the pixel-clustering parameter of a pixel comprises a position of the pixel on the ToF sensor image.

M7. The method according to any of the preceding method embodiments, wherein the pixel-clustering parameter of a pixel comprises a distance value comprised by the pixel.

M8. The method according to any of the preceding method embodiments, wherein the pixel-clustering parameter of a pixel comprises a light intensity value comprised by the pixel.

M9. The method according to any of the preceding embodiments, wherein the pixel-clustering parameter of a pixel comprises
a distance value related to the pixel,
a depth measurement by the ToF sensor related to the pixel,
a received light intensity measurement by the ToF sensor related to the pixel,
a position of the pixel on the ToF sensor image,
a 2-dimensional Euclidean distance calculated based on the depth measurement by the ToF sensor related to the pixel and the horizontal position of the pixel on the ToF sensor image,
a 2-dimensional Euclidean distance calculated based on the depth measurement by the ToF sensor related to the pixel and the vertical position of the pixel on the ToF sensor image,
a 3-dimensional Euclidean distance calculated based on the depth measurement by the ToF sensor related to the pixel and the position of the pixel on the ToF sensor image,
or any combination thereof.

M10. The method according to any of the preceding method embodiments and with the features of embodiment M2, wherein two pixels in a distance image are clustered if they
are proximal within a predefined proximity threshold to each other, wherein proximity between two pixels is measured based on the position of the pixels on the ToF sensor image and
comprise respective distance values with a difference smaller than a predefined distance threshold and wherein the distance values comprise
depth measurements by the ToF sensor related to the pixels,
2-dimensional Euclidean distances calculated based on the depth measurements by the ToF sensor related to the pixels and the horizontal position of the pixels on the ToF sensor image,
a 2-dimensional Euclidean distance calculated based on the depth measurements by the ToF sensor related to the pixels and the vertical position of the pixels on the ToF sensor image,
a 3-dimensional Euclidean distance calculated based on the depth measurements by the ToF sensor related to the pixels and the position of the pixels on the ToF sensor image,
or any combination thereof.

M11. The method according to any of the preceding method embodiments and with the features of embodiment M3, wherein two pixels in a brightness image are clustered if they
are proximal within a predefined proximity threshold to each other, wherein proximity between two pixels is measured based on the position of the pixels on the ToF sensor image and
comprise respective light intensity values with a difference smaller than a predefined light intensity threshold.

M12. The method according to any of the preceding method embodiments, wherein identifying a cluster of pixels is based on an edge detection algorithm for detecting region boundaries and identifying a cluster of pixels from bounded regions.

M13. The method according to any of the preceding method embodiments, wherein identifying a cluster of pixels is based on an iterative algorithm, such as, the K-means algorithm.

M14. The method according to any of the preceding method embodiments, wherein identifying a cluster of pixels comprises calculating a histogram of the pixel-clustering parameter for all the pixels in a ToF sensor image and identifying clusters of pixels based on the peaks and valleys in the histogram.

M15. The method according to any of the preceding method embodiments, wherein identifying a cluster of pixels is based on an optimization algorithm that
maximizes the number of pixels in a cluster while maintaining a pixel-clustering error below a predetermined error bound or
minimizes a pixel-clustering error while maintaining the size of a cluster above a predetermined minimum cluster size,
wherein the pixel-clustering error is calculated based on the difference between the pixel-clustering parameters of the pixels in the cluster.

M16. The method according to any of the preceding embodiments, wherein the step of identifying at least one cluster of pixels on the at least one ToF sensor image based on at least one pixel-clustering parameter comprises

configuring the data processing unit to solve an optimization problem.

M17. The method according to any of the preceding method embodiments, wherein identifying a cluster of pixels is based on a classification algorithm that determines a continuous portion of an image to correspond to a cluster of pixels if the number of pixels on the continuous portion of the image is above a predetermined minimum cluster size and a pixel clustering error is below a predetermined error bound and wherein the pixel-clustering error is calculated based on the difference between the pixel-clustering parameters of the pixels on the continuous portion of the image.

### Two-Phase Clustering

M18. The method according to any of the preceding embodiments, wherein the step of identifying at least one cluster of pixels on the at least one ToF sensor image based on at least one pixel-clustering parameter comprises

dividing a ToF sensor image into subregions, preferably, equally-sized subregions, such as, rectangular equally-sized subregions.

M19. The method according to the preceding embodiment, wherein
the subregions comprise a width between 1 to 20 pixels, preferably a width between 2 to 20 pixels, such as, 4 pixels and a height between 1 to 20 pixels, preferably a height between 2 and 20 pixels, such as, 4 pixels and/or
the ToF sensor image is divided into at least 4 and at most 20,000 subregions, preferably at least 48 and at most 4800 subregions, such as, 1200 subregions.

M20. The method according to any of the 2 preceding embodiments, wherein the step of identifying at least one cluster of pixels on the at least one ToF sensor image based on at least one pixel-clustering parameter comprises

identifying at least one cluster of pixels on at least one subregion of the at least one ToF sensor image based on at least one first pixel-clustering parameter.

M21. The method according to the preceding embodiment, wherein the first pixel-clustering parameter comprises a distance value and the step of identifying at least one cluster of pixels on at least one subregion of the at least one ToF sensor image based on at least one first pixel-clustering parameter comprises

grouping two pixels in the same subregion in a cluster if they comprise distance values with a difference of at most 100 cm, preferably at most 50 cm.

M22. The method according to the preceding embodiment, wherein the distance value of a pixel comprises
a distance value related to the pixel,
a depth measurement by the ToF sensor related to the pixel,
a position of the pixel on the ToF sensor image,
a 2-dimensional Euclidean distance calculated based on the depth measurement by the ToF sensor related to the pixel and the horizontal position of the pixel on the ToF sensor image,
a 2-dimensional Euclidean distance calculated based on the depth measurement by the ToF sensor related to the pixel and the vertical position of the pixel on the ToF sensor image,
a 3-dimensional Euclidean distance calculated based on the depth measurement by the ToF sensor related to the pixel and the position of the pixel on the ToF sensor image,
or any combination thereof.

M23. The method according to any of the 3 preceding embodiments, wherein the step of identifying at least one cluster of pixels on at least one subregion of the at least one ToF sensor image based on at least one first pixel-clustering parameter further comprises grouping two pixels in the same subregion in a cluster if they are neighboring pixels.

M24. The method according to any of the 4 preceding embodiments, wherein the step of identifying at least one cluster of pixels on at least one subregion of the at least one ToF sensor image based on at least one first pixel-clustering parameter is based on a
flat clustering algorithm, such as, the K-means clustering algorithm,
hierarchical clustering algorithm, such as, agglomerative hierarchical clustering algorithm or divisive hierarchical clustering algorithm,
or any combination thereof.

M25. The method according to any of the preceding embodiments and with the features of embodiment M18, wherein the step of identifying at least one cluster of pixels on the at least one ToF sensor image based on at least one pixel-clustering parameter further comprises

grouping clusters within a plurality of subregions to form composite clusters.

M26. The method according to the preceding embodiment, wherein the plurality of subregions comprises subregions that are vertically aligned to form a column of subregions in a ToF sensor image.

M27. The method according to the preceding embodiment, wherein grouping clusters within a plurality of subregions to form composite clusters is performed for each column of subregions of the ToF sensor image independently.

M28. The method according to any of the 3 preceding embodiments, wherein the plurality of subregions comprises subregions that are horizontally aligned to form a row of subregions in a ToF sensor image.

M29. The method according to the preceding embodiment, wherein grouping clusters within a plurality of subregions to form composite clusters is performed for each row of subregions of the ToF sensor image independently.

M30. The method according to any of the 5 preceding embodiments, wherein the plurality of subregions comprises neighboring subregions.

M31. The method according to the preceding embodiment, wherein grouping clusters within a plurality of subregions to form composite clusters is performed for each plurality of subregions comprising neighboring subregions.

M32. The method according to any of the 7 preceding embodiments, wherein grouping clusters within a plurality of subregions to form composite clusters comprises
calculating for each cluster in the plurality of subregions a second pixel-clustering parameter based on the first pixel-clustering parameters of the pixels in the cluster, and
grouping two clusters in the plurality of subregions if they comprise similar or identical second pixel-clustering parameters.

M33. The method according to the preceding embodiment, wherein the second pixel-clustering parameter comprises a distance value of a cluster, and two clusters are grouped to form one composite cluster if the clusters comprise distance values with a difference of at most 100 cm, preferably at most 50 cm.

M34. The method according to the preceding embodiment, wherein the distance value of a cluster comprises
a distance value calculated based on distance values related to the pixels of the cluster,
a depth value calculated based on depth measurements by the ToF sensor related to the pixels of the clusters,
a position of the cluster on the ToF sensor image,
a 2-dimensional Euclidean distance of a cluster calculated based on 2-dimensional Euclidean distances calculated for each pixel based on the depth measurement by the ToF sensor related to the pixel and the horizontal position of the pixel on the ToF sensor image,
a 2-dimensional Euclidean distance of a cluster calculated based on 2-dimensional Euclidean distances calculated for each pixel based on the depth measurement by the ToF sensor related to the pixel and the vertical position of the pixel on the ToF sensor image,
a 3-dimensional Euclidean distance of a cluster calculated based on 2-dimensional Euclidean distances calculated for each pixel based on the depth measurement by the ToF sensor related to the pixel and the position of the cluster on the ToF sensor image,
or any combination thereof.

M35. The method according to any of the preceding embodiments, wherein grouping clusters within a plurality of subregions to form composite clusters further comprises

grouping two clusters in the plurality of subregions if the cluster are positioned in subregions separated by at most 1 subregion.

M36. The method according to any of the preceding embodiments and with the features of embodiment M25, wherein grouping clusters within a plurality of subregions to form composite clusters is based on a
flat clustering algorithm, such as, the K-means clustering algorithm,
hierarchical clustering algorithm, such as, agglomerative hierarchical clustering algorithm or divisive hierarchical clustering algorithm,
or any combination thereof.

M37. The method according to any of the preceding embodiments, wherein the step of identifying at least one cluster of pixels on the at least one ToF sensor image based on at least one pixel-clustering parameter is based on a two-phase clustering process, wherein
in a first phase of the two-phase clustering process, pixels in a first portion of the ToF sensor image are grouped into clusters based on a first pixel-clustering parameter and
in a second phase of the two-phase clustering process, clusters in a second portion of the ToF sensor image are grouped into composite clusters based on a second-pixel clustering parameter,
wherein the second phase is performed after the first phase and the second portion of the ToF sensor image is composed of a plurality of the first portions of the ToF sensor image.

M38. The method according to the any of the 2 preceding embodiments, wherein the second portion of the ToF sensor image is composed of
a plurality of first portions of the ToF sensor image that are vertically aligned in a column, or
a plurality of first portions of the ToF sensor image that are horizontally aligned in a row, or
a plurality of first portions of the ToF sensor images that are neighbors (i.e. share at least one border).

M39. The method according to any of the 3 preceding embodiments, wherein the first pixel-clustering parameter comprises
a distance value related to a pixel,
a depth measurement by the ToF sensor related to a pixel,
a received light intensity measurement by the ToF sensor related to a pixel,
a position of a pixel on the ToF sensor image,
a 2-dimensional Euclidean distance calculated based on the depth measurement by the ToF sensor related to a pixel and the horizontal position of the pixel on the ToF sensor image,
a 2-dimensional Euclidean distance calculated based on the depth measurement by the ToF sensor related to a pixel and the vertical position of the pixel on the ToF sensor image,
a 3-dimensional Euclidean distance calculated based on the depth measurement by the ToF sensor related to a pixel and the position of the pixel on the ToF sensor image,
or any combination thereof.

M40. The method according to any of 4 preceding embodiments, wherein the second pixel-clustering parameter is calculated for a cluster based on the first pixel-clustering parameters of pixels of the clusters.

### Object Detection

M41. The method according any of the preceding method embodiments, the method further comprising determining whether at least one cluster of pixels corresponds to an object in the outdoor setting.

M42. The method according to the preceding method embodiment, wherein determining whether a cluster of pixels corresponds to an object in the outdoor setting is based on the size of the cluster.

M43. The method according to any of the two preceding method embodiments, wherein determining if a cluster of pixels corresponds to an object in the outdoor setting is based on the shape of the cluster.

M44. The method according to any of the three preceding method embodiments, wherein determining if a cluster of pixels corresponds to an object in the outdoor setting is based on an object classification algorithm configured to classify a shape (i.e. a cluster shape) into a respective category of objects.

M45. The method according to any of the four preceding method embodiments, wherein determining if a cluster of pixels corresponds to an object in the outdoor setting is based on an artificial neural network algorithm that is trained with a database of labelled clusters of pixels.

### Obstacle Detection

M46. The method according to any of the preceding method embodiments, wherein determining whether at least one cluster of pixels corresponds to a hazardous object in the outdoor setting comprises determining whether at least one cluster of pixels corresponds to an object or obstacle in the outdoor setting that obstructs mobile robot’s travelling.

M47. The method according to the preceding method embodiments, wherein the object or obstacle in the outdoor setting that obstructs mobile robot’s travelling is at least 20 cm high, or at least 30 cm high, preferably at least 50 cm high.

### Computerized View

M48. The method according to any of the preceding method embodiments, the method further comprising generating a computerized view (200) of the outdoor setting.

M49. The method according to the preceding method embodiment, wherein the data processing unit generates the computerized view (200).

M50. The method according to any of the two preceding method embodiments, wherein the computerized view (200) comprises an occupancy map (200) depicting the position of objects in the outdoor setting relative to the position of the mobile robot (20).

M51. The method according to any of the three preceding method embodiments, the method further comprising projecting at least one cluster of pixels on the computerized view (200).

M52. The method according to any of the four preceding method embodiments, the method further comprising projecting at least one hazardous object on the computerized view (200).

M53. The method according to any of the two preceding method embodiments, wherein projecting a cluster of pixels and/or hazardous object on the computerized view (200) comprises drawing an outline of boundary of the cluster of pixels and/or hazardous object on the computerized view (200).

M54. The method according to the preceding method embodiment, wherein projecting a cluster of pixels and/or hazardous object on the computerized view (200) comprises associating a label to the projected cluster of pixels and/or hazardous object, wherein said label comprises at least one of: an ID of the cluster of pixels and/or hazardous object, a type or classification of the projected object, the position of the center of the cluster and/or hazardous object relative to the mobile robot (20).

### Moving Object Detection

M55. The method according to any of the preceding method embodiments, the method comprising capturing at least two ToF sensor images at different times via the at least one ToF sensor (10) and wherein determining whether at least one cluster of pixels corresponds to a hazardous object in the outdoor setting comprises determining whether the at least one cluster of pixels corresponds to a moving object in the outdoor setting.

M56. The method according to the preceding method embodiment and with the features of embodiment M51, wherein determining whether the at least one cluster of pixels corresponds to a moving object in the outdoor setting comprises identifying at least two clusters projected on the computerized view (200) on different positions that correspond to the same moving object in the outdoor setting.

M57. The method according to the preceding method embodiment, wherein the method comprises estimating a speed and direction of movement (i.e. velocity) of a moving object in the outdoor setting based on
the positions of at least two clusters projected on the computerized view (200) that are identified to correspond to the same moving object in the outdoor setting and
the difference between the capturing times of the at least two ToF sensor images wherein said clusters were detected.

M58. The method according to the preceding method embodiment, the method further comprising tracing the movement of a moving object in the outdoor setting.

M59. The method according to any of the four preceding method embodiments, the method comprising detecting fast moving objects, such as, moving vehicles.

### Hazardous Object Detection Facilitating Steps

M60. The method according to any of the preceding method embodiments, wherein determining whether at least one cluster of pixels corresponds to a hazardous object in the outdoor setting comprises applying at least one geometric rule,

wherein the at least one geometric rule comprises determining whether a cluster corresponds to a hazardous object based on geometric information that can be extracted from the object, such as, location, size, orientation, shape of the cluster.

M61. The method according to the preceding method embodiment, wherein the at least one geometric rule comprises determining whether a cluster corresponds to a hazardous object by determining whether the cluster is connected to the ground.

M62. The method according to the preceding method embodiment, wherein based on the geometric rule for a cluster that is connected to the ground it is determined with a higher likelihood that it is a hazardous object than for a cluster that is not connected to the ground.

M63. The method according to any of the preceding method embodiments and with the features of embodiment M2, wherein the method comprises capturing at least one first ToF sensor image with at least one ToF sensor (10) configured with a first ambiguity distance and at least one second ToF sensor image with at least one ToF sensor (10) configured with a second ambiguity distance, wherein the first ambiguity distance is different from the second ambiguity distance.

M64. The method according to the preceding method embodiment, wherein the method comprises
detecting a first cluster on the at least one first ToF sensor image and a corresponding second cluster on the at least one second ToF sensor image wherein the first cluster and the corresponding second cluster correspond to the same object in the outdoor setting and
generating with a first likelihood a first location hypothesis of the said object based on the measured distance of the first cluster on the at least one first ToF sensor image and
generating with a second likelihood a second location hypothesis of the said object based on the measured distance of the second cluster on the at least one second ToF sensor image and
generating with a third likelihood a third location hypothesis based on the first location hypothesis and the second location hypothesis and wherein the third likelihood is higher than the first likelihood and the second likelihood.

M65. The method according to the preceding method embodiment, wherein
the first location hypothesis comprises a first set of multiple locations related to the location of the object and
the second location hypothesis comprises a second set of multiple locations related to the location of the object and
the third location hypothesis comprises a third set of one or multiple locations related to the location of the object, wherein the third set is smaller than the first and second set.

M66. The method according to the preceding method embodiment, wherein the third set is generated based on the intersection of the first set and the second set.

M67. The method according to any of the preceding method embodiments, the method further comprising determining a region of interest on the at least one ToF sensor image and the data processing unit processing only the region of interest to identify at least one cluster of pixels on the at least one ToF sensor image based on at least one pixel-clustering parameter.

M68. The method according to the preceding method embodiment, wherein determining the region of interest on the at least one ToF sensor image comprises partially or fully excluding parts of the ToF sensor image that comprise a high likelihood of corresponding to the ground and/or sky.

M69. The method according to any of the two preceding method embodiments, wherein the ToF sensor (10) outputs ToF sensor image comprising only the region of interest.

M70. The method according to any of the preceding method embodiments and with the features of embodiment M2, wherein the method comprises
capturing at least one first ToF sensor image at a first mobile robot (20) position and at least one second ToF sensor image at a second mobile robot (20) position
detecting a first cluster on the at least one first ToF sensor image and a corresponding second cluster on the at least one second ToF sensor image wherein the first cluster and the corresponding second cluster correspond to the same object in the outdoor setting and
generating with a first likelihood a first location hypothesis of the said object based on a measured distance and angle to the first cluster based on the at least one first ToF sensor image and
generating with a second likelihood a second location hypothesis of the said object based on the measured distance and angle to the second cluster on the at least one second ToF sensor image and
generating with a third likelihood a third location hypothesis using a triangulation technique based on the first location hypothesis and the second location hypothesis and wherein the third likelihood is higher than the first likelihood and the second likelihood.

M71. The method according to any of the preceding method embodiments, the method further comprising calculating a blurriness parameter for at least one portion of a ToF sensor image, wherein the blurriness parameter indicates a degree of image blurring for the at least one portion of the ToF sensor image.

M72. The method according to the preceding method embodiment, wherein the blurriness parameter is calculated for at least one cluster of pixels.

M73. The method according to the preceding method embodiment and with the features of embodiment M2, wherein the blurriness parameter of a cluster of pixels is utilized to disambiguate an ambiguous distance measurement to the cluster of pixels.

M74. The method according to any of the two preceding method embodiments and with the features of embodiment M2, wherein
a distance to a cluster of pixels is determined from the distance image and
a first location hypothesis and a second location hypothesis for the cluster are generated based on the distance to the cluster of pixels, wherein the first location hypothesis is closer to the mobile robot (20) than the second location hypothesis and
wherein based on the blurriness parameter calculated for the cluster of pixels, one of the first location hypothesis and second location hypothesis is determined as the location of the cluster of pixels.

M75. The method according to the preceding method embodiment, wherein the first location hypothesis is chosen if the blurriness parameter is smaller than a blurriness threshold value and the second location hypothesis is chosen if the blurriness parameter is larger than a threshold value.

### Combination With Visual Cameras

M76. The method according to any of the preceding method embodiments, wherein the at least one ToF sensor (10) senses infrared signal, such as electromagnetic waves with wavelengths between 700 – 1400 nm, preferably between 750 – 1050 nm.

M77. The method according to any of the preceding method embodiments, wherein the method further comprises emitting infrared signal, such as electromagnetic waves with wavelengths between 700 – 1400 nm, preferably between 750 – 1050 nm, preferably during the step of capturing the at least one ToF sensor image.

M78. The method according to any of the preceding method embodiments, wherein the method further comprises equipping the mobile robot (20) with at least one visual camera and capturing at least one visual camera image with the at least one visual camera.

M79. The method according to the preceding method embodiment, wherein the visual camera captures at least one visual camera image by sensing visible light, such as, electromagnetic waves with wavelengths between 380 to 740 nm.

M80. The method according to any of the two preceding method embodiments, wherein the method further comprises processing the at least one visual camera image to identify at least one cluster of pixels on the at least one visual camera image based on the at least one pixel-clustering parameter.

M81. The method according to the preceding method embodiment, wherein the at least one pixel-clustering parameter of a pixel comprises a color of the pixel on the visual camera image.

M82. The method according to any of the four preceding method embodiments, wherein the method comprises capturing the at least one ToF sensor image and at least one visual camera image simultaneously (i.e. within a significantly small time-difference).

M83. The method according to any of the five preceding method embodiments, wherein the method comprises fusing at least one visual camera image with at least one ToF sensor image and generating a fused image, wherein the fused image comprises information extracted from the at least one visual camera image and the at least one ToF sensor image.

M84. The method according to the preceding method embodiment, wherein the method further comprises processing the at least one fused image to identify at least one cluster of pixels on the at least one visual camera image based on the at least one pixel-clustering parameter.

M85. The method according to any of the seven preceding method embodiments, wherein the at least one ToF sensor (10) and the at least one visual camera image comprise similar or intersecting fields of view.

M86. The method according to any of the preceding method embodiments, wherein the method further comprises equipping the mobile robot (20) with at least one stereo camera and capturing at least one stereo image with the at least one stereo camera.

M87. The method according to the preceding method embodiment, wherein a distance image is generated based on the stereo image.

M88. The method according to the preceding method embodiment and with the features of embodiment M2, wherein the distance image generated by the ToF sensor (10) and the distance image generated by the stereo camera are utilized to increase the accuracy of a distance measurement to a segment of the outdoor setting.

M89. The method according to any of the preceding method embodiments, wherein a blurriness parameter for a portion on a ToF sensor image is calculated based on a corresponding portion on a visual camera image and/or stereo camera image.

### Custom Optical Lens

M90. The method according to any of the preceding method embodiments, wherein the method comprising equipping the at least one ToF sensor (10) with a custom optical lens (15).

M91. The method according to the preceding method embodiment, wherein an illumination unit of a ToF sensor (10) is equipped with an optical lens (15) such that the shape of the emitted light by the illumination unit is changed by the optical lens (15).

M92. The method according to the preceding method embodiment, wherein the lens reshapes the emitted light by the illumination unit such that it comprises a full width of the beam at half its maximum intensity (FWHM) between 30° to 35°, such as, 33° vertically and full width at 90% of the maximum value between 60° to 70°, preferably 66° horizontally.

### Data Processing Unit

M93. The method according to any of the preceding method embodiments, wherein the data processing unit carries out at least one of the steps of the method.

M94. The method according to the preceding embodiment, wherein the data processing unit automatically executes at least one of the steps of the method while the mobile robot (20) is travelling.

M95. The method according to any of the two preceding embodiments, wherein the data processing unit is triggered by an event to carry out at least one of the steps of the method.

M96. The method according to the preceding embodiments, wherein the event comprises the mobile robot (20) approaching a road crossing.

M97. The method according to any of the preceding embodiments, wherein the method comprises setting a velocity of the mobile robot (20) based on the determination whether at least one cluster of pixels corresponds to a hazardous object in the outdoor setting.

M98. The method according to the preceding embodiment, wherein the method comprises the mobile robot (20) crossing a road based on the determination whether at least one cluster of pixels corresponds to a hazardous object (e.g. a moving car) in the outdoor setting.

M99. The method according to any of the two preceding embodiments, wherein the method comprises configuring the trajectory of the mobile robot (20) to avoid an obstacle based on the determination whether at least one cluster of pixels corresponds to a hazardous object (e.g. an obstacle) in the outdoor setting.

M100. The method according to any of the preceding embodiments, wherein the method is a computer-implemented method.

Below, mobile robot embodiments will be discussed. These embodiments are abbreviated by the letter “R” followed by a number. Whenever reference is herein made to “robot embodiments”, these embodiments are meant.

R1. A mobile robot (20) configured to travel in outdoor settings, the mobile robot comprising at least one ToF sensor (10).

R2. The mobile robot (20) according to the preceding robot embodiment, wherein the at least one ToF sensor (10) is mounted on the robot (20) at a height from the ground of 10 – 70 cm, preferably 20 – 55 cm, more preferably 40 – 50 cm.

R3. The mobile robot (20) according to any of the preceding robot embodiments, wherein the robot (20) comprises a plurality of ToF sensors (10) mounted on the robot (20) and wherein at least a part of them can be mounted at the same height (or approximately at the same height) from the ground.

R4. The mobile robot (20) according to any of the preceding robot embodiments wherein the robot (20) comprises a plurality of ToF sensors (10) and wherein a first set of ToF sensors (10) are mounted at a first height from the ground and a second set of ToF sensors (10) are mounted at a second height from the ground.

R5. The mobile robot (20) according to any of the preceding robot embodiments, wherein at least one front ToF sensor (10), is mounted at the front of the mobile robot (20), preferably aligned near or at the middle of the front of the robot (20).

R6. The mobile robot (20) according to any of the preceding robot embodiments, wherein at least one side ToF sensor (10), can be mounted on the sides of the robot (20), preferably on the sides of the robot (20) near the front of the robot (20), such as, the front-left and the front-right sides of the mobile robot (20).

R7. The mobile robot (20) according to any of the preceding robot embodiments, wherein the mobile robot (20) comprises at least one visual camera.

R8. The mobile robot (20) according to the preceding robot embodiment, wherein at least one ToF sensor (10) and at least one visual camera are mounted on the robot such that they comprise similar or intersecting fields of view.

R9. The mobile robot (20) according to any of the preceding robot embodiments, wherein the mobile robot (20) comprises at least one stereo camera.

R10. The mobile robot (20) according to the preceding robot embodiment, wherein at least one ToF sensor (10) and at least stereo camera are mounted on the robot such that they comprise similar or intersecting fields of view.

R11. The mobile robot (20) according to any of the preceding robot embodiments, wherein the mobile robot (20) comprises at least one further sensor, such as, at least one of:
at least one radar configured to detect objects (e.g. moving objects) in the surroundings of the robot (20),
at least one GPS sensor configured to provide an estimated geolocation of the mobile robot (20),
at least one odometer configured to measure a distance travelled by the wheels of the robot (20),
at least one odometer and gyroscope configured to measure relative movement of the mobile robot (20) between two different poses,
at least one accelerometer configured to measure acceleration, tilting and orientation of the mobile robot (20).

R12. The mobile robot (20) according to any of the preceding robot embodiments, wherein the mobile robot (20) comprises at least one sensor mounting section (25) configured to facilitate mounting at least one sensor to the mobile robot (20).

R13. The mobile robot (20) according to the preceding robot embodiment, wherein the at least one ToF sensor (10) is mounted on the sensor mounting section (25).

R14. The mobile robot (20) according to any of the two preceding robot embodiments and with the features of embodiment R7, wherein the at least one visual camera is mounted on the sensor mounting section (25).

R15. The mobile robot (20) according to any of the three preceding robot embodiments and with the features of embodiment R9, wherein the at least one stereo camera is mounted on the sensor mounting section (25).

R16. The mobile robot (20) according to any of the four preceding robot embodiments and with the features of embodiment R11, wherein the at least one further sensor is mounted on the sensor mounting section (25).

R17. The mobile robot (20) according to any of the five preceding robot embodiments, wherein the sensor mounting section (25) is configured to provide protection or cover to the at least one sensor attached therein from rain, snow, outdoor temperature, dust and in general any external particle or condition that can damage the at least one sensor mounted in the sensor mounting section (25).

R18. The mobile robot (20) according to any of the six preceding robot embodiments, wherein the sensor mounting section (25) is covered by a transparent cover, wherein the transparent cover can be a cover that minimizes the obfuscation of the view of the attached sensors on the sensor mounting section (25).

R19. The mobile robot (20) according to any of the seven preceding embodiments, wherein the sensor mounting section (25) is positioned on the front of the mobile robot (20) and is preferably extended around the mobile robot (20).

R20. The mobile robot (20) according to any of the eight preceding embodiments, wherein the sensor mounting section (25) is positioned at a height from the ground of 10 – 70 cm, preferably 20 – 60 cm, more preferably 40 – 60 cm.

R21. The mobile robot (20) according to any of the nine preceding embodiments, wherein the sensor mounting section (25) comprises a larger area at the front of the mobile robot (20) to accommodate a higher number of sensors as compared to the other sides.

R22. The mobile robot (20) according to any of the preceding robot embodiments, wherein the mobile robot (20) is operated according to the method according to any of the preceding method embodiments.

R23. The mobile robot (20) according to the preceding embodiment, wherein the mobile robot (20) comprises the data processing unit.

Below, optical lens embodiments will be discussed. These embodiments are abbreviated by the letter “L” followed by a number. Whenever reference is herein made to “optical lens embodiments”, these embodiments are meant.

L1. An optical lens (15) configured to reshape light emitted by an illumination unit that provides active illumination for at least one ToF sensor (10) of a mobile robot (20).

L2. The optical lens (15) according to the preceding optical lens embodiment, comprising a focal length of 2 to 6 mm, such as, 4 mm.

L3. The optical lens (15) according to any of the preceding optical lens embodiments, comprising a refractive index of the lens material of 1.4 to 1.6, such as, 1.5.

L4. The optical lens (15) according to any of the preceding optical lens embodiments, wherein the optical lens (15) is configured to reshape the emitted light by the illumination unit such that it comprises a full width of the beam at half its maximum intensity (FWHM) between 30° to 35°, such as, 33° vertically and full width at 90% of the maximum value between 60° to 70°, preferably 66° horizontally.

L5. The optical lens (15) according to any of the preceding optical lens embodiments, wherein the optical lens (15) is configured to reshape the emitted light by the illumination unit, such that the power in the field of view of the at least one ToF sensor (10) is at least 70% of the total power emitted by the illumination unit, preferably at least 80%.

L6. The optical lens (15) according to any of the preceding embodiment, wherein the at least one ToF sensor (10) comprises a field of view with a spread of 80° to 88°, such as 85.12°, horizontally and 60° to 75°, such as 69.05°, vertically.

Below, system embodiments will be discussed. These embodiments are abbreviated by the letter “S” followed by a number. Whenever reference is herein made to “system embodiments”, these embodiments are meant.

S1. A system configured to operate a mobile robot (20) comprising
a mobile robot (20) configured to travel in an outdoor setting and comprising at least one ToF sensor (10) configured to capture at least one ToF sensor image; and
a data processing unit configured to
   process the at least one ToF sensor image to identify at least one cluster of pixels on the at least one ToF sensor image based on at least one pixel-clustering parameter; and
   determine whether at least one cluster of pixels corresponds to a hazardous object in the outdoor setting.

S2. The system according to the preceding embodiment, wherein the mobile robot (20) is configured according to any of the preceding robot embodiments.

S3. The system according to any of the preceding system embodiments, wherein the mobile robot (20) comprises at least one illumination unit configured to provide active illumination for the at least one ToF sensor (10).

S4. The system according to the preceding embodiment, wherein the mobile robot (20) comprises a custom optical lens (15) configured to reshape light emitted by the illumination unit.

S5. The system according to the preceding embodiment, wherein the custom optical lens (15) is configured according to any of the preceding optical lens embodiments.

S6. The system according to any of the preceding system embodiments, wherein the system further comprises a server and the server partially or fully comprises the data processing unit.

S7. The system according to the preceding embodiment, wherein the mobile robot (20) and the server comprise respective communication units configured to allow a bi-directional communication between the robot (20) and the server.

S8. The system according to any of the preceding system embodiments configured to execute the method according to any of the preceding method embodiments.

Below, use embodiments will be discussed. These embodiments are abbreviated by the letter “U” followed by a number. Whenever reference is herein made to “use embodiments”, these embodiments are meant.

U1. Use of the method according to any of the preceding method embodiments for operating a mobile robot (20), particularly at low-light conditions, such as, during nighttime.

U2. Use of the method according to any of the preceding method embodiments for detecting at least one obstacle in an outdoor setting wherein a mobile robot (20) is travelling, particularly at low-light conditions, such as, during nighttime.

U3. Use of the method according to any of the preceding method embodiments for detecting at least one moving object, such as a moving vehicle, in an outdoor setting wherein a mobile robot (20) is travelling, particularly at low-light conditions, such as, during nighttime.

### BRIEF DESCRIPTION OF DRAWINGS

FIG. 1 illustrates an exemplary embodiment of a mobile robot comprising at least one time-of-flight sensor;

FIG. 2a lists the steps of a method for detecting at least one object and/or at least one hazardous object by utilizing at least one ToF sensor;

FIG. 2b illustrates a computerized view of an outdoor setting that can facilitate the operation of the mobile robot in the outdoor setting;

FIG. 2c illustrates a computerized view of an outdoor setting that can facilitate detecting at least one moving object;

FIG. 2d illustrates a two-phase clustering method;

FIG. 2e illustrates grouping of clusters in a subregion column;

FIG. 3a depicts a plurality of techniques or steps that can facilitate detecting objects and/or hazardous objects;

FIG. 3b depicts a combiner engine that is configured to combine a plurality of techniques or steps that can facilitate detecting objects and/or hazardous objects;

FIG. 4 illustrates a step of facilitating the detection of objects and/or hazardous object based on a geometric rule;

FIG. 5 illustrates a step of facilitating the detection of objects and/or hazardous object based on distance images with different range ambiguity;

FIG. 6 illustrates a step of facilitating the detection of objects and/or hazardous object based on triangulation techniques;

FIG. 7 depicts embodiments of a mobile robot comprising at least one ToF sensor and at least one visual camera;

FIG. 8a depicts a typical behavior of distance measurement uncertainty dependence on distance of exemplary stereo cameras and exemplary ToF sensor;

FIG. 8b depicts the indicated region of FIG. 8a zoomed-in;

FIGS. 8c and 8d depicts the combined distance measurement uncertainty when determining the distance using both the ToF sensor and the stereo cameras;

FIG. 9 depicts a typical behavior of the distance measurement uncertainty of a ToF sensor as a function of amplitude of the reflected light;

FIG. 10a depicts an embodiment of a mobile robot comprising at least one ToF sensor equipped with a custom optical lens;

FIG. 10b illustrates blind spot creation in ToF sensor images due to lack of illumination of some regions of the outdoor setting;

FIG. 10c illustrates an efficient distribution of the illumination on the outdoor setting achieved by the use of the custom optical lens.

### DETAILED DESCRIPTION OF DRAWINGS

In the following, exemplary embodiments of the invention will be described, referring to the figures. These examples are provided to give further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps can be present between some or all of the described steps.

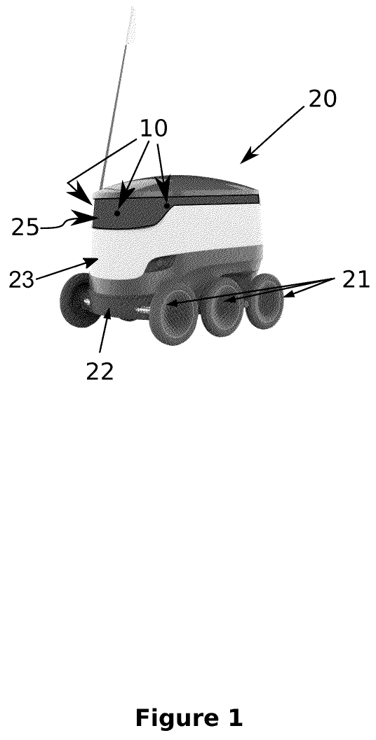

FIG. 1 shows an embodiment of a mobile robot 20. The robot 20 can comprise wheels 21 adapted for land-based motion. The wheels 21 can be mounted to a frame 22. A body 23 can be mounted on the frame 22. Body 23 can comprise an enclosed space (not shown), that can be configured to carry at least one item for delivery. Further, the mobile robot 20 can comprise a motion generation system (not shown), e.g., an electric and/or combustion engine, powered by battery and/or fuel. Further still the mobile robot 20 can comprise at least one controller system (not shown) which can be programmed and/or configured to receive instructions from a user terminal (not shown), e.g. remotely. The controller system of the robot 20 can facilitate a partial or a fully autonomous operation of the mobile robot 20. The mobile robot 20 can also comprise a communication unit (not shown), such as, a wireless communication unit, e.g. a long-range wireless communication unit. The communication unit can be configured to allow the mobile robot 20 to send and/or receive data with at least one external and/or distant device or system, such as, another mobile robot, server, user terminal, remote controller, etc. The mobile robot 20 can also comprise a communication unit configured for short range communication configured to allow the mobile robot 20 to communicate with at least one non-distant external device, such as, a remote controller.

In some embodiments, the mobile robot 20 can be a delivery robot 20. It can, for example, be configured to carry out last-mile delivery. That is, the robot 20 can be configured to receive at least one delivery item in the enclosed space of the body 23. The robot 20 can receive the delivery item at a delivery start location (e.g. a parcel shop, shop, bar, restaurant, storage location, a user’s home, etc.) and can be configured to transport the item to a recipient address. The robot 20 may be configured to travel autonomously or partly autonomously at least from the delivery start location to the recipient address. Preferably the robot 20 can be configured to travel (e.g. by default) in an autonomous mode (i.e. without a human operator assistance). In some embodiments, the robot 20 traveling in autonomous mode may be assisted by an external server. For example, the external server may carry out tasks requiring extensive computational resources and/or memory capacity and/or tasks that are not related to a fast response of the robot 20 (i.e. tasks with a non-critical time restrictions). Additionally, the robot 20 may be configured to request a human operator assistance in some scenarios or instances, such as, more than usual dangerous scenarios, e.g. crossing a road, low uncertainty during a problem solving or decision taking, etc. Advantageously, the robot 20 can be configured (or optimized) to maximize the autonomous driving time and minimize the number of requests and time for human operator assistance.

In other words, the mobile robot 20 can operate autonomously or partially autonomously. For example, the autonomy level of the mobile robot 20 can be between the levels 1 to 5, as defined by the Society of Automotive Engineers (SAE) in J3016 -Autonomy Levels. In some embodiments the mobile robot 20 can be controlled (e.g. steered) by a human operator through a user terminal (i.e. the user terminal can exchange data with the mobile robot). In some other embodiments, the robot 20 is assisted by the human operator only in some instances, e.g. in particular situations imposing more risk, such as, crossing a road. In other embodiments, the robot 20 can be fully autonomous -that is, can navigate, drive and carry out an assigned task without human intervention.

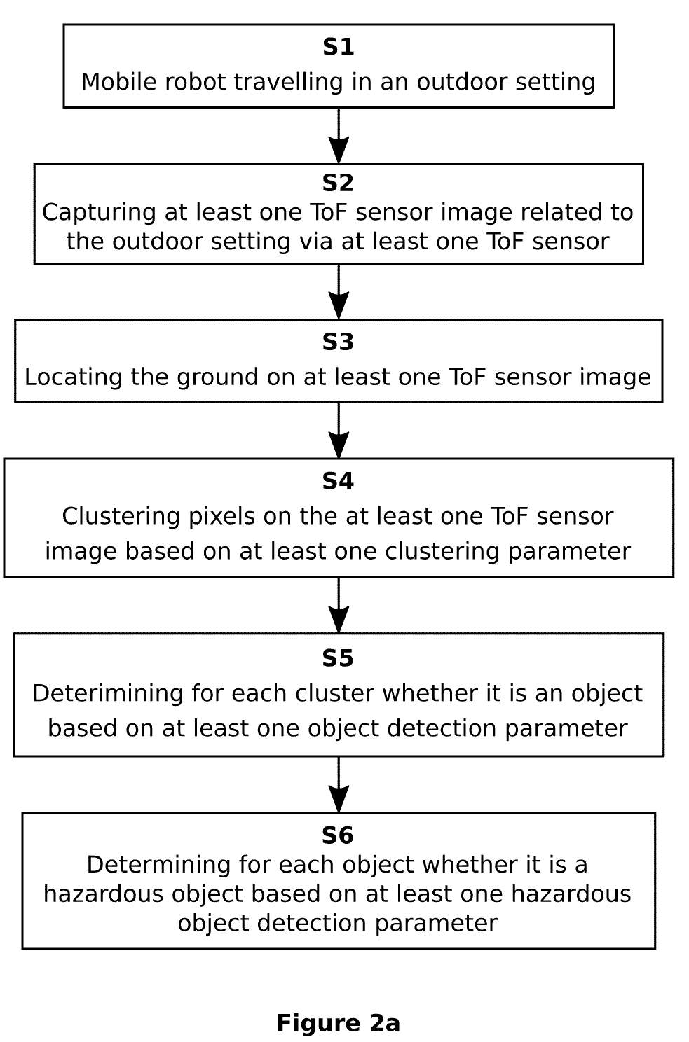

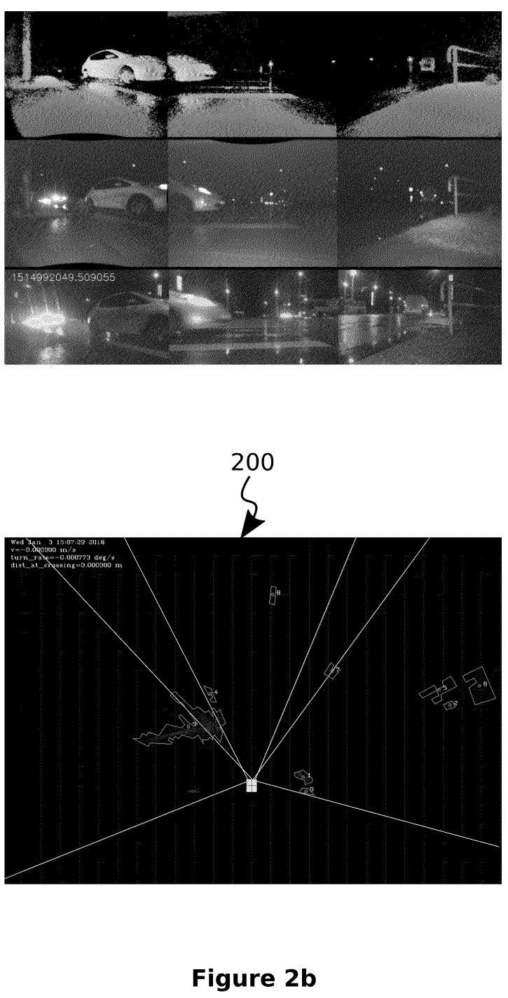

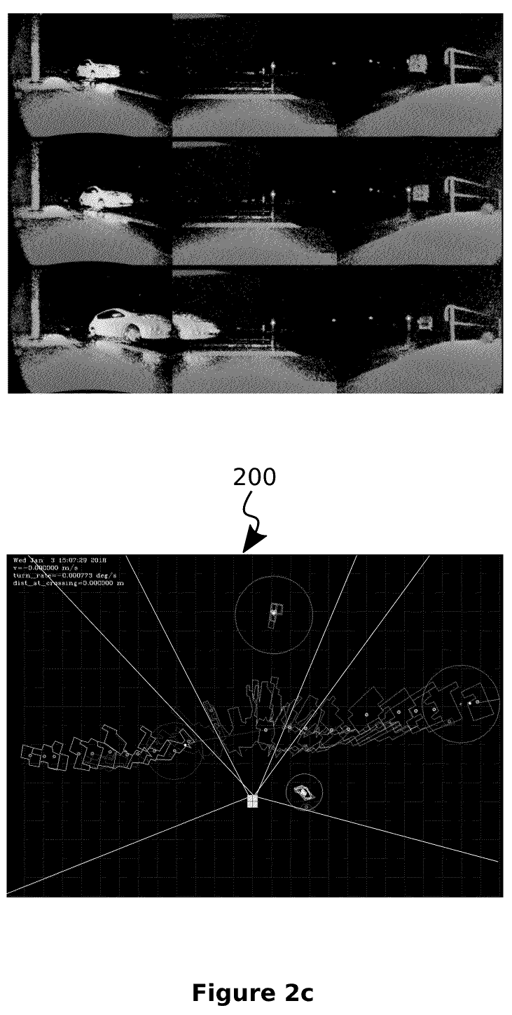

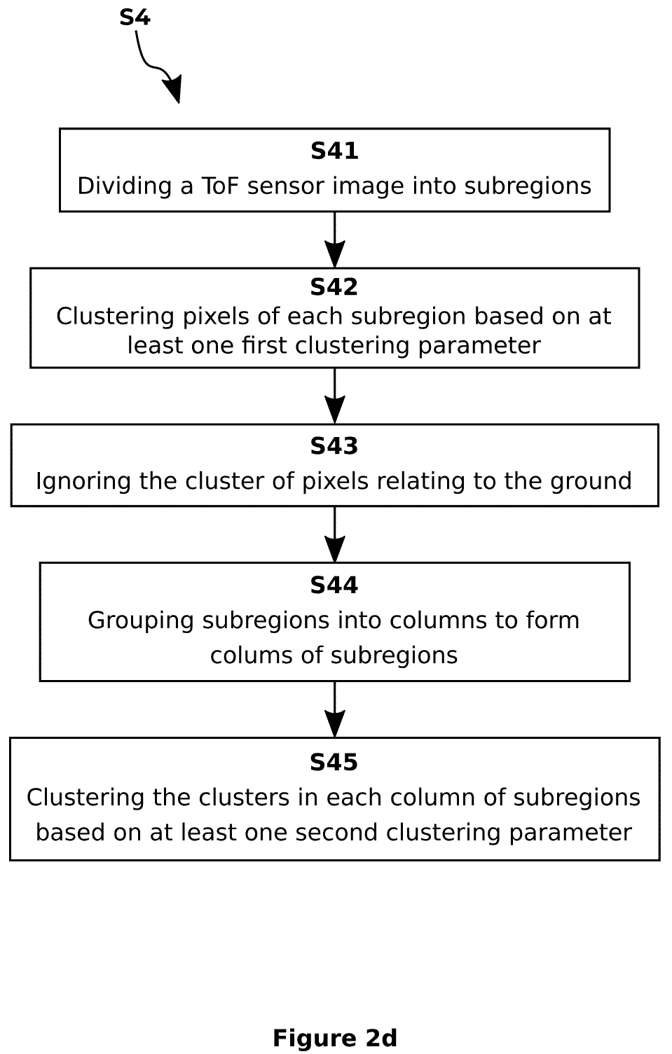

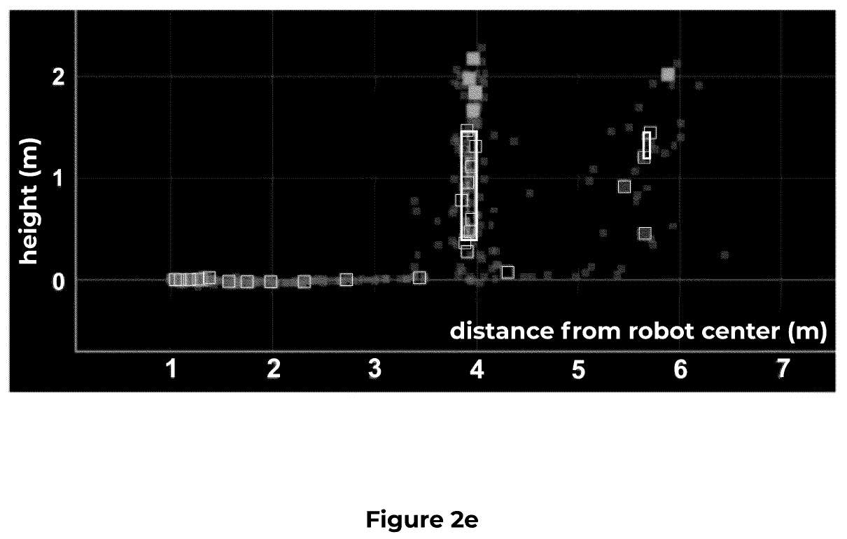

Driving and navigation of mobile robots 20 can be facilitated by a computerized view (e.g. see FIG. 2b) of its surroundings (i.e. computer vision). The computer vision can facilitate the autonomous driving of the mobile robot 20. Additionally, it can facilitate a human operator to assist (e.g. control) the mobile robot 20. Thus, the mobile robot 20 can be equipped with various sensors that acquire and provide information related to the surroundings of the mobile robot 20. Among other sensor devices, the mobile robot 20 can comprise at least one ToF sensor 10.

In some embodiments, at least one ToF sensor 10 can be mounted on the robot 20 at a height from the ground of 10 – 70 cm, preferably 20 – 55 cm, more preferably 40 – 50 cm. Further, when a plurality of ToF sensors 10 are mounted on the robot 20, at least a part of them can be mounted at the same height (or approximately at the same height) from the ground. This can facilitate combining the fields of view provided by the multiple ToF sensors 10 mounted at the same height. Further still, when a plurality of ToF sensors 10 are mounted on the robot 20, a first set of ToF sensors 10 are mounted at a first height from the ground and a second set of ToF sensors 10 are mounted at a second height from the ground. Thus, a first extended field of view can be obtained by merging the fields of view of the first set of ToF sensors 10 and a second extended field of view can be obtained by merging the fields of view of the second set of ToF sensors 10. An even further extended field of view can be obtained by merging the first extended field of view and the second extended field of view. An even further extended field of view, can be obtained by merging a field of view of at least one ToF sensor 10 with a field of view of at least one other sensor type (e.g. visual camera) of the robot 20. Some examples of images of extended fields of view are shown in FIGS. 2b, 2c, 4c, 10b. For example, FIGS. 2c, 4c and 10b show images obtained by merging the fields of view of three ToF sensors, while FIG. 2b shows images obtained by merging the fields of view of three ToF sensors and three visual cameras.

Further, at least one ToF sensor 10, which can be referred to as front ToF sensor 10, can be mounted at the front of the mobile robot 20, preferably aligned near or at the middle of the front of the robot 20. The front of the robot 20, refers to the side of the robot 20 toward the direction of forward driving. If multiple front ToF sensors 10 are provided they can be distributed (e.g. equidistantly separated from each other) at the front part of the robot 20. Thus, the at one least front ToF sensor 10 can provide a field of view of the front of the robot 20. If multiple front ToF sensors 10 are provided their fields of view can be combined (i.e. merged) to obtain an extended front field of view.

Further still, at least one ToF sensor 10, which can be referred to as side ToF sensor 10, can be mounted at the sides of the robot 20, preferably at the sides of the robot 20 near the front of the robot 20. Thus, the robot 20 can have a wider front field of view including a (partial) field of view at the direction toward the sides of the robot 20.

For example, in FIG. 1 the robot 20 can comprise three ToF sensors 10, more particularly, a front ToF sensor 10 mounted on the front of the robot 20 (e.g. the middle ToF sensor in FIG. 1) and two side ToF sensors 10 mounted on the left and right side of the robot 20, near the front. Further, as depicted in FIG. 1 the ToF sensors 10 are provided approximately at the same height from the ground. This can facilitate the merging of their fields of view. Further still, the ToF sensors 10 are mounted near the top of the robot 20 and preferably oriented horizontally. This can provide a better field of view of the surroundings of the robot 20 (e.g. most of the field of view cannot comprise the ground or the sky, which may not comprise necessary information).

The mobile robot 20 can comprise further sensors or other types of sensors (not shown), such as, at least one of: at least one visual camera e.g. stereo cameras, configured to capture visual images, at least one radar configured to detect objects (e.g. moving objects) in the surroundings of the robot 20, at least one GPS sensor configured to provide an estimated geolocation of the mobile robot, at least one odometer configured to measure a distance travelled by the wheels 21 of the robot 20, at least one odometer and gyroscope configured to measure relative movement of the mobile robot between two different poses, at least one accelerometer configured to measure acceleration, tilting and orientation of the mobile robot. It should be noted that the above list of further sensors that can be comprised by the mobile robot 20 is not an exhaustive list of all the sensors that can be comprised by the robot 20.

In some embodiments, the mobile robot 20 can comprise a sensor mounting section 25. The sensor mounting section 25 can be configured to facilitate mounting at least one sensor (e.g. ToF sensor 10) therein. The sensor mounting section 25 can be configured to allow the attached sensors therein a view of the surroundings of the robot 20. That is, the sensor mounting section can be configured to not obstruct the field of view of the sensors mounted therein. The sensor mounting section 25 can be configured to allow and/or facilitate fixating at least one sensor therein in a detachable or non-detachable manner. The sensor mounting section 25 can be configured to provide protection or cover to the at least one sensor attached therein from rain, snow, outdoor temperature, dust and in general any external particle or condition that can damage the at least one sensor. Preferably, the sensor mounting section 25 can be covered by a transparent cover, wherein the transparent cover can be a cover that minimizes the obfuscation of the view of the attached sensors on the sensor mounting section 25. The sensor mounting section 25 can be positioned on the front of the mobile robot 20 and can preferably extend around the mobile robot 20 (i.e. on all the sides). The sensor mounting section 25 can be positioned at a height from the ground of 10 – 70 cm, preferably 20 – 60 cm, more preferably 40 –60 cm. The sensor mounting section 25 can comprise a larger area at the front of the mobile robot 20 wherein generally a higher number of sensors need to be mounted as compared to the other sides – to provide a more complete or detailed view of the front of the mobile robot 20.

In some embodiments, the at least one ToF sensor 10 can be mounted at the sensor mounting section 25. Other sensors, generally sensors that require a field of view on the surroundings of the robot 20, such as, visual cameras, stereo cameras, radars, ultrasound sensors, etc., can be further mounted at the sensor mounting section 25. It will be noted, that alternatively or additionally, the robot 20 may comprise further sensor not mounted on the sensor mounting section 25 – e.g. the sensor may be mounted directly on the body 23 or frame 22 of the robot 20. Alternatively or additionally, the sensor mounting section 25 may not be provided and at least one of the sensors of the mobile robot 20 can be directly mounted on the robot, e.g. on the body 23 or frame 22 of the robot 20.

In a still further embodiment, the robot 20 can comprise at least one moving sensor mounting section (not shown). The moving sensor mounting section can be configured to allow and/or facilitate mounting in a detachable or non-detachable manner at least one sensor, such as, at least one ToF sensor 10. The moving sensor mounting section can be configured to provide protection against weather conditions or external damaging particles (e.g. dust) to the at least one sensor attached therein. Furthermore, the moving sensor mounting section can be attached to a motion generator (not shown). The motion generator (i.e. actuator) can be configured to provide rotational and/or translational movement of the moving sensor mounting section relative to the mobile robot 20. The motion generator and the moving sensor mounting section can be configured to position and orient the at least one sensor attached to the moving sensor mounting section such that an intended portion of the surroundings of the robot 20 can be sensed by the at least one sensor. For example, the moving sensor mounting section may comprise a robotic arm.

The robot 20 can comprise one or a plurality of sensor mounting section(s) 25. The mobile robot can comprise one or a plurality of moving sensor mounting section(s) (not shown). In general, the robot 20 can comprise any combination of at least one sensor mounting section 25 and at least one moving sensor mounting section.

FIG. 2a schematically lists the steps of a method for operating a mobile robot according to an aspect of the present invention. More particularly, FIG. 2a lists the steps of a method for detecting at least one object and/or at least one hazardous object by utilizing at least one ToF sensor. The method illustrated in FIG. 2a is particularly advantageous for detecting objects and/or hazardous objects at low visual light conditions (e.g. during nighttime).

In a step S1, a mobile robot, e.g. a mobile robot 20 according to the embodiment depicted in FIG. 1, is travelling in an outdoor setting. For example, the mobile robot is transporting a delivery item to a recipient. The outdoor setting can comprise, for example, sidewalks, pedestrian walkways, roads, streets, driveways and other outdoor spaces. Objects, people, buildings, traffic participants, traffic signs, etc., can be present in the outdoor setting in addition to the mobile robot. The outdoor setting is meant to differentiate from generally structured and more predictable indoor settings. The outdoor setting generally refers to, in the present context, the immediate surroundings of the mobile robot which it can detect at a given time via its sensors, such as, via its ToF sensors. For example, an outdoor setting may refer to a segment of a street and/or a plurality of streets that the robot can observe via its sensors, such as, via its ToF sensors. An outdoor setting may also refer to a road crossing that the robot can observe via its sensors, such as, via its ToF sensors.

In a step S2, data (i.e. sensor data) related to the outdoor setting is captured (i.e. acquired). This can be done via at least one ToF sensor of the mobile robot. The data captured by a ToF sensor can be referred to as a ToF sensor image. That is, in the step S2 at least one ToF sensor image of the outdoor setting is captured via at least one ToF sensor of the mobile robot. The ToF sensor 10 can capture ToF sensor images at a rate of 2 to 60 frames per second, such as, 4 to 8 frames per second. Generally, a higher frame rate can be advantageous, however the frame rate is limited by the processing power (e.g. of the robot, a data processing device comprised by the robot and/or an external server connected with the robot) or a computational time limit.

The ToF sensor image can comprise a plurality of pixels, wherein each pixel comprises a distance between the ToF sensor and a respective surface (or point) in the outdoor setting. This can be referred to as a distance ToF sensor image (or for the sake of brevity as a distance image) or 3-dimensional (3D) ToF sensor image (or for the sake of brevity as a 3D image). For example, each pixel on the ToF sensor image can be represented by three parameters, which for the sake of brevity can be referred to as x, y, d – wherein, without loss of generality, x and y can indicate a position of the pixel on the image and d can indicate the measured distance between the ToF sensor and a respective surface (or point) in the outdoor setting.

Alternatively, the ToF sensor image can comprise a plurality of pixels, wherein each pixel comprises a light intensity or brightness measurement. This can be referred to as a brightness ToF sensor image (or for the sake of brevity as a brightness image) or 2-dimensional (2D) ToF sensor image (or for the sake of brevity as a 2D image). For example, each pixel on the ToF sensor image can be represented by three parameters, which for the sake of brevity can be referred to as x, y, I – wherein, without loss of generality, x and y can indicate a position of the pixel on the image and I can indicate the measured intensity.

In some embodiments, the ToF sensor can output a ToF sensor image that can comprise distance and brightness information. That is, each pixel on the ToF sensor image can be represented by four parameters, which for the sake of brevity can be referred to as x, y, d, I – wherein, without loss of generality, x and y can indicate a position of the pixel on the image, d can indicate the measured distance between the ToF sensor and a respective surface (or point) in the outdoor setting and I can indicate the measured intensity. The ToF sensor can be configured to simultaneously measure distance and brightness and output a ToF sensor image that comprises distance and brightness information. Alternatively, the ToF sensor can be configured to preform multiple measurements and to output a ToF sensor image that can comprise distance and brightness information based on the multiple measurements. For example, the ToF sensor can perform one or more distance measurement(s) and output a distance image and one or more brightness measurement(s) and output a brightness image and based on the distance image and brightness ToF sensor image that can comprise distance and brightness information can be generated.

In the following, if not otherwise specified by the text or context, the term ToF sensor image is used to generally refer to the distance image, brightness image and/or ToF sensor image that can comprise distance and brightness information.

In an optional step S3, on the at least one ToF sensor image the ground can be located. The ground can, for example, refer to the surface on the outdoor setting wherein the mobile robot is driving or can drive. The ground can, for example, refer to sidewalks, pedestrian walkways, roads, streets, driveways etc. In other words, step S3 can comprise determining which part of the ToF sensor image captures the ground. Step S3 can be performed before capturing the at least one ToF sensor image (e.g. based on the sensor position and orientation) and/or after capturing the at least one ToF sensor image (e.g. by processing the ToF sensor image and detecting the ground therein).

In general, different algorithms for locating the ground on a ToF sensor image can be utilized. In some embodiments, the ground on a ToF sensor image can be located based on a part of the ToF sensor image capturing the outdoor setting just in front of the mobile robot, e.g., the lower part of the image. This is based on the rationale that the area just in front of the ToF sensor and the mobile robot corresponds with high certainty to the ground. From the part of the ToF sensor image selected or assumed to correspond to the ground, information regarding the ground can be extracted. Said information may include position of the ground on the image, distance of the ground from the ToF sensor (or mobile robot), brightness information, etc. Using information extracted from the part of the ToF sensor image selected or assumed to correspond to the ground (or the part of the ToF sensor image selected or assumed to correspond to the ground directly) and one or more extrapolation techniques other parts of the ToF sensor image that can correspond to the ground can be detected.

The extrapolation technique(s) can be based on a pre-determined ground model. For example, a simplistic ground model can be a flat ground. Using the flat ground model, the extrapolation technique(s) can estimate or fit a flat plane on the information extracted from the part of the ToF sensor image selected or assumed to correspond to the ground (or the part of the ToF sensor image selected or assumed to correspond to the ground directly). In another ground model, the ground can be assumed to be tilted. A tilted ground model can be advantageous if the mobile robot is travelling in a tilted or inclined surface. The amount of inclination of the ground (i.e. the slope of the ground) can be inferred based on the orientation (or inclination) of the mobile robot. The orientation or inclination of the mobile robot can be measured by at least one further sensor of the mobile robot, such as, a gyroscope. The slope of the ground can also be a parameter that can be obtained from map data which the mobile robot can access. In general, different ground models can be used. Such models can also consider non-flat (i.e. curved) grounds. The ground model can be constant or location specific (i.e. based on the location, a specific ground model is used). The location specific ground model can be advantageous as for flat areas (or outdoor setting) flat ground models can be used and for non-flat areas (or outdoor setting) tilted and/or curved ground models can be used.

Alternatively or additionally, other techniques or algorithms can be used for locating the ground on a ToF sensor image. For example, a height parameter specifying the distance of the ToF sensor from the ground and gyroscope can be used to estimate the location of the ground on the image.

Step S3 can be performed by a data processing unit which can receive the at least one ToF sensor image or at least the part of the ToF sensor image selected or assumed to correspond to the ground (or at least the information extracted from the part of the ToF sensor image selected or assumed to correspond to the ground). The data processing unit can be comprised by the mobile robot and can be configured to access a memory location wherein the at least one ToF sensor image or at least the part of the ToF sensor image selected or assumed to correspond to the ground (or at least the information extracted from the part of the ToF sensor image selected or assumed to correspond to the ground) can be stored.

Alternatively, the data processing unit can be a server external to the mobile robot. In such embodiments, the mobile robot can comprise a communication component configured to wirelessly communicate (or transfer data, e.g., the at least one ToF sensor image) with the server. This can be advantageous as the server can comprise less limitations regarding the computational power and memory capacity (said limitations generally present in the mobile, space-limited robots).

Alternatively still, a hybrid approach can be taken wherein part of the ground locating task is performed by the mobile robot (i.e. a data processing unit comprised by the mobile robot) and part of the ground locating task is performed in the server.

Furthermore, the ground location (i.e. step S3) can be facilitated by an image segmentation algorithm. The image segmentation algorithm can partition a ToF sensor image into the so-called segments, wherein pixels of the ToF sensor image portioned in a segment share a similar feature or parameter (e.g. distance, brightness).

Locating the ground on a ToF sensor image can be an optional step. If performed, it can facilitate detection of objects (or hazardous objects) in the outdoor setting close to the mobile robot.

In a step S4, the method comprises clustering pixels on the at least one ToF sensor image based on at least one pixel-clustering parameter, which for the sake of brevity can also be referred to as clustering parameter. More particularly, in step S4 some or all of the pixels in a ToF sensor image can be grouped into clusters. A cluster of pixels may refer to a continuous portion of an image such that all the pixels therein or a portion of the pixels therein can comprise an identical or similar clustering parameter. The clustering parameter (which can also be referred to as a similarity feature or similarity parameter) can be a feature or a combination of features of (or related to) a pixel. The clustering parameter can comprise the distance value of the pixel, such as, the d parameter of each pixel (i.e. the depth measurement). In some embodiments, the clustering parameter can comprise a 2-dimensional Euclidean distance of the pixel from the robot center or the ToF sensor, said 2-dimensional Euclidean distance calculated based on the depth measurement (i.e. d parameter of the pixel) and the horizontal position of the pixel on the image. In some further embodiments, the clustering parameter can comprise a 3-dimensional Euclidean distance of the pixel from the robot center or the ToF sensor, said 3-dimensional Euclidean distance calculated as for the 2-dimensional Euclidean distance wherein in addition the height of the pixel (i.e. vertical position of the pixel on the image) is considered. In some embodiments, the above calculations of the Euclidean distances may comprise calculating a horizontal and/or vertical distance between the pixel and the center of the mobile robot or ToF sensor based on the position of the pixel on the image. Hence, pixels can be clustered such that they comprise an identical or similar distance from the center of the mobile robot or ToF sensor. Alternatively or additionally the clustering parameter can comprise the intensity or brightness value of the pixel (i.e. the I parameter of each pixel). Hence, pixels can be clustered such that they comprise an identical or similar intensity (i.e. the I parameter of each pixel).

It will be understood that the expression a distance of a pixel is to be understood as the distance of the portion of the outdoor setting represented by the pixel.

The pixel clustering algorithm in step S4 can be based on an optimization problem. The said optimization problem can be configured to cluster pixel by maintaining a pixel-clustering error below a predetermined error bound. The pixel-clustering error can be calculated such that it can indicate the difference or variation or deviation of the clustering parameters of the pixels in the cluster. For example, the pixel-clustering error can be the standard deviation or the variance of the clustering parameters of the pixels in the cluster. The pixel-clustering error can be calculated by summing the squared differences between the pixel-clustering parameter of each pixel in the cluster and the mean pixel-clustering parameter of the pixel. This is usually referred as the variability of a cluster and it can represent a non-normalized variance. Alternatively or additionally, pixel-clustering error may be calculated for a plurality of clusters (e.g. all the cluster on an image). For example, the pixel-clustering error may comprise a sum of the variabilities of each cluster in an image. This is often referred to as the dissimilarity of a set of clusters.

In some embodiments, the clustering step S4 may comprise configuring a processing unit (which can be referred to as an optimizer processing unit) to solve an optimization problem. The optimizer processing unit can be configured to minimize the pixel-clustering error. For example, the optimizer processing unit can be configured to cluster the pixels on a ToF sensor image, such that, the variability of each cluster is below a threshold error, the average variability of the clusters on a ToF sensor image is below a threshold error, the maximum variability of the clusters is below a threshold error or the dissimilarity of all the clusters (i.e. the sum of the variabilities) is below a threshold error. It will be understood that the above are only some exemplary optimization purposes. That is, an upper bound and/or a lower bound on the pixels-clustering error can be provided to the optimizer processing unit.

In some embodiments, the clustering step S4 may comprise configuring a processing unit (which can be referred to as an optimizer processing unit) to cluster all the neighboring pixels with an identical or similar pixel-clustering parameter. For example, the optimizer processing unit can be configured to cluster all the neighboring pixels with a distance difference smaller than a predefined threshold value, such as, 0.5 meters. In such embodiments, the clustering based on the similarity of the clustering parameter can be further constrained by an upper bound on the pixel-clustering error.

In some embodiments, the clustering step S4 may comprise configuring a processing unit (which can be referred to as an optimizer processing unit) to identify a predefined number (or range) of clusters. That is, an upper bound and/or lower bound on the number of clusters can be provided to the optimizer processing unit.

To put it simply, the optimizer processing unit can be configured to cluster the pixels based on at least one pixel-clustering parameter by minimizing the pixel-clustering error and/or clustering pixels with similar pixel-clustering parameter and/or a range of clusters to be identified. For example, the optimizer processing unit can cluster the pixels on a ToF sensor distance image based on the distance value of each pixel and the position of the pixels on the image. The clustering can be performed such that the variability of the clusters is minimized e.g. by ensuring that pixels in a cluster have a maximum distance difference of 0.5 meters.

There can be a trade-off between maximizing the number of pixels in a cluster and minimizing the pixel-clustering error. That is, maximizing the number of pixels in a cluster can result in big clusters with pixels therein sharing significantly different clustering parameters. This may not be advantageous as, for example, objects would be detected to be larger than they actually are and/or multiple objects would be detected as one cluster. On the other hand, minimizing the pixel-clustering error can result in small clusters with pixels therein sharing almost identical clustering parameters. This may not be advantageous as, for example, objects would be detected to be smaller than they actually are and/or multiple clusters corresponding to the same object would be detected and/or the probability of detecting artefacts (i.e. clusters not representing objects) would be increased. Thus, it can be advantageous to configure the pixel clustering algorithm in step S4 to simultaneously maximize the number of pixels on the cluster (i.e. area of the cluster) and minimize the pixel-clustering error. This can alleviate the above-mentioned problems in this paragraph.

The optimizer processing unit may be comprised by a data processing unit comprised by the mobile robot and/or a server external to the mobile robot. Alternatively, the data processing unit comprised by the mobile robot and/or a server external to the mobile robot can be the optimizer processing unit configured as above.

In some preferred embodiments, the clustering of the pixels of the at least one ToF sensor image can be a two-phase-clustering process. This is illustrated in FIG. 2d, wherein step S4 is detailed.

In a first clustering step S41, a ToF sensor image can be divided into subregions, preferably equally-sized subregions. The subregions can comprise a rectangular shape. Furthermore, the subregions may comprise a size of 4×4 pixels (i.e. a width of 4 pixels and a height of 4 pixels). In some embodiments, a ToF sensor image may be divided into 1200 subregions arranged in 40 columns and 30 rows. That is, a ToF sensor image may be divided into 40×30 subregions. It will be understood, other shapes and sizes can be used as well. For example, in some embodiments, a ToF sensor image may be divided into subregions, wherein each subregion may comprise at least 1 pixel (preferably at least 2 pixels) and at most 1000 pixels, such as, 16 pixels. In some embodiments, each subregion may comprise a size of at least 2×2 pixels and at most 20×20 pixels, such as, a size of 4×4 pixels. In some embodiments, a ToF sensor image may be divided into at least 4 subregions and at most 20000 subregions, preferably at least 48 and at most 4800 subregions, such as 1200 subregions. In one particular embodiment, a ToF sensor image may comprise a size of 160×120 pixels and it may be divided into 1200 subregions arranged into 40 columns and 30 rows and each subregion may comprise a size of 4×4 pixels.

Thus, instead of processing the ToF sensor image as a whole, in a preferred clustering method as depicted in FIG. 2d, the ToF sensor image is divided into subregions. The division into subregions can be advantageous to reduce noise in the ToF camera point cloud. Point cloud is a common term used in the art and refers to a set of data points, in this case, it refers to the pixels on a ToF sensor image. The point cloud can be significantly noisy due to different factors, such as, low illumination, motion blur, flying pixels, etc. As such, considering the point cloud of the entire ToF sensor image may produce suboptimal results. However, dividing the ToF sensor image into regions and performing the clustering on each subregion independently can reduce noise and thus, increase quality.

In a second clustering step S42 a first clustering phase is performed. More particularly, in each of the subregions, pixels with a similar clustering parameter can be grouped together. These groups can be referred to as clusters. The clustering parameter used during the first clustering phase (which can be referred to as a first clustering parameter) can be a distance parameter (as also discussed above) – particularly when the ToF sensor image comprises a distance image. That is, in the first clustering phase (i.e. step S42), the pixels to be clustered must be positioned on the same subregion of the ToF sensor image and the clustering can be performed based on the distance pixel value. If the neighboring pixels are more than 0.5 meters apart, they belong to separate clusters. Alternatively, neighboring pixels with a distance difference less than 0.5 meters can be clustered. The distance for a pixel can be the depth measurement, 2-dimensional Euclidean distance, 3-dimensional Euclidean distance (as discussed above).

In step S42, different clustering techniques can be used. Some exemplary clustering techniques that can be used, are flat clustering techniques (e.g. the K-means algorithm) or hierarchical clustering techniques (agglomerative or divisive). Additionally or alternatively, the density-based spatial clustering of applications with noise (DBSCAN) can be utilized to facilitate pixel clustering. Additionally or alternatively, machine learning algorithms can be utilized to increase the efficiency of pixel clustering.

In some embodiments, step S42 comprises configuring the optimizer processing unit to cluster the pixels in a subregion, as discussed above. That is, the optimizer processing unit in step S42 can operate on a subregion of the ToF sensor image (instead of operating on the ToF sensor image as discussed above).

In an optional step S43, the pixels or clusters of pixels relating to the ground can be ignored. Step S43 can increase time efficiency (as part of the ToF sensor image is not processed further) and accuracy (as the ground or objects with a small height are not hazardous, such as, obstacles). Step S43 can utilize the results obtained during step S3 (wherein the ground was located).

In step S44 subregions belonging to a column are grouped into column of subregions. That is, subregions that are aligned vertically in a column are “merged”. It will be understood that in step S44 the subregions belonging to a column are not necessarily grouped or merged per se. Step S44 may indicate that the following steps of the method (i.e. S45) are performed on a per column basis.

In step S45, the second clustering phase can be performed. In each vertical column of subregions, clusters are grouped together to form bigger or composite clusters (which can also be referred to as components). The clusters can be grouped together if the range difference is at most 100 cm, preferably at most 50 cm. In addition, clusters can be grouped if they are up to two subregions apart. That is, clusters can be grouped if they belong to the same subregion column, the subregions they belong to comprise at most one other subregion in between and the clusters comprise similar clustering parameters. The clustering parameter used in step S45 (also referred to as second clustering parameter) can be similar to the clustering parameter used in step S42. For example, the second clustering parameter can be an average or minimum or maximum of the first clustering parameters of the pixels of the cluster.

Thus, clusters in close angular proximity (i.e. in the same column) are grouped together, as they most probably belong to the sample object. This is particularly advantageous for detecting elongated objects, which can extend over multiple subregions of a vertical column of subregions.

As it will be understood, a column of subregions represents an angular sector (i.e. a portion of the outdoor setting in a certain direction). That is, the ToF sensor image is used in a similar manner to a laser scanner. However, a laser scanner (e.g. LIDAR) can scan only one angular sector at a time, while the ToF sensor can obtain multiple angular sectors with a single image capture. The size of the subregions (in step S1), particularly their width, defines the width of the column of subregions and at the same time the width of the angular sector. In some embodiments, the size of the subregions (in step S1), particularly their width, can be chosen such that to coincide with the angular sectors of the laser scanners. This can facilitate adapting processing techniques of the output of laser scanners for processing the output of the ToF sensor. For example, the size of the subregions can be 4×4 pixels (or other values as discussed above).

The method of FIG. 2d, can be particularly advantageous for detecting obstacles. That is, composite clusters can be detected in each column of subregions and the one that is closest to the mobile robot or ToF sensor can be identified. Thus, the closest obstacle in any direction can be identified.

In some embodiments, the method if FIG. 2d can further comprise grouping clusters over multiple columns. This is particularly advantageous for detecting objects, particularly, wide objects (that extend over multiple angular sectors) and/or moving objects.

Grouping of clusters in a subregion column is further illustrated in FIG. 2e. The horizontal axis of the plot shows the distance of the pixels from the robot center in meters. More particularly, the shown distance is the 2-dimensional distance of the pixels from the robot center. The vertical axis, shows the height in meters of the pixels. The height of the pixels can be calculated based on the vertical position of the pixels on the ToF sensor image.

All the pixels belonging to one subregion column are plotted, as depicted by the filled squares in FIG. 2e. The bigger filled squares depict the clusters determined in step S42. The unfilled squares depict the composite clusters determined in step S45. The ground clusters (i.e. clusters at the height of approximately 0 m) are ignored.

Referring back to FIG. 2a, in a step S5, for each cluster it can be determined based on at least one object detection parameter whether it is an object. The object detection parameter can comprise a cluster size parameter. Hence, only clusters with a size within the cluster size parameter can be considered as objects – the other clusters that do not fulfil this criterion can be disregarded. The object detection parameter can be a type of object. That is, based on the shape of the cluster a type of object can be inferred. If a type of object can be inferred, the cluster can be considered as an object. Otherwise it can be considered as an artefact. That is, in general step S5 may comprise classifying the clusters at least into “objects” or “not objects”. The classification is based on an object detection parameter, which can relate to a cluster size, cluster shape, cluster position, cluster distance, object type or any combination thereof.

Step S5 can be based on a machine learning algorithm. For example, an artificial neural network can be configured and trained to detect clusters that represent objects or different types of objects (e.g. building, sidewalk, road, traffic sings, people, cars, bicycles, etc.). The artificial neural network may thus facilitate the classification of clusters at least into “objects” or “not objects”.

Step S5 can be advantageous as it can decrease the number of artefacts – i.e. clusters that do not represent objects, such as, sky or ground. Step S5 can also be advantageous as the detected objects can be classified based on the object type.

In a step S6, hazardous objects are detected. That is, for each detected object (in step S5) or cluster (in step S4) it can be determined whether the object or cluster is or corresponds to a hazardous object based on at least one hazardous object detection parameter. A hazardous object detection parameter may be the distance between an object and the mobile robot. Generally nearby objects can be more hazardous than far away objects. Another hazardous object detection parameter can be the size of an object. Generally large objects can be more hazardous than small objects. Yet another hazardous object detection parameter can be the position of the hazardous objects relative to the mobile robot and more particularly to the direction of movement of the mobile robot. Generally, objects on collision course with the mobile robot can be more hazardous. Yet another hazardous object detection parameter can be the velocity of an object. Generally, fast moving objects can be more hazardous than slow moving or static objects. Similarly, objects moving towards the mobile robot can be more hazardous than objects moving away from the robot.

The method illustrated in FIG. 2a, can further comprise projecting at least one detected cluster and/or at least one detected object and/or at least one detected hazardous object in a computerized view of the outdoor setting. The computerized view, can be generated by the mobile robot utilizing the sensors comprised by the mobile robot, such as the ToF sensor. That is, the computerized view depicts how the robot “sees” the outdoor setting it is operating in.

FIG. 2b, illustrates an exemplary computerized view 200 of the outdoor setting. The computerized view in FIG. 2b depicts a ToF occupancy map 200 wherein clusters and/or objects and/or hazardous objects detected by the mobile robot using ToF sensor images are projected therein. More particularly, objects on the outdoor setting detected from the distance images (i.e. the images on top), the brightness images (the images on the middle) and/or visual camera images (the images on the bottom) are projected on the computerized view 200.

In addition, the computerized view shows the mobile robot 20. The clusters and/or objects and/or hazardous objects are projected in the computerized view such that the relative position between the robot and the clusters and/or objects and/or hazardous objects is conserved.

In addition, the computerized view 200 may depict the fields of view of the respective sensors and/or cameras comprised by the mobile robot 20. More particularly, three field of views are depicted therein corresponding to front and side ToF sensors (and/or cameras).

In some embodiments, after step S4 the detected clusters can be projected on the computerized view 200. Alternatively, only those clusters that are determined to correspond to objects in the outdoor setting can be projected on the computerized view 200. Thus, after step S5 objects can be projected on the computerized view 200. However, in some embodiments, firstly the detected clusters can be projected on the computerized view 200 after step S4 and after step S5 those clusters determined to be objects can be labelled as such – hence the computerized view 200 can depict both detected clusters and objects.

In some embodiments, after step S6 hazardous objects can be projected on the computerized view 200. The computerized view 200 may comprise only hazardous objects. Alternatively, in some embodiments, the computerized view 200 may comprise clusters, objects and/or hazardous objects respectively labelled. It can be advantageous the computerized view 200 comprises at least the hazardous objects.

A hazardous object can be an obstacle (e.g. an object on collision course with the robot). Thus, in step S6 obstacles can be detected. Detecting obstacles can be advantageous as it can reduce the number of collisions of the mobile robot. Detecting obstacles can be particularly advantageous while the robot travels on the sidewalk, wherein generally multiple obstacles can be on the robot’s way, such as, pedestrians, cyclists, traffic signs, bins, heaps etc.

A hazardous object can also be a moving object, particularly fast-moving objects, such as, moving cars. Generally, the robot travels on the sidewalk wherein there are no fast-moving objects, such as, vehicles. However, in many instances the robot may need to cross roads. Road-crossings, due to the presence of cars in the road, can be a particularly more critical task for the mobile robot, even more so when the robot is driving autonomously. Road-crossing can be facilitated by detecting and tracking moving objects. This can allow the mobile robot to “know” or predict the position of the moving objects (e.g. cars) and decide when to cross the road. Thus, detecting moving objects can be advantageous as it can facilitate autonomous road crossing by the mobile robot. Additionally, the mobile robot can be configured to cross roads assisted or controlled by human operators. Even in such embodiments, automatically detecting moving objects can be advantageous as the mobile robot can signal the operator that moving objects are present in the outdoor setting. This can increase the likelihood that the operator becomes aware of moving objects, which in turn can decrease the likelihood of accidents. For example, in a video feed provided to the operator (while the operator assists the mobile robot for the road crossing) distinctive signs can be overplayed on the video feed (e.g. bright boxes), preferably on the part of the image where the mobbing object is detected.

The method according to the embodiment of FIG. 2a can be configured or adapted to detect moving objects. In some embodiments, moving objects can be detected by projecting them on the computerized view 200. For example, a cluster, object and/or hazardous object is detected using the method of FIG. 2a. The detected cluster, object and/or hazardous object can be projected on the computerized view 200. From the computerized view it can then be determined if the detected cluster, object and/or hazardous object is static or moving. In addition, speed and direction of movement (i.e. velocity) of the objects can be determined.

FIG. 2c illustrates a computerized view 200, wherein a moving object can be detected. More particularly, distance images captured by a ToF sensor 10 are captured at different times. FIG. 2c depicts three distance images captured by a ToF sensor at different times. It will be noted that in general at least two images are required to detect moving objects. Clusters, objects and/or hazardous objects can be detected on the at least two ToF sensor images and are projected on the computerized view 200. In the computerized view clusters, objects and/or hazardous object that are moving can be detected. For example, in FIG. 2c the vehicle is captured by multiple distance images captured at different times and is projected on the computerized view 200. In the computerized view, the moving vehicle can be detected (as a moving object) and can furthermore be tracked. Using the time between the projections (i.e. which depends on the time when the respective images are captured) and the distance between the projection, the speed and direction of the moving objects (e.g. moving car) can be estimated.

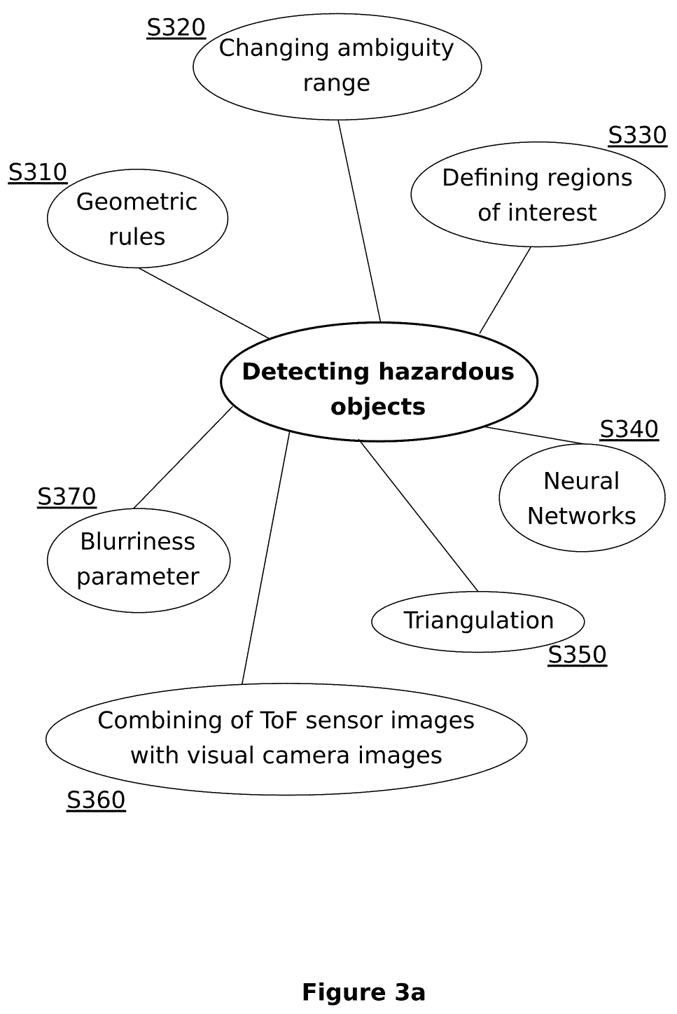

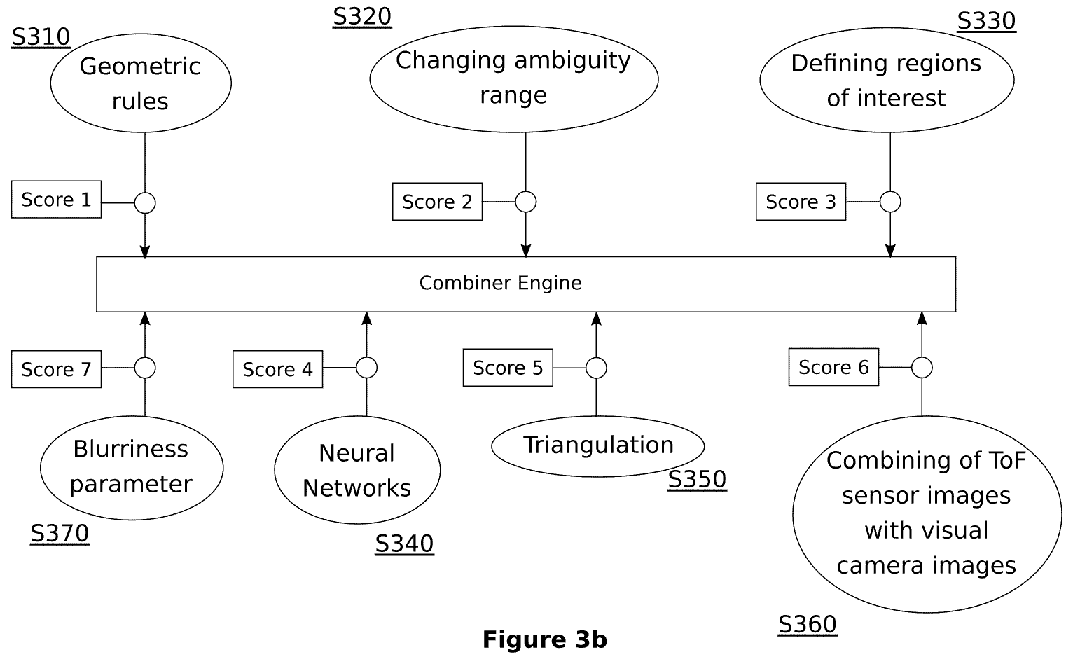

FIG. 3a lists a plurality of facilitating techniques for detecting hazardous object according to aspects of the present invention. In some embodiments, at least one of the techniques listed in FIG. 3a for facilitating the detection of hazardous object can be performed as part of the method for detecting hazardous objects illustrated in FIG. 2a. For example, at least one of the techniques listed in FIG. 3a for facilitating the detection of hazardous object can be performed as part of step S6 of the method illustrated in FIG. 2a.

A common challenge associated with distance images captured by ToF sensors is the ambiguity that may exist in the distance measurement. Distance ambiguity is particularly present when the ToF sensor measures distance based on phase differentiation techniques between the illuminated light and received one. In general, the phase differentiation technique for measuring distance with a ToF sensor consists on emitting a modulated signal. The emitted signals perform a round trip between the ToF sensor (more particularly a light emitter of the ToF sensor) and objects in the outdoor setting and are received by the ToF sensor. Further the difference between the phase of the emitted signal and the phase of the received signal can be measured. The phase difference corresponds to a particular distance travelled by the emitted signals. However, this is true as long as the distance travelled by the emitted signals is less than half the wavelength of the modulated signals. This is due to the fact that the phase of the signals wraps around 360° (which corresponds to one wavelength of the modulated signals). As such, an object being positioned far from the ToF sensor (i.e. further than one wavelength) can be ambiguously measured as being close to the ToF sensor.

In terms of hazardous object detection, the ambiguity in distance measurements, which can be an inherent property of the distance measurement technique used by a ToF sensor (e.g. phase differentiation technique is a commonly used one for distance measurement by a ToF sensor), can impose extra challenges. More particularly, far objects which may not impose any particular danger to the mobile robot can be ambiguously measured as being close and may be erroneously determined as hazardous objects. In other words, the distance ambiguity may cause an increase of the false positive rate in the detection of hazardous objects.

Techniques according to aspects of the present invention listed in FIG. 3a can in general be used to improve the accuracy of distance measurements by a ToF sensor and particularly make the distance measurements less ambiguous. Additionally, techniques according to aspects of the present invention listed in FIG. 3a can increase the accuracy of hazardous object detection – e.g. can improve the accuracy of the method according to the embodiment of FIG. 2a.

In a technique or step S310, at least one pre-defined geometric rule can be used to determine whether an object or cluster is a hazardous object. The geometric rules can facilitate determining whether an object is hazardous based on geometric information that can be extracted from the object, such as, location, scale, orientation, shape, etc. According to one example of a geometric rule, an object can be determined (with a predetermined level of certainty) to not be hazardous if the detected object is not connected to the ground. Alternatively or additionally, according to said example, an object can be determined (with a predetermined level of certainty) to be a hazardous object if the object is connected to the ground. Said geometric rule can be based on the rationale that if an object is not connected to the ground, it can be inferred that the object is far from the mobile robot – generally far objects appear “floating” in the air, i.e. not connected to the ground, due to the low visibility. This geometric rule can be particularly applicable for traffic signs. Generally, the traffic sign is highly reflective and can generally be detected in a ToF sensor image, even if it is far away from the ToF sensor. However, the pole of the traffic sign can generally not be visible if the traffic sign is very far. As such, the traffic sign appears floating.

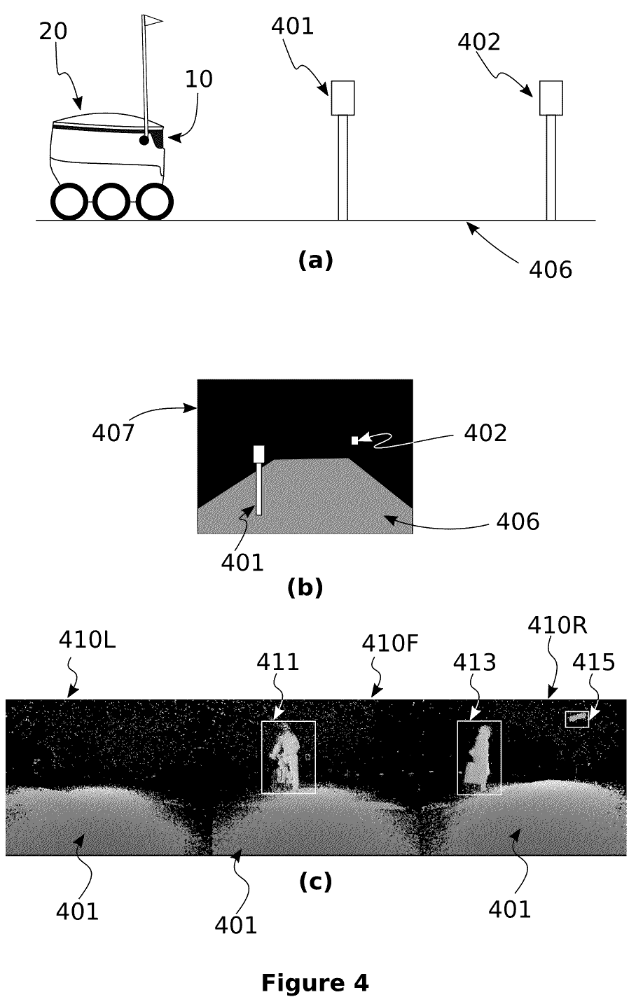

A particular example of the geometric rule is illustrated in FIG. 4. FIG. 4a, illustrates a scenario wherein a mobile robot 20 comprising at least one ToF sensor 10 is travelling in an outdoor setting (e.g. in a sidewalk). In the outdoor setting, at least two objects (illustrated as sign posts) 401 and 402 are present, wherein object 401 is closer to the mobile robot 20 than the object 402. FIG. 4b, illustrates a ToF senor image captured in the illustrated outdoor setting of FIG. 4a. In the ToF sensor image the ground 406 (on the lower part of the image) and the sky 407 (on the upper part of the image) have been detected. In addition, the two objects 401 and 402 are also detected on the ToF sensor image. Object 401, as it is positioned near to the mobile robot 20 and the at least one ToF sensor 10, is more visible in the ToF sensor image as compared to object 402 which is positioned far from the mobile robot 20 and the ToF sensor 10. As such, object 401 can appear in (almost) its entirety in a ToF sensor image. For example, the pole of the traffic sign 401 is also visible. Thus, object 401 appears connected to the ground. Object 402, as it is positioned far from the mobile robot 20 and the at least one ToF sensor 10, is less visible in the ToF sensor image. As such, part of object 402 does not appear in the ToF sensor image. For example, the pole of the traffic sign 402 is not visible. Thus, object 402 appear to be “floating”. A processing unit (e.g. a data processing unit comprised by the mobile robot and/or a server external to the mobile robot) can process the ToF sensor image and can determine that object 401 is connected to the ground and that object 402 is not connected to the ground. Further, based on this information and by applying the said geometric rule it can be inferred (e.g. by the said processing unit) that object 402 is not hazardous as it is positioned far from the mobile robot 20. Alternatively or additionally, it can be inferred that object 401 can be hazardous as it is positioned near the mobile robot 20.

FIG. 4c, provides another illustration of a geometric rule, wherein an object can be determined (within a predetermined certainty) to be hazardous or non-hazardous based on the connection of the object to the ground. FIG. 4c depicts three ToF sensor images. The left ToF sensor image 410L can be captured by a ToF sensor provided in a left side of the mobile robot 20. The right ToF sensor image 410R can be captured by a ToF sensor provided in the right side of the mobile robot 20. The front ToF sensor image 410F can be captured by a ToF sensor image provided in the front part of the mobile robot 20. The images can be captured at the same instant.

On the left ToF sensor image 410L no object is detected (e.g. no object is present in the outdoor setting in the field of view of the left ToF sensor). On the front ToF sensor image 410F, one object 411 is detected – as visually depicted by the rectangular 411 around the object 411. The object 411 (appearing to be a person 411 riding a bicycle) is connected to the ground 401. In some embodiments, using the said geometric rule it can be determined (e.g. by a processing unit) that the object 411 can be (with a predetermined level of confidence) a hazardous object.

On the right ToF sensor image 410R, two objects 413 and 415 are detected. Object 413 (appearing to be a pedestrian 413) is connected to the ground 401. Object 415 is not connected to the ground. From this information it can be inferred (with a predetermined level of confidence) that object 413 can be a hazardous object. Alternatively or additionally, it can be inferred (with a predetermined level of confidence) that object 415 is not a hazardous object.

Furthermore, the above-discussed geometric rule, can be used to make distance measurements of the ToF sensor less ambiguous. For example, referring to the illustration in FIG. 4b, the actual distance of object 402 from the ToF sensor can be larger than the ambiguity range. As a result, the distance measured by the ToF sensor will be wrapped around the distance ambiguity and can be erroneously measured. For example, if distance to object 402 is the distance ambiguity plus a number y, then the measured distance by the ToF sensor can be the number y. However, using the geometric rule (i.e. determining whether the object is connected to the ground) it can be determined that object 402 cannot be near the ToF sensor, but is actually far away since it appears to be floating. For example, it can be determined that object 402 is actually at least distance ambiguity plus y further from the ToF sensor, instead of the measured distance y.

Further in this regard, it will be noted that the amount of the received signal by the ToF sensor which is reflected by objects in the outdoor setting not only depends on the distance between the ToF sensor and the object but also on the reflectivity of the object. For example, some object may be less visible and detectable in a ToF sensor image even though they may be positioned near the ToF sensor, as they may comprise a low reflectivity. In other words, the objects may absorb most of the emitted signal by the ToF sensor and reflect only a small energy of the incident signal. Thus, some close objects that may be hazardous objects may appear to be “floating” (i.e. not connected to the ground) and based on the said geometric rule may be erroneously determined to be non-hazardous objects. To alleviate this, the determinations whether an object is hazardous based on the said geometric rule can be assigned a level of confidence (or certainty). The level of confidence may be a constant for the specific geometric rule used or may vary according to different conditions, such as, time of the day, amount of illumination, color or reflectivity of object, type of object, distance to object, size of object, shape of object, etc. The calculation of the level of confidence can be facilitated by measurements of the ToF sensor (e.g. distance, brightness measurements), measurements of other sensors (e.g. a camera can be used to determine color of an object) and/or can be manually pre-defined or adjusted.

In a technique or step S320 in FIG. 3a, detecting a hazardous object can be facilitated by obtaining at least two ToF sensor images with different ambiguity ranges. That is, the at least two ToF sensor images can be captured by changing the ambiguity range (e.g. changing modulation frequency of the emitted signal) of the ToF sensor while capturing the images or by using at least two ToF sensor configured with different ambiguity ranges. Obtaining at least two images with different ambiguity ranges can be advantageous as it can make the measured distance to an object less ambiguous (i.e. step S320 can be used to mitigate the distance ambiguity problem of ToF sensor distance measurements). Thus, step S320 can be particularly advantages when distance images of the ToF sensor are used to detect hazardous objects, more particularly, when the ToF sensor(s) use a distance measurement technique associated with the distance ambiguity issue (e.g. measuring distance based on phase differentiation).

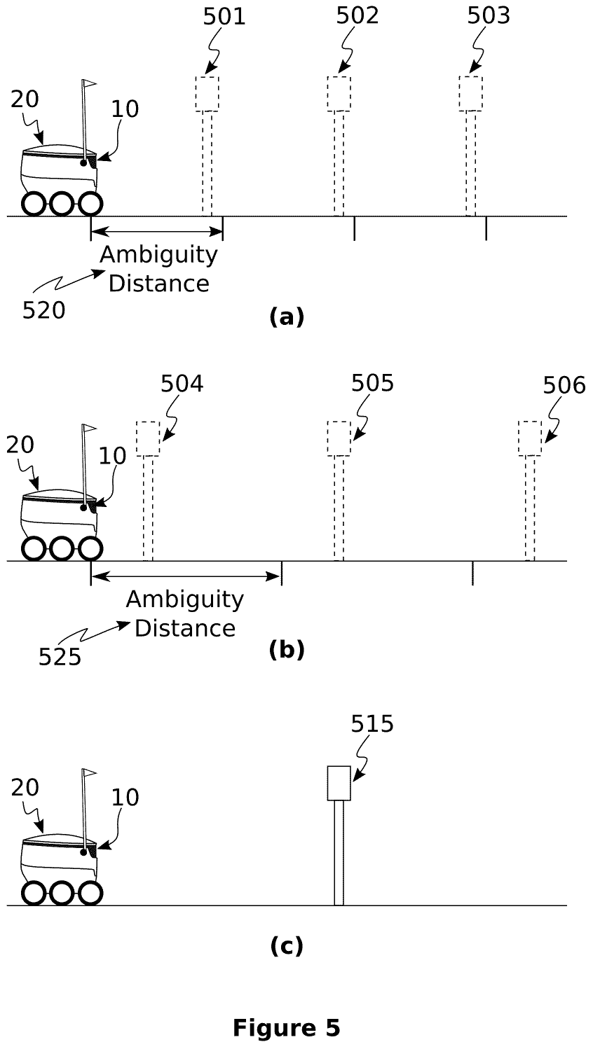

Step S320 is illustrated in more detail in FIG. 5. FIG. 5a depicts a mobile robot 20 comprising at least one ToF sensor 10. The ToF sensor 10 is configured with a first ambiguity distance 520. In addition, three different hypothesis 501, 502 and 503 of the location of an object with respect to the ToF sensor 10 (or the mobile robot 20) can be generated based on at least one first distance image captured by the ToF sensor 10 configured with the first distance ambiguity 520. In other words, the distance to an object is measured using a ToF sensor, however due to distance ambiguity issue that can be associated with the measurement technique used by the ToF sensor 10, multiple location hypothesis can be generated regarding the location of the object. For example, the measurement distance by the ToF sensor can be a number y₁, which can correspond to the first location hypothesis 501. A second location hypothesis 502 can correspond to a distance of first ambiguity distance 520 plus y₁. A third location hypothesis 503 can correspond to a distance of two times the first ambiguity distance 520 plus y₁. In some embodiments, only two location hypotheses (e.g. 501 and 502) can be generated based on the at least one first distance image. In some other embodiments, more than three location hypotheses can be maintained based on the at least one first distance image.

Similarly, FIG. 5b depicts a mobile robot 20 comprising at least one ToF sensor 10. The ToF sensor 10 is configured with a second ambiguity distance 525, wherein the second ambiguity distance 525 is different from the first ambiguity distance 520. In addition, three different hypothesis 504, 505 and 506 of the location of an object with respect to the ToF sensor 10 (or the mobile robot 20) can be generated based on at least one second distance image captured by the ToF sensor 10 configured with the second distance ambiguity 525. In other words, the distance to an object is measured using a ToF sensor, however due to distance ambiguity issue that can be associated with the measurement technique used by the ToF sensor 10, multiple location hypothesis can be generated regarding the location of the object. For example, the measurement distance by the ToF sensor can be a number y₂, which can correspond to the fourth location hypothesis 504. A fifth location hypothesis 505 can correspond to a distance of second ambiguity distance 525 plus y₂. A sixth location hypothesis 506 can correspond to a distance of two times the second ambiguity distance 525 plus y₂. In some embodiments, only two location hypotheses (e.g. 504 and 505) can be generated based on the at least one second distance image. In some other embodiments, more than three location hypotheses can be maintained based on the at least one second distance image.

Based on the at least one location hypothesis generated using a first distance image captured with a ToF sensor configured with a first ambiguity distance 520 and a second distance image captured with a ToF sensor configured with a second ambiguity distance 525 and (optionally) at least one further distance image captured with a ToF sensor configured with at least one different ambiguity distance, the location to the object can be determined more accurately and/or with less ambiguity. For example, as illustrated in FIG. 5, a less ambiguous location hypothesis 515 (FIG. 5c) can be generated by finding an intersection between the at least one location hypothesis generated using a first distance image (FIG. 5a) and the at least one location hypothesis generation using a second distance image (FIG. 5b).

Further in this regard, it will be noted that the ambiguity distance of a ToF sensor can depend on the modulation frequency. That is, generally ToF sensors can be configured to measure distances by emitting an electromagnetic signal and receiving the signal after it is reflected by objects or surfaces in the surroundings. The emitted electromagnetic signal can generally be an infrared signal, such as an electromagnetic wave with wavelengths between 700 – 1400 nm, preferably between 750 – 1050 nm. Furthermore, to facilitate distance measurements, ToF sensors can be configured to operate with modulated electromagnetic signals. For example, using modulated electromagnetic signals can make it easier to determine a phase difference between the emitted and received electromagnetic signal (which can then be translated to a corresponding round-trip length performed by the electromagnetic signal). As discussed, some distance measuring techniques, such as, measuring distance based on the phase difference between the emitted and received electromagnetic signal are associated with distance ambiguity (due to wrapping of the phase of a signal every 360°). The ambiguity distance can depend on the modulation frequency. More particularly, the ambiguity distance can be equal to half the wavelength of the modulated signal (considering that the electromagnetic signal performs a round-trip), wherein the wavelength of the modulated signal equals the speed of the modulated electromagnetic signal divided by the modulation frequency. Thus, a ToF sensor can be configured with a particular distance ambiguity by correspondingly configuring the modulation frequency of the emitted signal used to measure distances.

Moreover, different ambiguity distances can be associated with different errors. That is, due to physical limitations the granularity of distance cannot be infinitesimally small. That is, the measured distance is not a continuous quantity but instead a discrete quantity. In other words, a finite amount of distance levels between 0 and ambiguity distance can be measured. As a consequence, increasing the ambiguity distance can increase the discretization step and at the same time the error performed during distance measurement. That is, changing ambiguity distance can result in location hypothesis associated with different errors. Thus, each location hypothesis can be associated with a level of confidence. The level of confidence can be calculated based on the error performed during the distance measurement. The level of confidence can be an indicator of how accurate the location hypothesis can be.

Further still in this regard, active illumination requires significant energy consumption. In a battery powered mobile robot 20 this ca be disadvantageous as it can lower the driving length of the mobile robot 20 in one charging of the battery and can make the operation of the mobile robot 20 generally less efficient. In this regard, capturing images with different ambiguity range may increase the use of active illumination and consequently the energy consumption. That is, capturing images with different ambiguity range can be a costly process in terms of energy efficiency. To cope with this, the mobile robot can be configured to perform step S320 (i.e. capture ToF sensor images with different ambiguity range) only on critical scenarios or when energy efficiency is not required. A particular critical scenario can for example be when an object that is not connected to the ground is detected in front of the mobile robot. Normally, an object not connected to the ground can be determined to be non-hazardous (e.g. using the geometric rule S310). However, in some instances when the floating object is detected in front of the robot (i.e. on a collision course) it may be advantageous to perform further checks whether the object is indeed non-hazardous. For example, the object may comprise a non-reflective material in the lower part and hence appear not connected to the ground even though it can be close to the robot. After such an object is detected using at least one first ToF sensor image captured with a first ambiguity range, at least one second ToF sensor image captured with a second ambiguity range can be captured (i.e. step S320). This step can verify whether the object is far or close to the robot – as it can reduce the ambiguity of distance measurement. Acquiring images with different ambiguity range only in critical scenarios may reduce the use of active illumination and may thus provide a more efficient technique of using the energy resources of the mobile robot 20.

That is, in some embodiments, it can be advantageous to exploit the synergistic effect of combining different techniques for detecting hazardous objects.

In a step S330, a region of interest in the ToF camera view can be defined. For example, in a ToF sensor image generally the lower part of the image is occupied by the ground and the upper part of the image is occupied by the sky, far-away objects and/or objects at a high height that do not impose a danger. In a step S330, the ToF camera can be configured to ignore such regions and acquire measurements only on regions of interest (i.e. regions with a high certainty of comprising hazardous objects). This can decrease the readout time, i.e. the time to acquire pixel values from the sensor, since values for a small number of pixels need to be acquired. As such, the time of obtaining a ToF sensor image can be decrease which can allow for faster (hazardous) object detection using a ToF sensor image. Further still, specifying a region of interest decreases the space (i.e. number of pixels) to search for detecting (hazardous) objects, as the size of the ToF sensor image can be smaller (i.e. only the region of interest). Further still, specifying a region of interest can lower energy consumption as less computations can be required for detecting a (hazardous) object in a smaller ToF sensor image. Further still, particularly in embodiments wherein the mobile robot 20 transmits the ToF sensor image to an external server or remote operator, less bandwidth can be required to transmit the smaller ToF sensor image, resulting in an efficient use of bandwidth. Moreover, a faster detection of hazardous objects can be advantageous as the faster a hazardous object can be detected the more time is available for the mobile robot 20 (and/or a remote operator) to perform collision avoidance measures. In some embodiments, in step S330 the mobile robot 20 can switch between different regions of interest.

In a step or technique S340, artificial neural networks (ANN) computing systems can be utilized to improve hazardous object detection. In one aspect of the present invention, artificial neural networks can be used to make distance measurements of a ToF sensor less ambiguous. That is, the ANN can be configured to receive at least one ToF sensor image and output a distance (or depth) image. The ANN can be trained to mitigate distance measurement ambiguities. This may require training the ANN with annotated training images, preferably a large database of annotated training images. In other words, the ANN can receive raw ToF sensor measurements (which may suffer from distance ambiguity and/or other errors) and can be configured to output a distance image with more accurate and/or less ambiguous distance data. That is, the ANN can be configured and utilized to improve the quality of distance images in general. ANN can be trained to detect pixels that relate to surfaces (or points) in the outdoor setting that are further than the ambiguity range from the ToF sensor 10. This can be done by training the ANN with many input images and accurate (e.g. hand-annotated) unambiguity masks (which can be associated to each input training image).

In a step or technique S350, a triangulation technique can be utilized to improve hazardous object detection. In one aspect of the present invention, the triangulation technique can be used to make distance measurements of a ToF sensor less ambiguous and/or increase certainty of the distance measurements of a ToF sensor. Step S350, generally comprises a mobile robot comprising at least one ToF sensor capturing at least two ToF sensor images from different positions. More particularly, at least one object in the outdoor setting can be captured by at least two ToF sensor images, wherein the at least two different ToF sensor images are captured from different locations of the mobile robot relative to the at least one object. On the at least two ToF sensor image, objects can be detected and furthermore corresponding objects can be determined (i.e. the same object detected on different images). Based on the position of the object on the ToF sensor image, an angle indicating the (angular) position of the object relative to the mobile robot can be determined. Using at least two angular measurements from two different positions the certainty regarding the exact location of the object relative to the mobile robot can be increased. To put it simply, step S350 consists on the mobile robot moving, capturing ToF sensor images, tracking the location of an object using the ToF sensor images, maintaining at least one hypothesis about the location of the object and improving the accuracy of the location hypotheses regarding the object’s location using triangulation.

Step S350 can be particularly advantageous when an object can be detected on a ToF sensor image, however its distance cannot be measured. As the object is detected on the ToF sensor image but its distance cannot be measured, only information regarding the direction to the object (relative to the mobile robot/ToF sensor) can be extracted. This can for example be caused by oversaturation of the ToF sensor, which can be caused by highly reflective objects (e.g. street signs). Step S350 can also be advantageous for mitigating distance ambiguity issue associated with some distance measurement techniques that can be used by the ToF sensor.

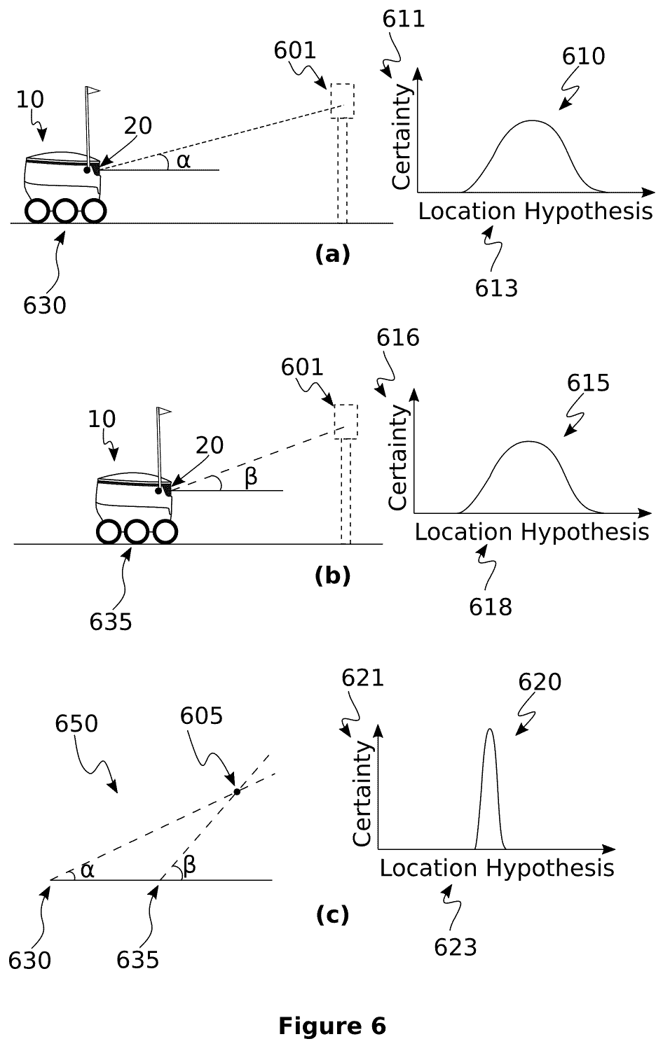

FIG. 6 provides an illustration of a mobile robot 20 comprising at least one ToF sensor 10 and travelling in an outdoor setting comprising (at least) object 601 and performing step S350.

FIG. 6a depicts the mobile robot 20 capturing from a first location 630 with at least one ToF sensor 10 at least one first ToF sensor image of the object 601. Object 601 can be detected on the at least one first ToF sensor image. Based on the position of object 601 on the at least one first ToF sensor image a first angle denoted by α can be measured. Based on the first angle α, at least one first location hypothesis 613 can be generated with a first certainty 611 (as illustrated by the Location Hypothesis vs Certainty line 610).

Similarly, FIG. 6b depicts the mobile robot 20 capturing from a second location 635 (different from first location 630) with at least one ToF sensor 10 at least one second ToF sensor image of the object 601. Object 601 can be detected on the at least one second ToF sensor image. Based on the position of object 601 on the at least one second ToF sensor image a second angle denoted by β can be measured. Based on the second angle β, at least one second location hypothesis 618 can be generated with a second certainty 616 (as illustrated by the Location Hypothesis vs Certainty line 615).

Carrying out the triangulation technique 650 based on the at least two angle measurements α and β, a location 605 of the object 601 can be inferred. Mora particularly, at least one third location hypothesis 623 can be generated with a third certainty 621 as illustrated by the Location Hypothesis vs Certainty line 620.

As illustrated in FIG. 6, due to erroneous or lack of distance measurement by a ToF sensor to an object (caused e.g. oversaturation of the ToF sensor, distance ambiguity, etc.) the first and the second location hypotheses 613 and 618 may comprise a higher uncertainty. Applying the triangulation technique, as shown in FIG. 6c, can increase the uncertainty of the location hypothesis. In one aspect, the triangulation technique may lower the amount of possible locations that the object 601 can be positioned. The triangulation technique may make the distance measurement to an object 601 less ambiguous. In general terms, step S350 may improve localisation of an object in the surroundings of a mobile robot.

In a step S360, hazardous object detection may be facilitated by using ToF sensors and visual cameras, preferably stereo visual cameras. In step S360, the detection of hazardous objects may be based on the output of ToF sensor images and the output of visual cameras. In one aspect of the invention, at least one ToF sensor image and at least one visual camera image may be provided to a processing unit configured to detect hazardous objects, and the said processing unit can detect at least one hazardous object based on at least one ToF sensor image and at least one visual camera image. In some embodiments, the at least one ToF sensor image can be fused with a corresponding visual image. That is, distance and/or brightness information can be extracted from a ToF sensor image and color information can be extracted from a visual camera image. The extracted information can then be fused or combined in one fused image that comprises information extracted from corresponding ToF sensor image and visual camera image. For example, each pixel in the fused image can be represented by two numbers (e.g. x, y) denoting position of pixel in the image, three numbers (e.g. r, g, b) comprising color information captured by the visual camera, one number (e.g. d) comprising distance measurement performed by the ToF sensor and brightness information (e.g. I) captured by the ToF sensor. In addition, the pixel can further comprise brightness information captured by the visual camera. In general, a pixel of the fused image can comprise any combination of the above-mentioned information that can be extracted from a ToF sensor image and a visual camera image.

A ToF sensor image and a visual camera image can correspond to each-other, if they field of view that they capture intersect. Said intersection can be referred to as the correspondence intersection. A fused image, comprising visual camera and ToF sensor information can be generated for the correspondence intersection. Generally, it can be advantageous that the correspondence intersection be as large as possible. This can be achieved, by positioning the visual camera and the ToF sensor such that they comprise the same or similar fields of view.

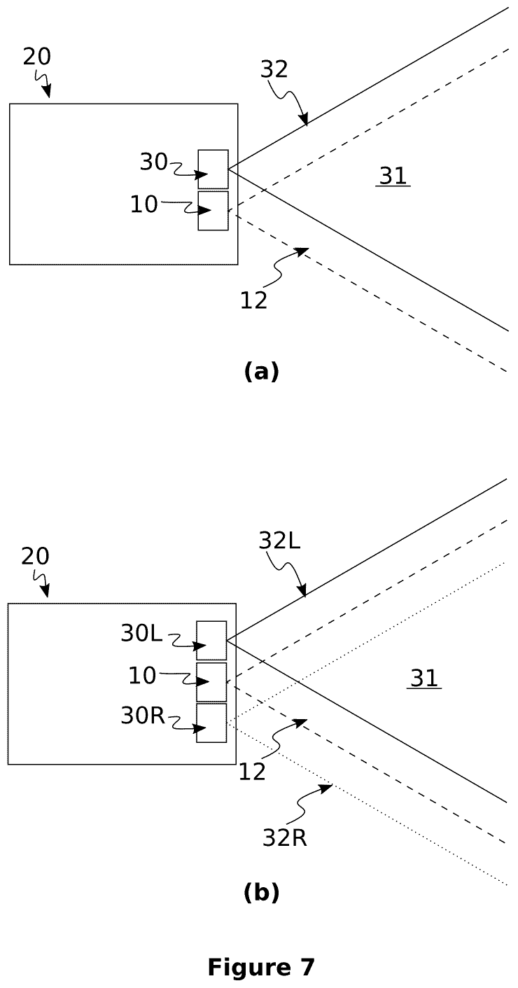

An embodiment of a mobile robot 20 comprising at least one ToF sensor 10 and at least one visual camera 30 is depicted in FIG. 7a. The visual camera 30 can comprises a horizontal field of view as indicated by area 32. The ToF sensor 10 can comprise a field of view as indicated by area 12. The visual camera 30 and the ToF sensor 10 can be configured such that their fields of view can intersect. The area 31 in FIG. 7a illustrates the intersection of the field of view 32 of the visual camera 30 with the field of view 12 of the ToF sensor 10. In some embodiments, it can be advantageous to maximize the intersection area 31. FIG. 7a depicts only the horizontal fields of view of the respective sensors. However, a similar illustration and discussion can also be made for other orientations, e.g. for the vertical fields of view.

FIG. 7b depicts an embodiment of a mobile robot 20 at least one ToF 10 and at least one stereo camera pair 30L, 30R. The left visual camera 30L of the stereo camera pair can comprise a horizontal field of view 32L. The ToF sensor 10 can comprise a horizontal field of view 12. The right visual camera 30R of the stereo camera pair can comprise a horizontal field of view 32R. The stereo cameras 30L, 30R and the ToF sensor 10 can be configured such that their fields of view can intersect. The area 31 in FIG. 7b illustrates the intersection of the field of view 32L of the left camera 30L with the field of view 12 of the ToF sensor 10 and with the field of view 32R of the right camera 30R. FIG. 7b depicts only the horizontal fields of view of the respective sensors. However, a similar illustration and discussion can also be made for other orientations, e.g. for the vertical fields of view.

In a further embodiment (not shown), the mobile robot 20 can be alternatively or additionally be equipped with visual cameras 30, ToF sensors 10 and/or stereo cameras 30L, 30R on the sides of the mobile robot 20. The visual cameras 30, ToF sensors 10 and/or stereo cameras 30L, 30R provided on other sides of the mobile robot can be arranged such that their fields of view can intersect.

Configuring the visual/stereo camera(s) and the ToF sensor(s) with intersective fields of view can facilitate identifying corresponding regions and/or clusters of pixels between visual images captured by the visual/stereo cameras and ToF sensor images. This can further facilitate utilizing ToF sensor images and visual cameras images (e.g. generating fused images) to detect hazardous objects (step S360).

The use of stereo cameras in particular, can be advantageous as stereo cameras can provide a second distance measurement (in addition to the distance measurements performed by the ToF sensor). Generally, stereo cameras can provide inaccurate distance estimation particularly for far objects as small changes in image space correspond to large changes in distance. On the other hand, ToF sensors 10 can provide a more accurate estimation of the distance to an object, however as discussed, they suffer from distance ambiguity. But considering the distance estimate provided by the stereo cameras and the distance estimate provided by the ToF sensor 10 (i.e. step S360), the ambiguity of the ToF sensor 10 distance estimation can be removed and a more accurate estimation of the distance (particularly of far object) can be achieved.

More particularly, the distance measurement uncertainty (which for the sake of brevity can also be referred to as distance uncertainty or error) of the ToF sensor 10, can depend, among others, on the ambient light, unambiguity distance (or modulation frequency) and amplitude of reflected light. In other words, a high amplitude of the ambient light (which can be considered as noise during the distance measurement) can contribute on decreasing the signal-to-noise ratio at the ToF sensor. Generally, a lower signal-to-noise ratio at the ToF sensor can contribute on increasing the distance measurement uncertainty of the ToF sensor 10.

The distance measurement uncertainty of the ToF sensor 10 can increase with the increase of the intensity of the ambient light. The ambient light may comprise light emitted by light sources (in the outdoor setting) different from the illumination emitted by the ToF sensor, such as, sunlight, light from urban lights, etc.

The ambiguity distance can also affect the accuracy of distance measurements by the ToF sensor 10. Generally, the larger the ambiguity distance the larger the distance measurement uncertainty.

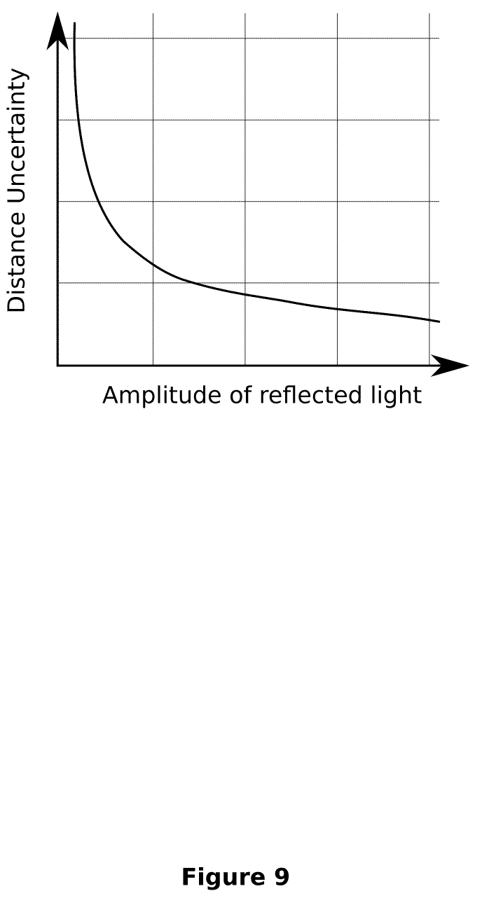

The amplitude of the reflected light can be another factor that impacts the distance measurement uncertainty for a ToF sensor 10. The amplitude of the reflected light can be defined as the measured amplitude at the ToF sensor of the light emitted by the ToF sensor, reflected by an object in the outdoor setting and received by the ToF sensor. A typical behavior of the distance measurement uncertainty as a function of amplitude of the reflected light is depicted in FIG. 9. As it can be noticed therein, the distance measurement uncertainty generally decreases with the increase of the amplitude of the reflected light.

The amplitude of the received reflected light can be increased by increasing the amplitude of the emitted light. Furthermore, the amplitude of the received reflected light can be increased by increasing the exposure time (i.e. the time during which the ToF sensor senses incoming light), such that low amplitude reflections can be measured better. However, the increase of the transmission power of the active illumination and/or increase of the exposure time of the ToF sensor may cause oversaturation of high amplitude reflections.

The amplitude of the reflected light can also depend on the reflecting surface properties.

On the other hand, for stereo cameras the distance measurement uncertainty generally increases with distance, usually with the square of the distance. The distance measurement uncertainty of stereo cameras, further depends on the lens focal length of the cameras, camera resolution and distance between the two cameras in the stereo pair.

Generally, increasing the resolution of the cameras can decrease the distance measurement uncertainty. For example, if the pixel size is 1 degree, then the smallest parallax – the difference in the apparent position (on the image) of an object or feature viewed from two different cameras – that can be measured, can be no smaller than 1 degree. However, if each pixel corresponds to 0.5 degrees, then the smallest measurable parallax can be at least 0.5 degrees. In other words, higher resolution can allow for finer measurements of parallax. Distance to an object is inversely proportional to the parallax, so a finer measurement of the parallax can provide a more precise measurement of the distance and thus, decrease the distance measurement uncertainty.

On the other hand, increasing the distance between the cameras in the stereo pair can contribute on decreasing the distance measurement uncertainty. However, the distance between the cameras can influence the overlap between the fields of view of the respective cameras in the stereo pair. More particularly, the more apart the cameras in the stereo pair are positioned the smaller the overlap can be. A small overlap between the fields of view of the cameras in the stereo pair can make it more challenging for matching the corresponding pixels between the two images provided by the stereo cameras. Hence, the selection of the distance between the cameras in the stereo pair involves a trade-off between computational resources required for solving the correspondence problem and accuracy.

In addition, the field of view of the cameras can also affect the distance measurement. In one hand, a wider field of view of the cameras in the stereo pair can increase the amount of the surroundings that can be “seen” by the cameras. At the same time, the amount of overlap between the respective fields of view of the cameras can be increased. For performing a distance measurement, it may be required that an object or feature is positioned within the overlap region of the fields of view. This can allow calculation of distance through triangulation techniques - i.e. finding the position of a point, object or feature relative to at least two reference points (the known camera locations) using at least two angle measurements performed based on the position of the point, object or feature on the images captured by the cameras. Note that other techniques may be utilized additionally or alternatively for estimating the distance to points, objects or features from stereo camera images. Hence a wider field of view of the cameras can result in a bigger overlap between the fields of view of the cameras which in turn can allow objects positioned closer to the stereo cameras to be within the overlap region (thus allowing distance measurement e.g. through triangulation techniques). However, when increasing the field of view of the cameras at the same time the field of view per pixel is increased. Increasing the field of view per pixel can increase the distance measurement uncertainty. As a result, the selection of the field of view of the cameras in the stereo pair involves a trade-off between minimum measurable distance and accuracy.

Thus, different stereo camera pairs can be configured to comprise different distance measurement uncertainty and different minimum measurable distance. Generally, decreasing the minimum measurable distance may increase the distance measurement uncertainty. Similarly, decreasing distance measurement uncertainty can increase the minimum measurable distance.

For example, the mobile robot 20 (see FIG. 1) can have front stereo cameras positioned in the front of the mobile robot 20 and side stereo cameras positioned at the sides of the mobile robot 20.

In a particular embodiment of the mobile robot 20, the front stereo cameras can be configured for providing accurate distance measurements to objects that are close to the cameras (consequently to the robot as well). However, this configuration of the front stereo cameras may come at the expense of an increased uncertainty for measuring the distance of far objects from the front stereo cameras. On the other hand, the side stereo cameras can be configured for measuring with an improved accuracy distances to objects being far from the cameras. This configuration of the stereo cameras can generally limit the ability of the side stereo cameras for measuring distances to objects being close to the side stereo cameras. Due to such configurations, the front and the side stereo cameras may be characterized by different distance measurement uncertainties.

In some embodiments, the front stereo cameras can be configured to measure distances of at least 15 cm and at most 60 cm with a distance uncertainty of less than 0.5 cm, while the side stereo cameras can be configured to measure distances of at least 50 cm and at most 100 cm with a distance uncertainty of less than 0.5 cm. Alternatively or additionally, the front stereo cameras can be configured to measure distances of at least 15 cm and at most 85 cm with a distance uncertainty of less than 1 cm, while the side stereo cameras can be configured to measure distance of at least 50 cm and at most 150 cm with a distance uncertainty of less than 1 cm. Alternatively or additionally, the front stereo cameras can be configured to measure distances of at least 15 cm and at most 180 cm with a distance uncertainty of less than 5 cm, while the side stereo cameras can be configured to measure distances of at least 50 cm and at most 320 cm with a distance uncertainty of at most 5 cm. Note that the above ranges are provided for exemplary purposes and other configurations of the cameras can be achieved as well.

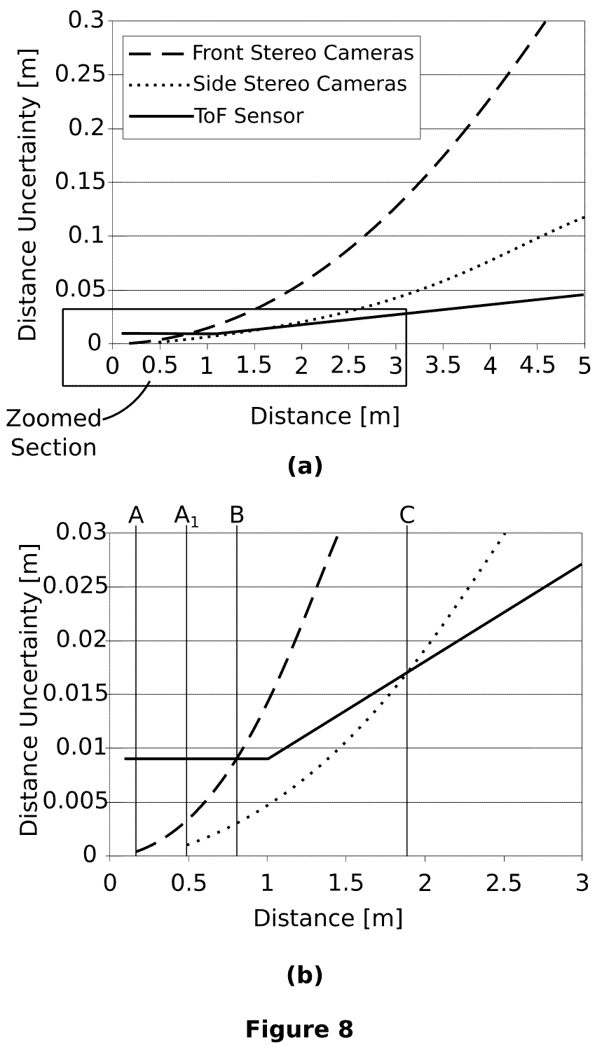

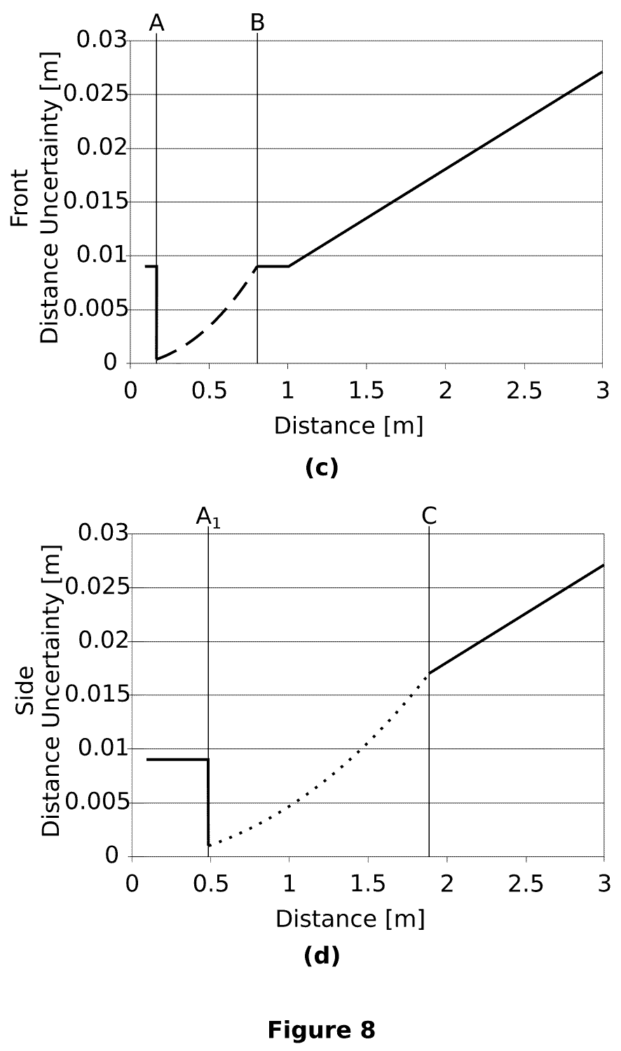

FIG. 8a depicts a typical behavior (i.e. idealized graph) of distance measurement uncertainty dependence on distance for exemplary front and side stereo cameras and exemplary ToF sensor 10. FIG. 8b depicts the indicated region of FIG. 8a zoomed-in.

As it can be noticed from the graphs in FIGS. 8a and 8b, the stereo cameras can typically comprise a minimum detection distance that is larger than the minimum detection distance of the ToF sensor 10. That is, the ToF sensor 10 can have a minimum measurable distance smaller than distance A which depicts the minimum measurable distance of the front stereo cameras (see FIG. 8b) and smaller than distance A₁ which depicts the minimum measurable distance of the side stereo cameras (see FIG. 8b).

Further, from the graph it can be noticed that for small distances the ToF sensor 10 can typically comprise a larger distance measurement uncertainty as compared to stereo cameras. For example, for distances between distance A and distance B (for front stereo cameras) and for distances between distance A and distance C (for side stereo cameras) the stereo cameras comprise a smaller distance measurement uncertainty compared to ToF sensor 10.

Further still, from the graphs it can be noticed that for larger distances the ToF sensor 10 can typically comprise a lower distance measurement uncertainty compared to stereo cameras. It can be noticed from the typical behavior graphs of FIGS. 8a and 8b that the ToF sensor distance measurement uncertainty increases almost linearly with distance while the stereo camera distance measurement uncertainty increases almost quadratically with distance). That is, for distances larger than B the ToF sensor 10 comprises a lower distance measurement uncertainty compared to the front stereo cameras and for distances larger than C the ToF sensor 10 comprises a lower distance measurement uncertainty compared to the side stereo cameras.

In some embodiments, a mobile robot 20 as depicted in FIG. 1 can be equipped with front ToF sensor 10, front stereo cameras, side ToF sensors 10 and side stereo cameras. These sensors can be used for measuring distances to objects. Furthermore, their measurements can be combined to improve the accuracy of distance measurements. For example, the ToF sensor 10 can be used to measure distance to very close objects (e.g. objects positioned closer than distance A) for which the stereo cameras cannot measure a distance. Further, for near objects (e.g. objects between distance A and B for the front or A and C for the sides) the measurements of the stereo cameras can be used. Further still, for far objects (e.g. objects further than distance B for the front or C for the sides) the measurements of the ToF sensors can be used. In the latter case, the ambiguity of the ToF sensor measurement (for objects further than the unambiguity distance D_{unambiguity}) can be solved by using the measurement of the stereo cameras.

For example, a particular ToF sensor 10 can have an unambiguity distance of 10 meters. An object appears to be 3 meters away according to the ToF sensor 10 and 14 meters away according to the stereo cameras. The measurement of the stereo camera can be used to determine that the object is further than the unambiguity distance of the ToF sensor 10. With this information, it can be determined that the object is 13 meters away. Note that the measurement of the ToF sensor is used (i.e. 10 + 3 meters). Also, it should be noted, that in this example the ToF sensor 10 and stereo cameras use a common reference system to measure distance. The common reference system can be generated during a calibration step between the stereo cameras and the ToF sensor 10.

FIGS. 8c and 8d depicts the distance measurement uncertainty when determining the distance using both the ToF sensor 10 and the stereo cameras for the front and side stereo cameras and ToF sensors respectively. As it can be noticed, the combined error curves depict a lower distance uncertainty compared to the error curves of the individual sensors (depicted in FIG. 8b). Hence, the combination of ToF sensors 10 and stereo cameras (step S360) can be advantageous for performing distance measurements. A more accurate distance measurement to an object in the outdoor setting can improve the accuracy of detecting hazardous objects.

Utilizing both ToF sensor images and visual camera images S360 for detecting hazardous objects can further improve detection of objects that are not very reflective. The ToF sensor can detect an object based on the property of the object to reflect light, generally infrared light. The visual camera can detect an object based on the property of the object to emit or reflect visible light. Different objects based on their physical and chemical properties comprise different reflectivity. Some objects may not be very reflective of infrared light and hence (hardly) visible in a ToF sensor image. Some object may not be very reflective of visible light and hence (hardly) visible in a visual camera image. Some objects may have a low reflectivity of both infrared light and visible light and can be (hardly) visible in a visual image or ToF sensor image. The use of both ToF sensor images and visual camera image may increase the information that can be captured (or sensed) from the outdoor setting and can facilitate the detection of objects in the outdoor setting. This is particularly advantageous for objects that are not very reflective.

As discussed, a ToF sensor can be configured to capture distance images and brightness images. In some embodiments, the brightness image can be used to facilitate combining or fusing or merging a distance image with a visual camera image. More particularly, a brightness image can comprise visual features such as shapes, lines, corners, etc. Similarly, a visual image can comprise visual features such as shapes, lines, corners, etc. Thus, corresponding visual features on the brightness image of the ToF sensor and the visual camera image can be identified which can facilitate combining the two images together and also combining the distance image with the visual camera images. It will be understood that for two images to correspond or to be combined the two images need to be captured from same or similar locations.

To put simply, a distance image and a visual camera image convey different information. As such, it can be challenging to find a correspondence between the two (i.e. overlaying the images such that overlaying pixels correspond to the same are in the outdoor setting). On the other hand, the ToF sensor can be configured to capture brightness images too. The brightness images convey similar information to the visual camera images. Hence, instead of directly combining a distance image with the visual camera images, the ToF sensor can be configured to capture for each distance image a brightness image and the brightness image is combined with the visual image and the result of this combination can be used to combine the distance image with the visual camera image. The brightness image, distance image and visual camera image are captured from the same location and/or at the same time, such that they can be combined.

In a step S370 a blurriness parameter can be used to facilitate object detection and more particularly hazardous object detection. The blurriness parameter can indicate the degree of image blurring. Blurriness is the degree of being unclear or indistinct. For example, a blurry image can be referred to an image with reduced sharpness or contrast.

The blurriness parameter can be calculated from a brightness image and/or visual camera image. Multiple standard algorithms can be utilized for calculating a blurriness parameter, for example, spatial frequency spectrum analysis, variation of the Laplacian, contrast analysis, etc. The blurriness parameter can be calculated for part of an image or a group of pixels, e.g. a cluster of pixels. The blurriness parameter can be calculated based on the pixels corresponding to a detected object. Thus, in some embodiments, to each detected object on a ToF sensor image and/or visual camera image a corresponding blurriness parameter can be calculated.

Generally, objects or more generally scenes that are close to the ToF sensor can appear sharper (i.e. less blurry) in a brightness image as compared to objects or scenes being far from the ToF sensor. Similarly, objects or more generally scenes that are close to the visual camera can appear sharper (i.e. less blurry) in a visual camera image as compared to objects or scenes being far from the visual camera. Based on this rationale, the blurriness parameter can be utilized to solve the ambiguity problem that can be associated with distance measurements by a ToF sensor. That is, due to distance ambiguity, far objects (i.e. object further than the ambiguity distance) can be measured as being close to the ToF sensor. However, in step S370 a blurriness parameter of said object can be calculated from a brightness image and/or visual camera image of the said object. Based on the blurriness parameter it can be determined whether the object is far or near the ToF sensor. Based on this determination, ambiguity in the distance of the object can be solved.

In some embodiments, at least one of the techniques or steps discussed with respect to FIG. 3a for facilitating hazardous object detection can be associated with a respective score. The score can be a probability or likelihood that indicates the accuracy of the respective technique or of the output of the respective technique. The score can be predefined (e.g. by a human operators) or it can be calculated during the execution of the technique (e.g. depending on the confidence of the determined results by the respective technique). In some embodiments, the score provided to the respective technique can depend on the type of detected object. For example, the geometric rule in step S310 can comprise a better score (i.e. can be trusted more) when detecting traffic signs that can be hazardous (or not) compared to the other techniques. In some embodiments, the score provided to the respective technique can depend on the time of the day. For example, using visual camera images in step S360 can comprise a better score during daytime as compared to nighttime. That is, the scores associated to the techniques for facilitating hazardous object detection may be static or dynamic.

In some embodiments, more than one of the techniques discussed with respect to FIG. 3a can be utilized for facilitating hazardous object detection. In such embodiments, it can be advantageous to combine the output of the utilized techniques. For example, each of the techniques can be utilized to determine whether a detected object or cluster of pixels corresponds to a hazardous object in the outdoor setting. Each of the techniques may provide a respective determination. A final determination whether a detected object or cluster of pixels corresponds to a hazardous object in the outdoor setting can be made by combining the output of each technique.

FIG. 3b depicts an embodiment wherein a combiner engine 300 combines the output of at least one of the techniques S310 to S370, wherein the outputs are assigned a respective score. The combiner engine 300 can be configured to combine the outputs of at least one of the techniques S310 to S370 according to a predefined (or pre-programmed) function (e.g. linear combination) or according to a machine learning algorithm. In the later embodiment, for example, the combiner engine 300 may adapt the respective scores or the combination function according to previous results (i.e. history). For example, the true positives rates and/or false positives rates and/or true negatives rates and/or false negatives rates can be calculated and maintained for each technique and used to determine how accurately a respective technique is or has been performing. Based on this, the combiner engine puts more weight on the techniques with a higher accuracy (e.g. high true positives/negatives rate and low false positives/negatives rate), for example, by increasing the respective scores.

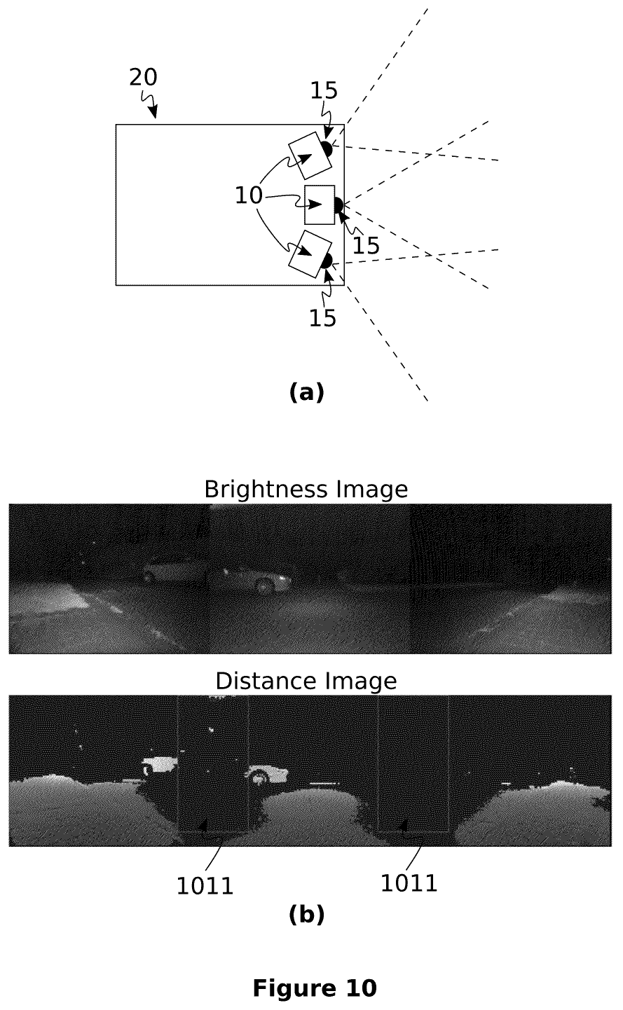

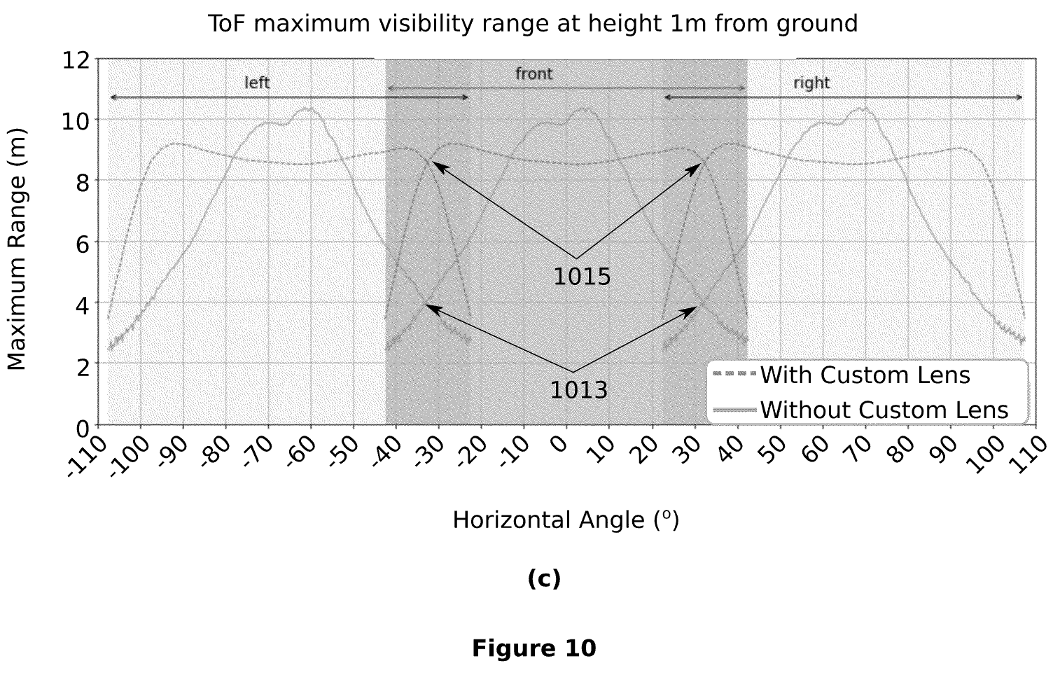

FIG. 10a depicts an embodiment of a mobile robot 20 comprising at least one ToF sensor 10 equipped with at least one custom optical lens 15. In the particular embodiment of FIG. 10a the mobile robot 20 comprises three ToF sensors 10. More particularly, the mobile robot 10 comprises a front ToF sensor 10 (with a field of view towards the front of the mobile robot 10) and two side ToF sensors 10 (with a field of view towards the sides of the mobile robot 10). In addition, FIG. 10a illustrates the field of view of each ToF sensor 10.

The custom optical lens 15 can be configured to refocus or reshape the illumination emitted by the ToF sensor (i.e. by an illumination unit comprised by the ToF sensor) such that the illumination of objects in the outdoor setting is increased. This can make objects more visible in a ToF sensor image and thus the accuracy of detecting objects and hazardous objects can be increased.

Generally, in a ToF sensor image, the upper and lower part of the image correspond to the sky (or high heights) and the ground respectively. As such, they may not convey information regarding objects detection. On the other hand, objects in the outdoor setting are generally captured on the middle or the sides of the ToF sensor image. Thus, in order to generally increase the illumination of objects in the outdoor setting the custom lens 15 according to an embodiment of the present invention can be configured to reshape illumination emitted by the ToF sensor 10, such that, the illuminated portion of the field of view of the ToF sensor 10 can be increased in the horizontal direction. In some embodiments, the custom lens 15 can be configured to decrease the illuminated portion of the field of view of the ToF sensor 10 in the vertical direction in order to increase the illuminated portion of the field of view of the ToF sensor 10 in the horizontal direction.

By reshaping or refocusing the illumination of the TOF sensor 10 using the custom optical lens 15 can be advantageous, as the illuminated portion of the field of view of the ToF sensor 10 can be increased in the horizontal direction without increasing the illumination power. In fact, the illuminated portion of the field of view of the ToF sensor 10 can be increased in the horizontal direction by “sacrificing” illumination of the field of view of ToF sensor 10 in the vertical direction - wherein nevertheless generally the ground or the sky is positioned and thus do not contribute significantly in object detection. The custom optical lens 15 can thus be advantageous as it can provide a more efficient use of the energy used for illumination by focusing the illumination in portions of the outdoor settings with a high likelihood of an object being positioned therein.

The optical lens 15 can be advantageous particularly when multiple ToF sensor 10 are used, as depicted in FIG. 10a. Generally, images captured by the multiple ToF sensors 10 can be “stitched” (i.e. merged) together and can provide a wide (i.e. extended) field of view. For example, using three ToF sensors 10 as depicted in FIG. 10a can (nearly) triple the field of view of the robot 10 as compared to using a single ToF camera 10. In such stitched images, although the field of view may be increased, there may be blind spots particularly on the sides of respective images due to lack of illumination. This is illustrated by FIG. 10b.

FIG. 10b depicts a stitched brightness image and a stitched distance image. The stitched images consist each of three images captured by a respective ToF sensor 10. Due to lack of illumination, particularly in the distance image, blind spots 1011 are created in the regions wherein the images are stitched (which correspond to the sides of the respective images). The blind spots 1011 are disadvantageous as objects positioned therein cannot be detected. For example, from the distance image it cannot be accurately determined whether an object is positioned in the blind spot 1011. On the other hand, as illustrated by the left blind spot 1011, the blind spots may cause an object (e.g. the vehicle) to appear as two separate objects. However, by increasing the illuminated portion of the field of view in the horizontal direction, the blind spots 1011 can be removed.

Furthermore, from the images of FIG. 10b it can be noticed that the lower part and the upper part of the image convey little information regarding object detection, as they capture ground and sky respectively. Thus, even if the illumination of these regions is reduced it may not have a significant negative impact for detecting objects – i.e. the impact on the false negative rate may be insignificant. Based on this, it can be advantageous to refocus illumination that would normally reach said regions towards the sides of the field of view of the respective ToF sensor, such that, the blind spots 1011 can be illuminated.

FIG. 10c provides a comparison between how illumination is spread in the horizontal direction when the custom lens 15 is used as compared to when the custom lens 15 is not used.

The horizontal axis depicts the horizontal angle of the field of view in degrees (°). The horizontal angle refers to the horizontal spread of the field of view of the ToF sensors 10. More particularly in the example of FIG. 10c, the field of view of the front ToF camera 10 extends between -43° to 43°, the field of view of the left ToF camera 10 extends between -22° to -108° and the field of view of the right ToF camera 10 extends between 22° to 108°. It will be noted that these are typical exemplary values and that the ToF sensor may be configured with different fields of view. In other words, according to the example of FIG. 10c, the mobile robot 10 can have a ToF sensor horizontal field of view between -108° to 108°.

The vertical axis depicts the maximum range in meters (m) with maximum visibility. The maximum visibility can be defined in terms of full width at half maximum (FWHM) expression. That is, maximum visibility is considered when the illumination is at least half the peak produced illumination. The dashed line depicts the maximum visibility range when the custom lens 15 is used. The continuous line depicts the maximum visibility range when the custom lens 15 is not used.

As it can be noticed, irrespective of the use of the custom lens, the center of the image comprises a maximum visibility up to a maximum range. However, when the custom lens is not used the visibility drops significantly towards the sides of the images (i.e. away from the center). However, when the custom lens is used, the maximum visibility is not only focused on the center of the image but extends towards the sides up to approximately ±20° from the center. Even further from ±20° maximum visibility range is significantly higher when the custom lens 15 is used.

FIG. 10c, also illustrates the use of the custom lens 15 can reduce the area of blind spots 1011 in an image. As shown by the intersections 1013, when the custom lens 15 is not used there will be no blind spot up to a distance of 4 meters. From there on, the width of the blind spot increases rapidly. However, when the custom lens 15 is used blind spots can be eliminated up to a distance of 7.8 meters. From there on, the width of the blind spot increases slowly. Thus, equipping the ToF sensor, more particularly an illumination unit that can generate illumination for the ToF sensor, with the custom lens 15 can mitigate the problem of blind spots and can facilitate detecting object from ToF sensor images.

In some embodiments the custom lens 15 can have a height and width between 5 to 15 mm, such as 10 mm. The custom lens 15 can further have a thickness between 5 to 10 mm, such as 8 mm. The lens can be configured to have a full width of the beam at half its maximum intensity (FWHM) between 30° to 35°, such as, 33° vertically and full width at 90% of the maximum value between 60° to 70°, preferably 66° horizontally. In some embodiments, the custom lens can have a beam angle (i.e. width at 50% of maximum illumination) of 27° vertically and 72° horizontally and a field angle (i.e. width at 10% of maximum illumination) of 52° vertically and 82° horizontally.

The use of the custom lens 15 can have certain advantages, such as: increase the number of detected objects which can otherwise be limited due to blind spots, make the robot move more smoothly as otherwise objects might suddenly just appear due to blind spots, facilitate tracking of moving objects such as bicycles and turning or close cars reliably as otherwise objects can be chopped by blind spots resulting in bad tracing performance. In general, these advantageous can increase autonomy and safety of driving on sidewalks and crossings.

1. A method for operating a mobile robot comprising at least one time-of-flight, ToF, sensor, the method comprising:
the mobile robot travelling in an outdoor setting; and
capturing at least one ToF sensor image related to the outdoor setting via the at least one ToF sensor; and
a data processing unit processing the at least one ToF sensor image to identify at least one cluster of pixels on the at least one ToF sensor image based on at least one pixel-clustering parameter; and
determining whether at least one cluster of pixels corresponds to a hazardous object in the outdoor setting.

2-15. (canceled)

16. The method according to claim 1, wherein capturing the at least one ToF sensor image comprises
capturing at least one distance image wherein each pixel comprises data indicating a distance between the at least one ToF sensor and a corresponding segment in the outdoor setting.

17. The method according to claim 1, wherein capturing the at least one ToF sensor image comprises
capturing at least one brightness image wherein each pixel comprises data indicating an amount of light received by the at least one ToF sensor.

18. The method according to claim 1, wherein the at least one pixel-clustering parameter is a plurality of pixel-clustering parameters, and
wherein each of the pixels is associated with a respective pixel-clustering parameter.

19. The method according to claim 18, wherein processing the at least one ToF sensor image to identify at least one cluster of pixels comprises identifying a plurality of pixels on the at least one ToF sensor image that are positioned within a predetermined distance from each other on the at least one ToF sensor image, and
wherein the difference between their respective pixel-clustering parameters is less than a pre-determined pixel-clustering parameter similarity threshold.

20. The method according to claim 1, wherein processing the at least one ToF sensor image to identify at least one cluster of pixels is based on a two-phase clustering process,
wherein in a first phase of the two-phase clustering process, pixels in at least some of a plurality of first portions of the at least one ToF sensor image are grouped into clusters based on respective first pixel-clustering parameters corresponding to the pixels;
wherein in a second phase of the two-phase clustering process, clusters in at least some of a plurality of second portions of the at least one ToF sensor image are grouped into composite clusters based on respective second-pixel clustering parameters corresponding to the clusters;
wherein the second phase is performed after the first phase and
wherein each of the second portions of the at least one ToF sensor image is composed of at least two of the plurality of the first portions of the at least one ToF sensor image.

21. The method according to claim 20, wherein the second portion of the at least one ToF sensor image is composed of a plurality of first portions of the at least one ToF sensor image that are vertically aligned.

22. The method according to claim 20, wherein for each of at least some of the clusters, the respective second-pixel clustering parameter is calculated based on the first pixel-clustering parameters corresponding to the pixels in that cluster.

23. The method according to claim 1, wherein determining whether at least one cluster of pixels corresponds to a hazardous object in the outdoor setting comprises
determining whether at least one cluster of pixels corresponds to an object or obstacle in the outdoor setting that obstructs mobile robot’s travelling.

24. The method according to claim 1, further comprising
the data processing unit generating a computerized view of the outdoor setting and projecting the at least one cluster of pixels and/or the detected hazardous object on the computerized view.

25. The method according to claim 1, further comprising:
capturing at least two ToF sensor images at different times via the at least one ToF sensor, and
wherein determining whether at least one cluster of pixels corresponds to a hazardous object in the outdoor setting comprises determining whether the at least one cluster of pixels corresponds to a moving object in the outdoor setting.

26. The method according to claim 1, wherein the method comprises operating the mobile robot based on the determining whether at least one cluster of pixels corresponds to a hazardous object in the outdoor setting.

27. A system configured to operate a mobile robot comprising:
a mobile robot configured to travel in an outdoor setting and comprising at least one time-of-flight, ToF, sensor configured to capture at least one ToF sensor image, wherein each of the at least one ToF sensor image comprises a plurality of pixels; and
a data processing unit configured to:
process the at least one ToF sensor image to identify at least one cluster of pixels on the at least one ToF sensor image based on at least one pixel-clustering parameter; and
determine whether at least one cluster of pixels corresponds to a hazardous object in the outdoor setting.

28. The system according to claim 27, wherein the at least one ToF sensor is configured to capture at least one distance image wherein each pixel comprises data indicating a distance between the at least one ToF sensor and a corresponding segment in the outdoor setting.

29. The system according to claim 27, wherein the at least one ToF sensor is configured to capture at least one brightness image wherein each pixel comprises data indicating an amount of light received by the at least one ToF sensor.

30. The system according to claim 27, wherein the at least one pixel-clustering parameter is a plurality of pixel-clustering parameters, and wherein each of the pixels is associated with a respective pixel-clustering parameter.

31. The system according to claim 30, wherein data processing unit is configured to process the at least one ToF sensor image to identify at least one cluster of pixels by identifying a plurality of pixels on the at least one ToF sensor image that are positioned within a predetermined distance from each other on the at least one ToF sensor image, and
wherein the difference between their respective pixel-clustering parameters is less than a pre-determined pixel-clustering parameter similarity threshold.

32. The system according to claim 27, wherein the data processing unit is configured to execute a two-phase clustering process to identify at least one cluster of pixels on the at least one ToF sensor image based on at least one pixel-clustering parameter,
wherein in a first phase of the two-phase clustering process, the data processing unit is configured to group pixels in at least some of a plurality of first portions of the at least one ToF sensor image into clusters based on respective first pixel-clustering parameters corresponding to the pixels,
wherein in a second phase of the two-phase clustering process, the data processing unit is configured to group clusters in at least some of a plurality of second portions of the at least one ToF sensor image into composite clusters based on respective second-pixel clustering parameters corresponding to the clusters, and
wherein the data processing unit is configured to perform the second phase after the first phase and
wherein each of the second portions of the at least one ToF sensor image is composed of at least two of the plurality of the first portions of the at least one ToF sensor image.

33. The system according to claim 27, wherein the at least one ToF sensor is configured to capture at least two ToF sensor images at different times, and
wherein the data processing device is configured to determine whether the at least one cluster of pixels corresponds to a moving object in the outdoor setting, and,
based thereon, to determine whether at least one cluster of pixels corresponds to a hazardous object in the outdoor setting.

34. The system according to claim 27, wherein the data processing unit is configured to operate the mobile robot based on the determining whether at least one cluster of pixels corresponds to a hazardous object in the outdoor setting.
